(19) United States
(12) Patent Application Publication
(10) Pub. No.: US 2024/0151290 A1
(43) Pub. Date: May 9, 2024

(54) SHOCK ABSORBER AND FREQUENCY SENSITIVE MECHANISM

(71) Applicant: Hitachi Astemo, Ltd., Ibaraki (JP)

(72) Inventor: Hideo NAGAYAMA, Hitachinaka-shi (JP)

(21) Appl. No.: 18/280,719

(22) PCT Filed: Jan. 25, 2022
(86) PCT No.: PCT/JP2022/002714

§ 371 Date: Sep. 7, 2023

(30) Foreign Application Priority Data
May 27, 2021 (JP) 2021-088881

(51) Int. Cl. F16F 9/50

(52) U.S. Cl. CPC F16F 9/50

(57) ABSTRACT

The shock absorber includes a piston fitted in a cylinder and partitioning an inside of the cylinder, a first passage through which a working fluid in the cylinder flows due to movement of the piston, a damping valve provided in the first passage and configured to change a flow path area due to a flow of the working fluid, a second passage communicating with an upstream side of the damping valve via a throttle, a third passage communicating with a downstream side of the damping valve, a passage part provided between the second passage and the third passage, and an elastic member having rubber elasticity provided in the passage part. The elastic member includes a seal part configured to suppress a flow of the working fluid from the second passage to the third passage, and a pressure receiving part configured to receive a pressure of the second passage.

### TECHNICAL FIELD

The present invention relates to a shock absorber and a frequency sensitive mechanism.

Priority is claimed on Japanese Patent Application No. 2021-088881 filed on May 27, 2021, the contents of which are incorporated herein by reference.

### BACKGROUND ART

A shock absorber in which a damping force is variable in response to a frequency is known (see, for example, Patent Documents 1 and 2).

### CITATION LIST

### Patent Document

[Patent Document 1]
PCT International Publication No. WO 2018/163868
[Patent Document 2]
Published Japanese Translation No. 2018-533703 of the PCT International Publication

### SUMMARY OF INVENTION

### Technical Problem

There is a demand for simplification of a structure in shock absorbers.

The present invention provides a shock absorber and a frequency sensitive mechanism that can be simplified in structure.

### Solution to Problem

According to a first aspect of the present invention, a shock absorber includes a piston fitted in the cylinder and partitioning an inside of the cylinder, a first passage through which a working fluid in the cylinder flows due to movement of the piston, a damping valve provided in the first passage and configured to change a flow path area due to a flow of the working fluid, a second passage communicating with an upstream side of the damping valve via a throttle, a third passage communicating with a downstream side of the damping valve, a passage part provided between the second passage and the third passage, and an elastic member having rubber elasticity provided in the passage part. The elastic member includes a seal part configured to suppress a flow of the working fluid from the second passage to the third passage, and a pressure receiving part configured to receive a pressure of the second passage.

According to a second aspect of the present invention, a shock absorber includes a piston fitted in the cylinder and partitioning an inside of the cylinder, a first passage through which a working fluid in the cylinder flows due to movement of the piston, a damping valve provided in the first passage and configured to change a flow path area due to a flow of the working fluid, a second passage communicating with an upstream side of the damping valve via a throttle, a third passage communicating with a downstream side of the damping valve, a seal chamber provided between the second passage and the third passage, a moving member provided in the seal chamber and including a seal part which suppresses a flow of the working fluid from the second passage to the third passage, and a pilot case forming a pilot chamber which communicates with the second passage and generates a force in a direction of reducing a flow path area of the damping valve due to an internal pressure. The pilot chamber and the seal chamber are formed in the pilot case at positions at which they overlap each other in an axial direction.

A frequency sensitive mechanism according to a third aspect of the present invention is a frequency sensitive mechanism provided in a shock absorber including a piston fitted in the cylinder and partitioning an inside of the cylinder, a first passage through which a working fluid in the cylinder flows due to movement of the piston, a damping valve provided in the first passage and configured to change a flow path area due to a flow of the working fluid, and a second passage communicating with an upstream side of the damping valve via a throttle, and the frequency sensitive mechanism includes a third passage communicating with a downstream side of the damping valve, a passage part provided between the second passage and the third passage, and an elastic member provided in the passage part, and having a seal part configured to suppress a flow of the working fluid from the second passage to the third passage and a pressure receiving part configured to receive a pressure of the second passage.

### Advantageous Effects of Invention

According to the shock absorber and the frequency sensitive mechanism described above, the structure can be simplified.

### BRIEF DESCRIPTION OF DRAWINGS

FIG. 1 is a front view showing a shock absorber according to a first embodiment of the present invention with a part thereof cross-sectioned.

FIG. 2 is a partial cross-sectional view showing a portion of the vicinity of a piston of the shock absorber according to the first embodiment of the present invention.

FIG. 3 is a partial cross-sectional view showing a portion of the vicinity of an extension-side damping force generation mechanism of the shock absorber according to the first embodiment of the present invention.

FIG. 4 is a hydraulic circuit diagram showing a portion of the vicinity of the piston of the shock absorber according to the first embodiment of the present invention.

FIG. 5 is a diagram showing damping force characteristics of the shock absorber according to the first embodiment of the present invention and a conventional shock absorber.

FIG. 6 is a partial cross-sectional view showing a portion of the vicinity of an extension-side damping force generation mechanism of a shock absorber according to a second embodiment of the present invention.

FIG. 7 is a hydraulic circuit diagram showing a portion of the vicinity of a piston of the shock absorber according to the second embodiment of the present invention.

FIG. 8 is a partial cross-sectional view showing a portion of the vicinity of an extension-side damping force generation mechanism of a shock absorber according to a third embodiment of the present invention.

FIG. 9 is a Lissajous waveform diagram showing damping force characteristics of the shock absorbers according to the first and third embodiments of the present invention.

FIG. 10 is a partial cross-sectional view showing a portion of the vicinity of an extension-side damping force generation mechanism of a shock absorber according to a fourth embodiment of the present invention.

FIG. 11 is a bottom view showing a seat member according to the fourth embodiment of the present invention.

FIG. 12 is a partial cross-sectional view showing a portion of the vicinity of an extension-side damping force generation mechanism of a shock absorber according to a fifth embodiment of the present invention.

FIG. 13 is a bottom view showing a seat member according to the fifth embodiment of the present invention.

FIG. 14 is a partial cross-sectional view showing a portion of the vicinity of an extension-side damping force generation mechanism of a shock absorber according to a sixth embodiment of the present invention.

FIG. 15 is a bottom view showing a seat member according to the sixth embodiment of the present invention.

FIG. 16 is a hydraulic circuit diagram showing a portion of the vicinity of a piston of the shock absorber according to the sixth embodiment of the present invention.

FIG. 17 is a partial cross-sectional view showing a portion of the vicinity of the extension-side damping force generation mechanism of the shock absorber according to the sixth embodiment of the present invention.

FIG. 18 is a partial cross-sectional view showing a portion of the vicinity of an extension-side damping force generation mechanism of a shock absorber according to a seventh embodiment of the present invention.

FIG. 19 is a hydraulic circuit diagram showing a portion of the vicinity of a piston of the shock absorber according to the seventh embodiment of the present invention.

FIG. 20 is a partial cross-sectional view showing a portion of the vicinity of an extension-side damping force generation mechanism of a shock absorber according to an eighth embodiment of the present invention.

FIG. 21 is a partial cross-sectional view showing a portion of the vicinity of an extension-side damping force generation mechanism of a shock absorber according to an ninth embodiment of the present invention.

FIG. 22 is a hydraulic circuit diagram showing a portion of the vicinity of a piston of the shock absorber according to the ninth embodiment of the present invention.

FIG. 23 is a partial cross-sectional view showing a portion of the vicinity of an extension-side damping force generation mechanism of a shock absorber according to a tenth embodiment of the present invention.

FIG. 24 is a hydraulic circuit diagram showing a portion of the vicinity of a piston of the shock absorber according to the tenth embodiment of the present invention.

### DESCRIPTION OF EMBODIMENTS

### First Embodiment

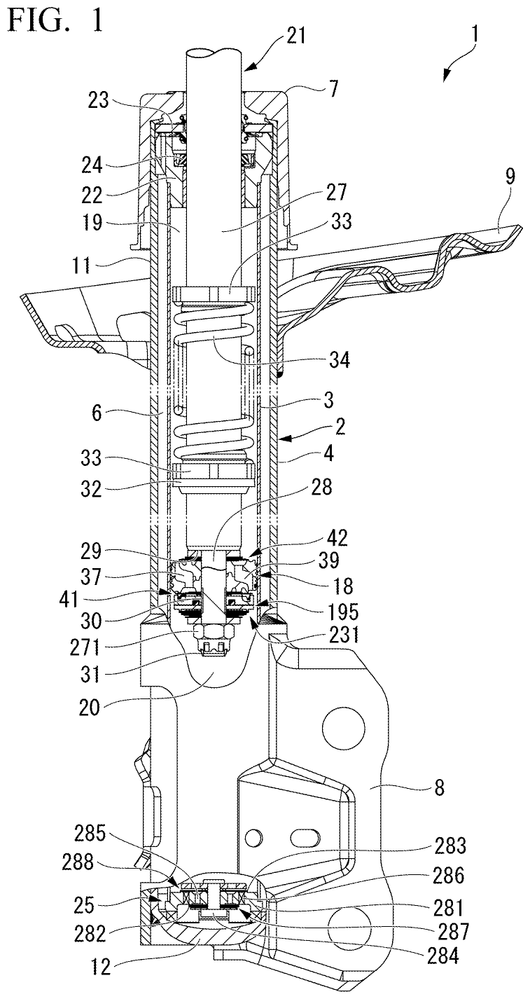

A shock absorber of a first embodiment will be described below with reference to FIGS. 1 to 5. Further, in the following, for convenience of explanation, an upper side in the drawing will be referred to using “upper” and a lower side in the drawing will be referred to using “lower” in FIGS. 1 to 3, FIG. 6, FIG. 8, FIG. 10, FIG. 12, FIG. 14, FIG. 17, FIG. 18, FIG. 20, FIG. 21, and FIG. 23.

As shown in FIG. 1, a shock absorber 1 of the first embodiment is a so-called dual-tube type hydraulic shock absorber. The shock absorber 1 includes a cylinder 2 in which an oil fluid (not shown) is sealed as a working fluid. The cylinder 2 includes an inner cylinder 3 and an outer cylinder 4. The inner cylinder 3 has a cylindrical shape. The outer cylinder 4 has a bottomed cylindrical shape. The outer cylinder 4 has an inner diameter larger than an outer diameter of the inner cylinder 3. The inner cylinder 3 is disposed inside the outer cylinder 4. A central axis of the inner cylinder 3 and a central axis of the outer cylinder 4 coincide with each other. A reservoir chamber 6 is provided between the inner cylinder 3 and the outer cylinder 4. The shock absorber 1 includes a cover 7, a main bracket 8, and a spring seat 9. The cover 7 covers an upper opening side of the outer cylinder 4. The main bracket 8 and the spring seat 9 are both fixed to an outer circumferential side of the outer cylinder 4.

The outer cylinder 4 has a barrel part 11 and a cylinder bottom part 12. The barrel part 11 has a cylindrical shape. The cylinder bottom part 12 is provided at a lower portion of the barrel part 11. The cylinder bottom part 12 closes the lower portion of the barrel part 11. The barrel part 11 and the cylinder bottom part 12 are integrally formed of one material.

The shock absorber 1 includes a piston 18. The piston 18 is fitted inside the inner cylinder 3 of the cylinder 2. The piston 18 is slidable with respect to the cylinder 2 in an axial direction of the cylinder 2. The piston 18 partitions the inside of the inner cylinder 3 into two chambers, an upper chamber 19 and a lower chamber 20. An oil fluid is sealed in the upper chamber 19 and the lower chamber 20 as a working fluid. An oil fluid and a gas are sealed in the reservoir chamber 6 between the inner cylinder 3 and the outer cylinder 4 as a working fluid.

The shock absorber 1 includes a piston rod 21. One end side of the piston rod 21 in the axial direction of the piston rod 21 is disposed inside the inner cylinder 3 of the cylinder 2. One end of the piston rod 21 is connected to the piston 18. The other end side of the piston rod 21 on a side opposite to the one end side in the axial direction of the piston rod 21 extends to the outside of the cylinder 2. The piston 18 and the piston rod 21 move together. In the shock absorber 1, a stroke in which the piston rod 21 moves in a direction to increase a protrusion amount thereof from the cylinder 2 is an extension stroke. In the shock absorber 1, a stroke in which the piston rod 21 moves in a direction to reduce a protrusion amount thereof from the cylinder 2 is a compression stroke. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted to the outer cylinder 4 on an upper side of the rod guide 22. A friction member 24 is provided between the rod guide 22 and the seal member 23. The rod guide 22, the seal member 23 and the friction member 24 are all annular. The piston rod 21 is inserted inside the rod guide 22, the friction member 24, and the seal member 23. The piston rod 21 slides with respect to the rod guide 22, the friction member 24, and the seal member 23 in the axial direction of them. The piston rod 21 extends from the inside of the cylinder 2 to the outside of the seal member 23.

The rod guide 22 restricts movement of the piston rod 21 in a radial direction of the piston rod 21. The piston rod 21 is fitted in the rod guide 22 and the piston 18 is fitted in the inner cylinder 3 of the cylinder 2. Thereby, a central axis of the piston rod 21 and a central axis of the cylinder 2 coincide with each other. The rod guide 22 supports the piston rod 21 to be movable in the axial direction of the piston rod 21. An outer circumferential portion of the seal member 23 is in close contact with the outer cylinder 4. An inner circumferential portion of the seal member 23 is in close contact with an outer circumferential portion of the piston rod 21. The piston rod 21 moves in the axial direction of the seal member 23 with respect to the seal member 23. The seal member 23 curbs the oil fluid in the inner cylinder 3 and the high-pressure gas and the oil fluid in the reservoir chamber 6 leaking to the outside. An inner circumferential portion of the friction member 24 is in contact with the outer circumferential portion of the piston rod 21. The piston rod 21 moves in the axial direction of the friction member 24 with respect to the friction member 24. The friction member 24 generates frictional resistance with respect to the piston rod 21.

An outer circumferential portion of the rod guide 22 has a larger diameter at an upper portion than at a lower portion. The rod guide 22 is fitted to an inner circumferential portion of an upper end of the inner cylinder 3 at the lower portion with a smaller diameter. The rod guide 22 is fitted to an upper inner circumferential portion of the outer cylinder 4 at the upper portion with a larger diameter. A base valve 25 is installed on the cylinder bottom part 12 of the outer cylinder 4. The lower chamber 20 and the reservoir chamber 6 are partitioned by the base valve 25. An inner circumferential portion of a lower end of the inner cylinder 3 is fitted to the base valve 25. An upper end portion of the outer cylinder 4 is swaged inward in a radial direction of the outer cylinder 4. The seal member 23 is sandwiched and fixed between the swaged portion and the rod guide 22.

The piston rod 21 includes a main shaft part 27 and a mounting shaft part 28. The mounting shaft part 28 has an outer diameter smaller than an outer diameter of the main shaft part 27. The mounting shaft part 28 is disposed inside the cylinder 2. The piston 18 is attached to the mounting shaft part 28. The main shaft part 27 has a shaft step part 29. The shaft step part 29 is provided at an end portion of the main shaft part 27 on the mounting shaft part 28 side. The shaft step part 29 extends in a direction orthogonal to the central axis of the piston rod 21. A passage groove 30 is formed in an outer circumferential portion of the mounting shaft part 28. The passage groove 30 is formed at an intermediate position in the axial direction of the mounting shaft part 28. A cross-sectional shape of the passage groove 30 in a plane orthogonal to the central axis of the piston rod 21 is formed to be any of rectangular, square, or D shaped. The passage groove 30 may be formed by cutting the outer circumferential portion of the mounting shaft part 28 into a planar shape parallel to a central axis of the mounting shaft part 28. A male screw 31 is formed on an outer circumferential portion of an end portion of the mounting shaft part 28 on a side opposite to the main shaft part 27 in the axial direction of the mounting shaft part 28.

An annular stopper member 32, a pair of annular shock absorbers 33, and a coil spring 34 are provided on the piston rod 21. The stopper member 32, the pair of shock absorbers 33, and the coil spring 34 are all provided in a portion between the piston 18 of the main shaft part 27 and the rod guide 22. The piston rod 21 is inserted into an inner circumferential side of the stopper member 32. The stopper member 32 is swaged and fixed to the main shaft part 27. One shock absorber 33, the coil spring 34, and the other shock absorber 33 are disposed on the main shaft part 27 in order from the stopper member 32 side on the rod guide 22 side with respect to the stopper member 32. The pair of shock absorbers 33 and the coil spring 34 are disposed between the stopper member 32 and the rod guide 22.

In the shock absorber 1, for example, a portion of the piston rod 21 protruding from the cylinder 2 is disposed at an upper portion and is connected to a vehicle body of a vehicle. At that time, the main bracket 8 of the shock absorber 1 provided on the cylinder 2 side is disposed at a lower portion and is connected to a wheel side of the vehicle. Conversely, the shock absorber 1 may be connected to the vehicle body on the cylinder 2 side. In this case, the piston rod 21 of the shock absorber 1 is connected to the wheel side.

In the vehicle, the wheel vibrates with respect to the vehicle body as the vehicle travels. Then, in the shock absorber 1, relative positions of the cylinder 2 and the piston rod 21 change according to the vibration. This change is suppressed by fluid resistance in a flow path provided in the shock absorber 1. As will be described in detail below, the fluid resistance in the flow path provided in the shock absorber 1 is designed to be different according to a speed and an amplitude of the vibration described above. Ride comfort of the vehicle is improved by the shock absorber 1 suppressing the vibration.

Also, in the vehicle, an inertial force or a centrifugal force generated in the vehicle body as the vehicle travels also acts between the cylinder 2 and the piston rod 21 in addition to the vibration generated by the wheel with respect to the vehicle body. For example, a centrifugal force is generated in the vehicle body when a traveling direction is changed by a steering wheel operation. Then, a force based on the centrifugal force acts between the cylinder 2 and the piston rod 21. As will be described below, the shock absorber 1 has satisfactory properties against vibration based on the force generated in the vehicle body as the vehicle travels. High traveling stability of the vehicle can be obtained by the shock absorber 1.

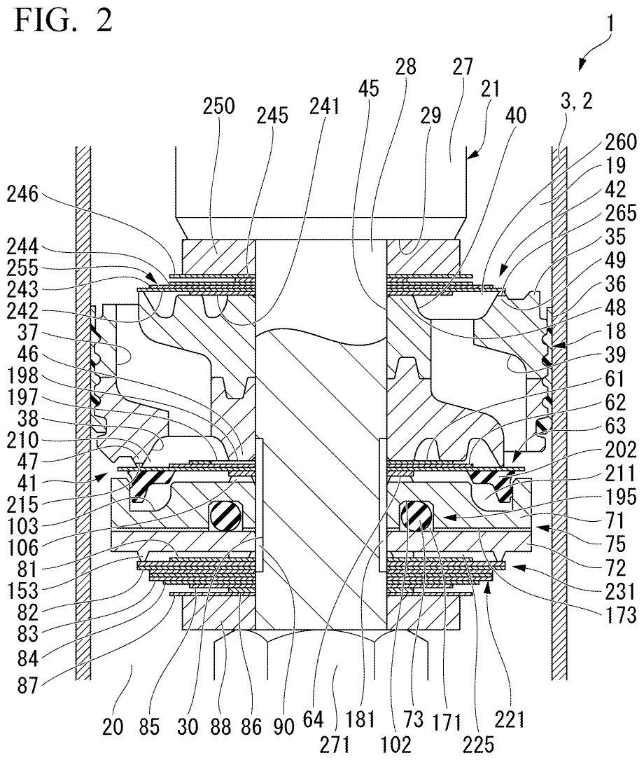

As shown in FIG. 2, the piston 18 includes a piston main body 35 and a slide member 36. The piston main body 35 is made of a metal and has an annular shape. The piston main body 35 of the piston 18 is in contact with the mounting shaft part 28 of the piston rod 21. The slide member 36 is made of a synthetic resin and has an annular shape. The slide member 36 is integrally attached to an outer circumferential surface of the piston main body 35. The slide member 36 of the piston 18 is in contact with the inner cylinder 3.

A passage hole 37, a passage groove 38, a passage hole 39, and a passage groove 40 are provided in the piston main body 35. A plurality of passage holes 37 are formed in the piston main body 35 at intervals in a circumferential direction of the piston main body 35 (only one is shown in FIG. 2 because it is a cross section). The passage groove 38 is formed in the piston main body 35 in an annular shape in the circumferential direction of the piston main body 35. A plurality of passage holes 39 are formed in the piston main body 35 at intervals in the circumferential direction of the piston main body 35 (only one is shown in FIG. 2 because it is a cross section). The passage groove 40 is formed in the piston main body 35 in an annular shape in the circumferential direction of the piston main body 35. In the piston main body 35, the passage holes 37 and the passage holes 39 are alternately formed one by one at regular pitches in the circumferential direction of the piston main body 35.

The passage groove 38 is formed at one end portion of the piston main body 35 in the axial direction. The passage groove 40 is formed at the other end portion of the piston main body 35 on a side opposite to the passage groove 38 in the axial direction. All the passage holes 37 open to the passage groove 38 at end portions in the axial direction of the piston main body 35. All the passage holes 39 open to the passage groove 40 at end portions in the axial direction of the piston main body 35. The plurality of passage holes 37 open to the outside of the passage groove 40 in a radial direction of the piston 18 at end portions on a side opposite to the passage groove 38 in an axial direction of the piston 18. The plurality of passage holes 39 open to the outside of the passage groove 38 in the radial direction of the piston 18 at end portions on a side opposite to the passage groove 40 in the axial direction of the piston 18.

The shock absorber 1 has a damping force generation mechanism 41 provided with respect to passages in the plurality of passage holes 37 and a passage in the passage groove 38. The damping force generation mechanism 41 opens and closes the passages in the plurality of passage holes 37 and the passage in the passage groove 38 to generate a damping force. The damping force generation mechanism 41 is provided on the lower chamber 20 side with respect to the piston 18 in the axial direction of the piston 18. The passages in the plurality of passage holes 37 and the passage in the passage groove 38 serve as a passage through which the oil fluid flows from the upper chamber 19 toward the lower chamber 20 when the piston 18 moves to the upper chamber 19 side. In other words, the passages in the plurality of passage holes 37 and the passage in the passage groove 38 serve as an extension-side passage through which the oil fluid flows from the upper chamber 19 toward the lower chamber 20 during the extension stroke of the shock absorber 1. The damping force generation mechanism 41 is an extension-side damping force generation mechanism that generates a damping force by suppressing a flow of the oil fluid through the passages in the plurality of passage holes 37 and the passage in the passage groove 38.

The shock absorber 1 has a damping force generation mechanism 42 provided with respect to passages in the plurality of passage holes 39 and a passage in the passage groove 40. The damping force generation mechanism 42 opens and closes the passages in the plurality of passage holes 39 and the passage in the passage groove 40 to generate a damping force. The damping force generation mechanism 42 is provided on the upper chamber 19 side with respect to the piston 18 in the axial direction of the piston 18. The passages in the plurality of passage holes 39 and the passage in the passage groove 40 serve as a passage through which the oil fluid flows from the lower chamber 20 toward the upper chamber 19 when the piston 18 moves to the lower chamber 20 side. In other words, the passages in the plurality of passage holes 39 and the passage in the passage groove 40 serve as a compression-side passage through which the oil fluid flows from the lower chamber 20 toward the upper chamber 19 during a compression stroke of the shock absorber 1. The damping force generation mechanism 42 is a compression-side damping force generation mechanism that generates a damping force by suppressing a flow of the oil fluid through the passages in the plurality of passage holes 39 and the passage in the passage groove 40.

The passages in the plurality of passage holes 37 and the passage in the passage groove 38 allow the upper chamber 19 and the lower chamber 20 to communicate with each other so that the oil fluid flows therebetween by movement of the piston 18. The passages in the plurality of passage holes 39 and the passage in the passage groove 40 allow the lower chamber 20 and the upper chamber 19 to communicate with each other so that the oil fluid flows therebetween by movement of the piston 18. The oil fluid passes through the passages in the plurality of passage holes 37 and the passage in the passage groove 38 when the piston rod 21 and the piston 18 move to the extension side (upper side in FIG. 2). The oil fluid passes through the passages in the plurality of passage holes 39 and the passage in the passage groove 40 when the piston rod 21 and the piston 18 move to the compression side (lower side in FIG. 2).

The piston main body 35 has substantially a disc shape. The piston main body 35 includes a fitting hole 45 formed to penetrate in the axial direction at a center of the piston main body 35 in the radial direction. The mounting shaft part 28 of the piston rod 21 is fitted in the fitting hole 45 of the piston main body 35.

An inner seat part 46 and a valve seat part 47 are formed at an end portion of the piston main body 35 on the lower chamber 20 side in the axial direction. The inner seat part 46 is annular. The valve seat part 47 is also annular. The inner seat part 46 is disposed on an inner side with respect to the opening of the passage groove 38 on the lower chamber 20 side in the radial direction of the piston main body 35. The valve seat part 47 is disposed on an outer side with respect to the opening of the passage groove 38 on the lower chamber 20 side in the radial direction of the piston main body 35. The valve seat part 47 is a part of the damping force generation mechanism 41.

An inner seat part 48 and a valve seat part 49 are formed at an end portion of the piston main body 35 on the upper chamber 19 side in the axial direction. The inner seat part 48 is annular. The valve seat part 49 is also annular. The inner seat part 48 is disposed on an inner side with respect to the opening of the passage groove 40 on the upper chamber 19 side in the radial direction of the piston main body 35. The valve seat part 49 is disposed on an outer side with respect to the opening of the passage groove 40 on the upper chamber 19 side in the radial direction of the piston main body 35. The valve seat part 49 is a part of the damping force generation mechanism 42.

In the piston main body 35, openings on the lower chamber 20 side in all the passage holes 39 are disposed on a side of the valve seat part 47 opposite to the passage groove 38 in the radial direction of the piston main body 35. In the piston main body 35, openings on the upper chamber 19 side in all the passage holes 37 are disposed on a side of the valve seat part 49 opposite to the passage groove 40 in the radial direction of the piston main body 35.

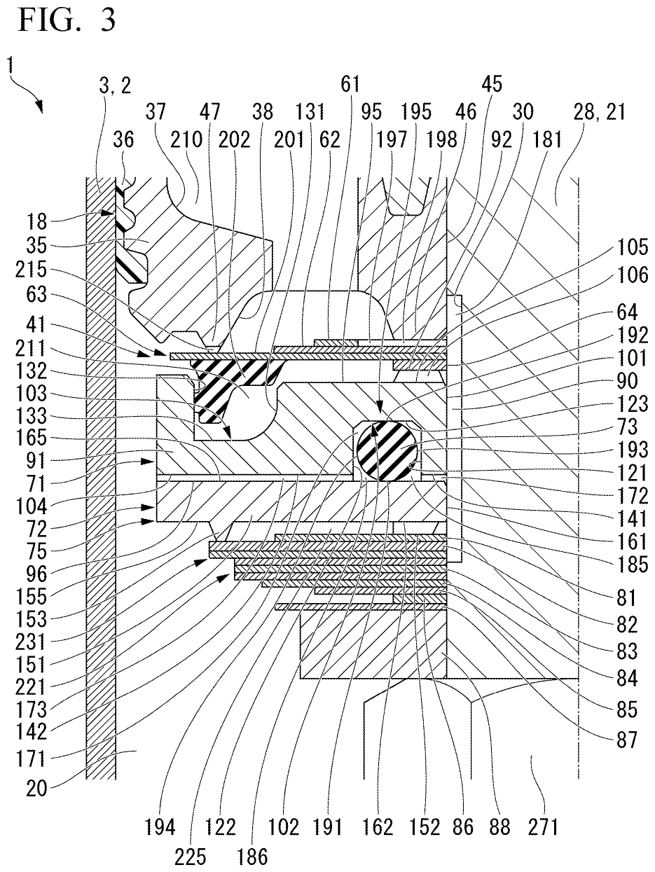

As shown in FIG. 3, one disc 61, one disc 62, one damping valve 63, and one disc 64 are stacked in order from the piston 18 side on the piston 18 on the lower chamber 20 side in the axial direction of the piston 18. The inner seat part 46 of the piston main body 35 is in contact with an inner circumferential side of the disc 61.

One case member 71 and one seat member 72 are stacked in order from the disc 64 side on the disc 64 on a side opposite to the piston 18 in an axial direction of the disc 64. A seal member 73 (elastic member, moving member) is provided between the case member 71 and the seat member 72. The case member 71 and the seat member 72 constitute a pilot case 75. The seal member 73 is provided inside the pilot case 75.

One disc 81, a plurality of discs 82, and a plurality of discs 83 are stacked in order from the seat member 72 side on the seat member 72 on a side opposite to the case member 71 in an axial direction of the seat member 72. Specifically, two discs 82 are provided. Specifically, three discs 83 are provided. One disc 84, one disc 85, one disc 86, one disc 87, and one annular member 88 are stacked in order from the discs 83 side on the discs 83 on a side opposite to the piston 18 in an axial direction of the discs 83.

The discs 61, 62, 64, and 81 to 87, the case member 71, the seat member 72, and the annular member 88 are all made of a metal. The case member 71 is integrally formed by sintering. The seat member 72 is integrally formed by sintering. At least either of the case member 71 and the seat member 72 may be formed by cutting. All the discs 61, 62, 64, and 81 to 87 have a flat plate shape with a constant thickness and are annular. The discs 61, 62, 64, and 81 to 87 are each formed by press-forming a plate material. The discs 61, 62, 64, and 81 to 87, and the annular member 88 all have the mounting shaft part 28 of the piston rod 21 fitted to an inner circumferential side thereof. All the discs 61, 62, 64, and 81 to 87 are bendable. The damping valve 63, the case member 71, and the seat member 72 are all annular. The damping valve 63, the case member 71, and the seat member 72 all have the mounting shaft part 28 of the piston rod 21 fitted to an inner circumferential side thereof. The pilot case 75 overlaps the passage groove 30 of the mounting shaft part 28 in position in the axial direction of the piston rod 21. The inside of the passage groove 30 serves as a rod chamber 90.

The case member 71 includes a member main body part 91 and a protruding part 92. The member main body part 91 has an annular shape. The protruding part 92 also has an annular shape. The protruding part 92 is provided on an inner circumferential side of the member main body part 91. A central axis of the member main body part 91 and a central axis of the protruding part 92 coincide with each other. These central axes serve as a central axis of the case member 71. The protruding part 92 protrudes in the axial direction of the seat member 72 from a surface portion 95 on one end side of the member main body part 91 in the axial direction of the case member 71. The surface portion 95 extends to be orthogonal to the central axis of the member main body part 91. The case member 71 is in contact with the disc 64 at an end surface of the protruding part 92 on a side opposite to the member main body part 91 in the axial direction of the case member 71.

A through hole 101, a seat member side annular groove 102, a piston side annular groove 103, a seat member side radial groove 104, and a piston side radial groove 105 are formed in the case member 71. The through hole 101 is formed at a center in a radial direction of the case member 71. The through hole 101 penetrates the case member 71 in the axial direction of the case member 71. The through hole 101 is formed of an inner circumferential surface of the member main body part 91 and an inner circumferential surface of the protruding part 92. The inner circumferential surface of the member main body part 91 has a cylindrical surface shape. An outer circumferential surface of the member main body part 91 also has a cylindrical surface shape. A central axis of the through hole 101 coincides with the central axis of the case member 71.

The member main body part 91 includes the seat member side annular groove 102 formed in a surface portion 96 on a side opposite to the surface portion 95 in the axial direction of the member main body part 91. The surface portion 96 has a planar shape extending to be orthogonal to the central axis of the member main body part 91. The seat member side annular groove 102 is recessed in the axial direction of the member main body part 91 from the surface portion 96. The seat member side annular groove 102 surrounds the through hole 101 from an outer side in a radial direction of the member main body part 91. The seat member side annular groove 102 is annular. A central axis of the seat member side annular groove 102 coincides with the central axis of the through hole 101.

The seat member side annular groove 102 has a wall surface portion 121, a wall surface portion 122, and a bottom surface portion 123. The wall surface portion 122 is disposed on an outer side with respect to the wall surface portion 121 in the radial direction of the member main body part 91. The wall surface portion 121 has a cylindrical surface shape. The wall surface portion 121 faces outward in the radial direction of the member main body part 91. The wall surface portion 122 has a cylindrical surface shape. The wall surface portion 122 faces inward in the radial direction of the member main body part 91. The bottom surface portion 123 connects an end edge portion of the wall surface portion 121 on a side opposite to the surface portion 96 and an end edge portion of the wall surface portion 122 on a side opposite to the surface portion 96. The bottom surface portion 123 has a planar shape extending parallel to the surface portion 96. A central axis of the wall surface portion 121, a central axis of the wall surface portion 122, and a central axis of the bottom surface portion 123 are the same as the central axis of the seat member side annular groove 102.

The piston side annular groove 103 is recessed in the axial direction of the member main body part 91 from the surface portion 95 of the member main body part 91. The piston side annular groove 103 is disposed on an outer side with respect to the seat member side annular groove 102 in the radial direction of the member main body part 91. The piston side annular groove 103 surrounds the seat member side annular groove 102 from an outer side in the radial direction of the member main body part 91. The piston side annular groove 103 is annular. A central axis of the piston side annular groove 103 coincides with the central axis of the through hole 101.

The piston side annular groove 103 has a wall surface portion 131, a wall surface portion 132, and a bottom surface portion 133. The wall surface portion 132 is disposed on an outer side with respect to the wall surface portion 131 in the radial direction of the member main body part 91. A portion of the wall surface portion 131 on a side opposite to the surface portion 95 in the axial direction of the member main body part 91 has a substantially cylindrical surface shape with an R chamfering. The wall surface portion 131 faces outward in the radial direction of the member main body part 91. The wall surface portion 132 has a cylindrical surface shape. The wall surface portion 132 faces inward in the radial direction of the member main body part 91. The bottom surface portion 133 connects an end edge portion of the wall surface portion 131 on a side opposite to the surface portion 95 and an end edge portion of the wall surface portion 132 on a side opposite to the surface portion 95. The bottom surface portion 133 has a planar shape extending parallel to the surface portion 95. A central axis of the wall surface portion 131, a central axis of the wall surface portion 132, and a central axis of the bottom surface portion 133 are the same as the central axis of the piston side annular groove 103. A portion of the seat member side annular groove 102 on the bottom surface portion 123 side and a portion of the piston side annular groove 103 on the bottom surface portion 133 side overlap each other in position in the axial direction of the case member 71. The seat member side annular groove 102 and the piston side annular groove 103 are positioned differently in the radial direction of the case member 71. The seat member side annular groove 102 and the piston side annular groove 103 are formed on opposite sides of the case member 71 in the axial direction.

The seat member side radial groove 104 is formed in the surface portion 96 of the member main body part 91. The seat member side radial groove 104 is recessed in the axial direction of the member main body part 91 from the surface portion 96. The seat member side radial groove 104 has a depth from the surface portion 96 that is smaller than a depth of the seat member side annular groove 102 from the surface portion 96. The seat member side radial groove 104 traverses the seat member side annular groove 102 in the radial direction of the case member 71. The seat member side radial groove 104 has an inner groove part 141 and an outer groove part 142. The inner groove part 141 extends from the inner circumferential surface of the member main body part 91 to the wall surface portion 121 of the seat member side annular groove 102. The outer groove part 142 extends from the wall surface portion 122 of the seat member side annular groove 102 to the outer circumferential surface of the member main body part 91. The inner groove part 141 opens to the rod chamber 90.

The piston side radial groove 105 is formed in the protruding part 92. The piston side radial groove 105 is recessed in the axial direction of the case member 71 from a distal end surface of the protruding part 92 on a side opposite to the member main body part 91 in the axial direction of the case member 71. The piston side radial groove 105 extends from the inner circumferential surface of the protruding part 92 to an outer circumferential surface of the protruding part 92. The piston side radial groove 105 traverses the protruding part 92 in a radial direction of the protruding part 92. The piston side radial groove 105 opens to the rod chamber 90. A passage inside the piston side radial groove 105 serves as a throttle 106 that communicates with the rod chamber 90.

The seat member 72 has an annular shape. The seat member 72 has a member main body part 151, a protruding part 152, and a valve seat part 153. The member main body part 151 has an annular shape. The protruding part 152 is also annular. The valve seat part 153 is also annular. The protruding part 152 is provided on an inner circumferential side of the member main body part 151. The valve seat part 153 is provided on an outer side of the protruding part 152 of the member main body part 151 in a radial direction of the seat member 72. A central axis of the member main body part 151, a central axis of the protruding part 152, and a central axis of the valve seat part 153 coincide with each other. These central axes serve as a central axis of the seat member 72. The protruding part 152 protrudes in the axial direction of the seat member 72 from a surface portion 155 on one end side of the member main body part 151 in the axial direction of the seat member 72. The valve seat part 153 protrudes in the axial direction of the seat member 72 from the surface portion 155 of the member main body part 151.

A through hole 161 and a radial groove 162 are formed in the seat member 72. The through hole 161 is formed at a center of the seat member 72 in the radial direction of the seat member 72. The through hole 161 penetrates the seat member 72 in the axial direction of the seat member 72. The through hole 161 is formed of an inner circumferential surface of the member main body part 151 and an inner circumferential surface of the protruding part 152. The inner circumferential surface of the member main body part 151 has a cylindrical surface shape. An outer circumferential surface of the member main body part 151 also has a cylindrical surface shape. A central axis of the through hole 161 coincides with the central axis of the seat member 72.

The radial groove 162 is formed in the protruding part 152. The radial groove 162 is recessed in the axial direction of the seat member 72 from a distal end surface of the protruding part 152 on a side opposite to the member main body part 151 in the axial direction of the seat member 72. The radial groove 162 extends from the inner circumferential surface of the protruding part 152 to an outer circumferential surface of the protruding part 152. The radial groove 162 traverses the protruding part 152 in the radial direction. The radial groove 162 opens to the rod chamber 90.

The member main body part 151 has an abutment surface 165. The abutment surface 165 is formed on a side of the member main body part 151 opposite to the protruding part 152 and the valve seat part 153 in the axial direction of the seat member 72. The abutment surface 165 has a planar shape extending to be orthogonal to the central axis of the member main body part 151.

When both the case member 71 and the seat member 72 are fitted on the mounting shaft part 28 of the piston rod 21, central axes thereof are made to be coincident with each other. In this state, the abutment surface 165 of the seat member 72 overlaps the surface portion 96 of the case member 71 to be in surface contact with each other. Then, the case member 71 and the seat member 72 form a seal chamber 171 (passage part), a throttle 172, and a lower chamber side passage 173 (third passage).

The seal chamber 171 is formed inside the seat member side annular groove 102. The seal chamber 171 is formed to be surrounded by the wall surface portion 121, the wall surface portion 122, the bottom surface portion 123, and the abutment surface 165. The seal chamber 171 has an annular shape. A central axis of the seal chamber 171 and the central axes of through holes 101 and 161 coincide with each other.

The throttle 172 is formed inside the inner groove part 141. The throttle 172 is formed to be surrounded by the inner groove part 141 and the abutment surface 165. One end of the throttle 172 opens to the seal chamber 171, and the other end opens to the rod chamber 90. The throttle 172 communicates with the seal chamber 171 and the rod chamber 90. The rod chamber 90 and the throttle 172 form an upper chamber side passage 181 (second passage).

The lower chamber side passage 173 is formed inside the outer groove part 142. The lower chamber side passage 173 is formed to be surrounded by the outer groove part 142 and the abutment surface 165. One end of the lower chamber side passage 173 opens to the seal chamber 171, and the other end opens to the lower chamber 20. The lower chamber side passage 173 communicates with the seal chamber 171 and the lower chamber 20. The seal chamber 171 is provided between the lower chamber side passage 173 and the throttle 172 of the upper chamber side passage 181.

The seal member 73 has an annular shape. A cross section of the seal member 73 in a plane including a central axis thereof is a circular O-ring. The seal member 73 is an elastic member having rubber elasticity. The seal member 73 is housed in the seal chamber 171. The seal member 73 is in contact with the bottom surface portion 123 of the seat member side annular groove 102 and the abutment surface 165 of the seat member 72 at the same time. At that time, the seal member 73 elastically deforms in an axial direction of the seal member 73. The seal member 73 moves in a radial direction of the seal member 73 within the seal chamber 171. The seal member 73 elastically deforms in the radial direction of the seal member 73 within the seal chamber 171. At least an inner diameter of the seal member 73 can be increased in the radial direction of the seal member 73 within the seal chamber 171. At least an outer diameter of the seal member 73 can be reduced in the radial direction of the seal member 73 within the seal chamber 171.

The seal member 73 includes a seal part 191, a seal part 192, a pressure receiving part 193, and a pressure receiving part 194. The seal part 191 comes into contact with the abutment surface 165 to seal between itself and the abutment surface 165. The seal part 192 comes into contact with the bottom surface portion 123 to seal between itself and the bottom surface portion 123. The seal parts 191 and 192 are also provided in the seal chamber 171. The seal parts 191 and 192 of the seal member 73 suppress a flow of the oil fluid from the upper chamber side passage 181 side including the throttle 172 to the lower chamber side passage 173 side. The seal parts 191 and 192 also suppress a flow of the oil fluid from the lower chamber side passage 173 side to the upper chamber side passage 181 side. The pressure receiving part 193 is on the wall surface portion 121 side of the seal member 73. The pressure receiving part 193 receives a pressure on the upper chamber side passage 181 side. The pressure receiving part 194 is on the wall surface portion 122 side of the seal member 73. The pressure receiving part 194 receives a pressure on the lower chamber side passage 173 side. The seal member 73 has a seal function that partitions the inside of the seal chamber 171 into an upper chamber communicating chamber 185 communicating with the upper chamber side passage 181 and a lower chamber communicating chamber 186 communicating with the lower chamber side passage 173. The seal member 73 has both the seal function and a property of elastic deformation at the same time.

The seal chamber 171, the throttle 172, the lower chamber side passage 173, and the seal member 73 constitute a frequency sensitive mechanism 195 that makes a damping force variable in response to a frequency of reciprocation of the piston 18. The frequency sensitive mechanism 195 is provided within the pilot case 75. In the frequency sensitive mechanism 195, the seal chamber 171, the throttle 172, and the lower chamber side passage 173 are formed of two members including the case member 71 and the seat member 72.

The disc 61 has an outer diameter larger than an outer diameter of the inner seat part 46. The disc 61 has an outer diameter smaller than an inner diameter of the valve seat part 47. A notch 197 extending outward in a radial direction of the disc 61 from an inner circumferential edge portion is formed in the disc 61. A passage in the notch 197 is a throttle 198. The throttle 198 opens to the passage in the passage groove 38 of the piston 18 and the rod chamber 90. The passages in the plurality of passage holes 37 and the passage in the passage groove 38 communicate with the rod chamber 90 via the throttle 198.

The disc 62 has an outer diameter larger than the outer diameter of the disc 61. The disc 62 has an outer diameter smaller than the inner diameter of the valve seat part 47 of the piston 18.

The damping valve 63 includes a disc 201 and a seal part 202. The disc 201 is made of a metal. The seal part 202 is made of rubber. The seal part 202 is fixed to the disc 201. The disc 201 has a flat plate shape with a constant thickness and is annular. The disc 201 is formed by press-forming a plate material. The mounting shaft part 28 of the piston rod 21 is fitted to an inner circumferential side of the disc 201. The disc 201 is bendable. The disc 201 has an outer diameter larger than an outer diameter of the valve seat part 47. The seal part 202 has an annular shape. The seal part 202 is fixed to a side of the disc 201 opposite to the piston 18 in an axial direction of the damping valve 63. The seal part 202 is fixed to an outer circumferential side of the disc 201 in a radial direction of the damping valve 63. A central axis of the seal part 202 and a central axis of the disc 201 coincide with each other.

The damping valve 63 is disposed on the piston side annular groove 103 side of the case member 71 in the axial direction of the case member 71. The disc 201 of the damping valve 63 comes in contact with the valve seat part 47. The damping valve 63 closes the passages in the plurality of passage holes 37 and the passage in the passage groove 38 when the disc 201 comes into contact with the valve seat part 47. The damping valve 63 opens the passages in the plurality of passage holes 37 and the passage in the passage groove 38 when the disc 201 is separated from the valve seat part 47. The damping valve 63 allows the passages in the plurality of passage holes 37 and the passage in the passage groove 38 to communicate with the lower chamber 20 when the disc 201 is separated from the valve seat part 47.

The passages in the plurality of passage holes 37 and the passage in the passage groove 38 form a piston passage 210 (first passage). The piston passage 210 is formed in the piston 18. The piston passage 210 includes a passage between the disc 201 and the valve seat part 47 that is created when the disc 201 is separated from the valve seat part 47. The piston passage 210 allows the oil fluid in the inner cylinder 3 to flow due to movement of the piston 18. The damping valve 63 is provided in the piston passage 210. The damping valve 63 changes a flow path area of the piston passage 210 due to a flow of the oil fluid through the piston passage 210. The throttle 198 of the disc 61 communicates with the piston passage 210.

The disc 64 has an outer diameter the same as an outer diameter of the protruding part 92 of the case member 71. The disc 64 is in contact with the disc 201 of the damping valve 63 and the protruding part 92 of the case member 71.

In the damping valve 63, the seal part 202 is slidably fitted in a liquid-tight manner to the wall surface portion 132 of the case member 71 over the entire circumference. The seal part 202 constantly seals a gap between the damping valve 63 and the wall surface portion 132. The damping valve 63, the case member 71, and the disc 64 form a pilot chamber 211. In other words, the pilot chamber 211 is formed in the case member 71. The pilot chamber 211 includes an inner portion of the piston side annular groove 103. The pilot chamber 211 exerts a pressure on the damping valve 63 in a direction of the piston 18. In other words, the pilot chamber 211 causes the damping valve 63 to generate a force in a direction of reducing a flow path area between the damping valve 63 and the valve seat part 47 due to an internal pressure.

The pilot chamber 211 communicates with the rod chamber 90 of the upper chamber side passage 181 via the throttle 106 of the case member 71. In the pilot case 75, the seal chamber 171 and the inner portion of the piston side annular groove 103 of the pilot chamber 211 are formed at different positions in a radial direction of the pilot case 75. The pilot chamber 211 and the seal chamber 171 are formed in the pilot case 75 at positions partially overlapping each other in an axial direction of the pilot case 75. A part of the pilot chamber 211 on the bottom surface portion 123 side and a part of the seal chamber 171 on the bottom surface portion 133 side overlap each other in position in the axial direction of the pilot case 75.

The damping valve 63 is a pilot type damping valve in which the pilot chamber 211 is provided on a side opposite to the piston 18. The damping valve 63 and the pilot chamber 211 form a part of the damping force generation mechanism 41. In other words, the damping force generation mechanism 41 includes the damping valve 63 and the pilot chamber 211, and is a pressure control type valve mechanism. The valve seat part 47 has a fixed orifice 215 between itself and the damping valve 63. The fixed orifice 215 forms a part of the piston passage 210. The fixed orifice 215 of the piston passage 210 allows the upper chamber 19 and the lower chamber 20 to communicate with each other. The fixed orifice 215 is provided in the damping force generation mechanism 41.

As described above, the passages in the plurality of passage holes 37, the passage in the passage groove 38, and the passage between the damping valve 63 and the valve seat part 47 constitute the piston passage 210. This piston passage 210 serves as an extension-side passage through which the oil fluid flows from the upper chamber 19 on one side toward the lower chamber 20 on the other side when the piston 18 moves to the upper chamber 19 side, that is, during the extension stroke of the shock absorber 1. The extension-side damping force generation mechanism 41 including the valve seat part 47 and the damping valve 63 is provided in the piston passage 210. The damping force generation mechanism 41 generates a damping force by opening and closing the piston passage 210 with the damping valve 63 to suppress a flow of the oil fluid. The extension-side damping force generation mechanism 41 introduces some of the flow of the oil fluid in the piston passage 210 into the pilot chamber 211 via the throttle 198, the rod chamber 90, and the throttle 106. The extension-side damping force generation mechanism 41 controls an opening of the damping valve 63 using the pressure in the pilot chamber 211.

The upper chamber side passage 181 including the rod chamber 90 communicates with an upstream side of the damping valve 63 in a flow direction of the oil fluid in the piston passage 210 via the throttle 198 during the extension stroke. The upper chamber side passage 181 communicates with the upper chamber communicating chamber 185 of the seal chamber 171. The lower chamber side passage 173 communicates with the lower chamber communicating chamber 186 of the seal chamber 171. The lower chamber side passage 173 communicates with the lower chamber 20. The lower chamber 20 is positioned downstream of the damping valve 63 in the flow direction of the oil fluid in the piston passage 210 during the extension stroke. Therefore, the lower chamber side passage 173 communicates with s downstream side of the damping valve 63 in the flow direction of the oil fluid in the piston passage 210 during the extension stroke.

The disc 81 has an outer diameter smaller than an inner diameter of the valve seat part 153 of the case member 71 and larger than an outer diameter of the protruding part 78. The disc 81 is in contact with the protruding part 78 of the case member 71. The plurality of discs 82 have an outer diameter slightly larger than an outer diameter of the valve seat part 153. The discs 82 on the disc 81 side is seated on the valve seat part 153. The discs 83 has an outer diameter smaller than an outer diameter of the discs 82. The disc 84 has an outer diameter smaller than an outer diameter of the discs 83. The disc 85 has an outer diameter smaller than the outer diameter of the disc 84. The disc 86 has an outer diameter smaller than the outer diameter of the disc 85. The disc 87 has an outer diameter smaller than the outer diameter of the disc 84 and larger than the outer diameter of the disc 85. The annular member 88 has an outer diameter larger than the outer diameter of the disc 85 and smaller than the outer diameter of the disc 87. The annular member 88 has a smaller thickness than the discs 81 to 87. The annular member 88 has a higher rigidity than the discs 81 to 87.

The discs 82 to 85 constitute a hard valve 221 that can be separated from and seated on the valve seat part 153. The hard valve 221 forms a bypass passage 225 between itself and the seat member 72. The hard valve 221 is seated on the valve seat part 153 at the disc 82. The bypass passage 225 communicates with the rod chamber 90 of the upper chamber side passage 181 via a passage inside the radial groove 162 of the seat member 72. The bypass passage 225 communicates with the lower chamber 20 when the hard valve 221 is separated from the valve seat part 153.

The hard valve 221 is separated from the valve seat part 153 during the extension stroke of the shock absorber 1. Then, the passage between the hard valve 221 and the valve seat part 153 opens, and the bypass passage 225 communicates with the lower chamber 20. At that time, the hard valve 221 suppresses a flow of the oil fluid from the bypass passage 225 to the lower chamber 20. In the extension stroke of the shock absorber 1, the lower chamber 20 is on a downstream side of the damping valve 63 in the flow direction of the oil fluid in the piston passage 210. The bypass passage 225 exerts a pressure on the hard valve 221 seated on the valve seat part 153 in a direction away from the valve seat part 153.

The hard valve 221 is separated from the valve seat part 153 to open the bypass passage 225 when a pressure in the bypass passage 225 reaches a predetermined pressure. Then, the oil fluid flows from the bypass passage 225 to the lower chamber 20. At that time, the hard valve 221 and the valve seat part 153 impart resistance to the flow of the oil fluid and generate a damping force. The hard valve 221, together with the valve seat part 153, constitutes a damping force generation mechanism 231. The damping force generation mechanism 231 is provided in the bypass passage 225. The hard valve 221 changes a flow path area of the bypass passage 225 due to the flow of the oil fluid in the bypass passage 225. The damping force generation mechanism 231 generates a damping force due to the flow of the oil fluid in the bypass passage 225. When the hard valve 221 deforms in an opening direction, the disc 87 and the annular member 88 suppress deformation of the hard valve 221 beyond a specified limit by coming into contact with the hard valve 221.

As shown in FIG. 2, one disc 241, one disc 242, one disc 243, one disc 244, one disc 245, one disc 246, and one annular member 250 are stacked on the upper chamber 19 side of the piston 18 in order from the piston 18 side in the axial direction of the piston 18. The discs 241 to 246 and the annular member 250 are all made of a metal. The discs 241 to 246 and the annular member 250 all have a flat plate shape with a constant thickness and are annular. The discs 241 to 246 are each formed by press-forming a plate material. The discs 241 to 246 and the annular member 250 all have the mounting shaft part 28 of the piston rod 21 fitted to an inner circumferential side thereof. All the discs 242 to 244 are bendable.

The disc 241 has an outer diameter larger than an outer diameter of the inner seat part 48 of the piston 18 and smaller than an inner diameter of the valve seat part 49. The disc 242 has an outer diameter the same as an outer diameter of the valve seat part 49 of the piston 18. The disc 242 is in contact with the valve seat part 49. The disc 242 opens and closes the passages in the plurality of passage holes 39 and the passage in the passage groove 40 by being separated from and brought into contact with the valve seat part 49. The disc 243 has an outer diameter smaller than the outer diameter of the disc 242. The disc 244 has an outer diameter smaller than the outer diameter of the disc 243. The disc 245 has an outer diameter smaller than the outer diameter of the disc 244. The disc 246 has an outer diameter the same as the outer diameter of the disc 244. The annular member 250 has an outer diameter smaller than the outer diameter of the disc 246 and larger than the outer diameter of the disc 245. The annular member 250 has a larger thickness and a higher rigidity than the discs 241 to 246. The annular member 250 is in contact with the shaft step part 29 of the piston rod 21.

The discs 242 to 244 constitute a disc valve 255. The disc valve 255 can be separated from and seated on the valve seat part 49. The disc valve 255 closes the passages in the plurality of passage holes 39 and passage in the passage groove 40 when the disc 242 comes into contact with the valve seat part 49. The disc valve 255 opens the passages in the plurality of passage holes 39 and the passage in the passage groove 40 when the disc 242 is separated from the valve seat part 49. The disc valve 255 allows the passages in the plurality of passage holes 39 and the passage in the passage groove 40 to communicate with the upper chamber 19 when the disc 242 is separated from the valve seat part 49.

The passages in the plurality of passage holes 39 and the passage in the passage groove 40 form a piston passage 260. The piston passage 260 is formed in the piston 18. The piston passage 260 also includes a passage between the disc 242 and the valve seat part 49 that is created when the disc 242 is separated from the valve seat part 49. The piston passage 260 allows the oil fluid in the inner cylinder 3 to flow due to movement of the piston 18. The disc valve 255 is provided in the piston passage 260. The disc valve 255 changes a flow path area of the piston passage 260 due to a flow of the oil fluid through the piston passage 260.

The disc valve 255 and the valve seat part 49 constitute the compression-side damping force generation mechanism 42. The damping force generation mechanism 42 is provided in the piston passage 260. The valve seat part 49 has a fixed orifice 265 between itself and the disc valve 255. The fixed orifice 265 is provided in the piston passage 260. The piston passage 260 allows the lower chamber 20 and the upper chamber 19 to communicate with each other due to the fixed orifice 265. The fixed orifice 265 is provided in the damping force generation mechanism 42.

Here, an example of an assembly method for assembling the above-described parts to the mounting shaft part 28 of the piston rod 21 will be described.

The annular member 250, the disc 246, the disc 245, the disc 244, the disc 243, the disc 242, and the disc 241 are stacked in that order on the shaft step part 29 while inserting the mounting shaft part 28 into the inner circumferential side of them. Next, the piston 18, the disc 61, the disc 62, the damping valve 63, and the disc 64 are stacked on the disc 241 in that order while inserting the mounting shaft part 28 into the inner circumferential side of them. Next, the case member 71 is stacked on the disc 64 while inserting the mounting shaft part 28 into the inner circumferential side and fitting the seal part 202 into the piston side annular groove 103. Next, the seal member 73 is disposed in the seat member side annular groove 102 of the case member 71. Next, the seat member 72 is stacked on the case member 71 and the seal member 73 while inserting the mounting shaft part 28 into the inner circumferential side. Next, the disc 81, the plurality of discs 82, the plurality of discs 83, the disc 84, the disc 85, the disc 86, the disc 87, and the annular member 88 are stacked on the seat member 72 in that order while inserting the mounting shaft part 28 into the inner circumferential side of them.

With the parts disposed in this manner, a nut 271 is screwed onto the male screw 31 of the mounting shaft part 28 that protrudes from the annular member 88. Thereby, the annular members 88 and 250, the discs 61, 62, 64, 81 to 87, and 241 to 246, the piston 18, the damping valve 63, the case member 71, and the seat member 72 are sandwiched between the shaft step part 29 and the nut 271. At this time, the annular members 88 and 250, the discs 61, 62, 64, 81 to 87, and 241 to 246, the piston 18, the damping valve 63, the case member 71, and the seat member 72 are clamped in the axial direction at least at the inner circumferential side of them. Thereby, the pilot case 75 is disposed to sandwich the damping valve 63 between itself and the piston 18. Thereby, central axes of the annular members 88 and 250, the discs 61, 62, 64, 81 to 87, and 241 to 246, the piston 18, the damping valve 63, the case member 71, and the seat member 72 are made to coincide with the central axis of the piston rod 21. The seal member 73 is in a state in which the piston rod 21 passes through an inner side of the seal member 73 in the radial direction.

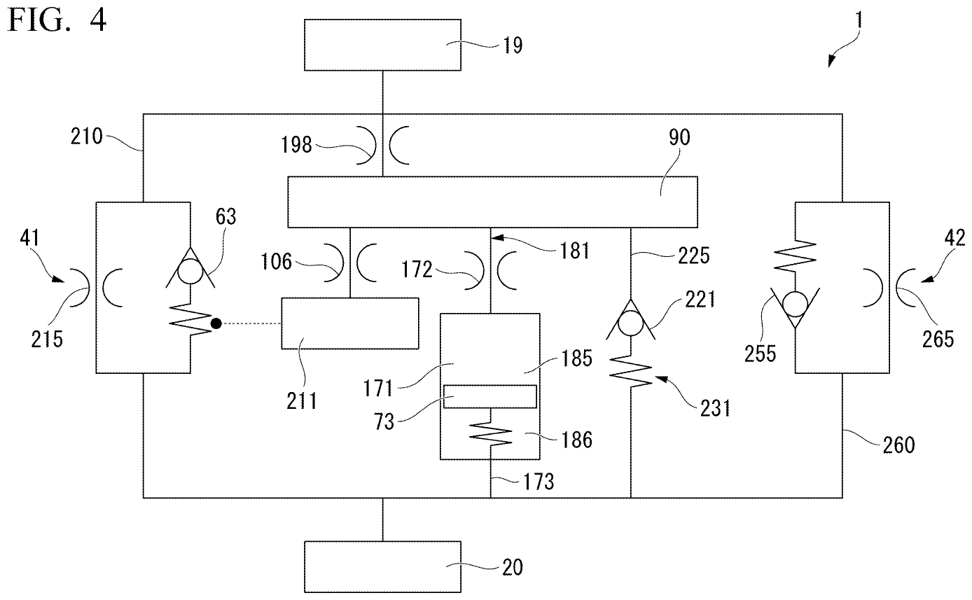

A hydraulic circuit diagram of a portion of the vicinity of the piston 18 of the shock absorber 1 configured as described above is shown in FIG. 4. As shown in FIG. 4, the piston passage 210 connecting the upper chamber 19 and the lower chamber 20 is provided in the shock absorber 1. The damping valve 63 and the fixed orifice 215, both of which constitute the damping force generation mechanism 41, are provided in parallel in the piston passage 210. The upper chamber 19 communicates with the rod chamber 90 via the throttle 198. The rod chamber 90 communicates with the pilot chamber 211 via the throttle 106. A pressure in the pilot chamber 211 acts on the damping valve 63. In the shock absorber 1, the upper chamber communicating chamber 185 of the seal chamber 171 communicates with the upper chamber side passage 181 including the rod chamber 90. The throttle 172 serving as a throttle is provided in the upper chamber side passage 181. The throttle 172 is provided between the rod chamber 90 and the upper chamber communicating chamber 185 of the seal chamber 171. The upper chamber communicating chamber 185 and the lower chamber communicating chamber 186 in the seal chamber 171 are partitioned by the seal member 73. The lower chamber communicating chamber 186 of the seal chamber 171 communicates with the lower chamber 20 through the lower chamber side passage 173. The bypass passage 225 communicates with the rod chamber 90. The damping force generation mechanism 231 including the hard valve 221 is provided in the bypass passage 225. Also, the piston passage 260 is provided to connect the lower chamber 20 and the upper chamber 19. The disc valve 255 and the fixed orifice 265, both of which constitute the damping force generation mechanism 42, are provided in parallel in the piston passage 260.

As shown in FIG. 1, the above-described base valve 25 is provided between the inner cylinder 3 and the cylinder bottom part 12 of the outer cylinder 4. The base valve 25 includes a base valve member 281, a disc 282, a disc 283, and an attachment pin 284. The lower chamber 20 and the reservoir chamber 6 are partitioned by the base valve member 281. The disc 282 is provided on a lower side of the base valve member 281, that is, on the reservoir chamber 6 side. The disc 283 is provided on an upper side of the base valve member 281, that is, on the lower chamber 20 side. The attachment pin 284 attaches the disc 282 and the disc 283 to the base valve member 281.

The base valve member 281 is annular. The attachment pin 284 is inserted into a center of the base valve member 281 in the radial direction. A plurality of passage holes 285 and a plurality of passage holes 286 are formed in the base valve member 281. The plurality of passage holes 285 allow the oil fluid to flow between the lower chamber 20 and the reservoir chamber 6. The plurality of passage holes 286 allow the oil fluid to flow between the lower chamber 20 and the reservoir chamber 6. The plurality of passage holes 286 are provided on an outer side with respect to the plurality of passage holes 285 in a radial direction of the base valve member 281. The disc 282 on the reservoir chamber 6 side allows a flow of the oil fluid from the lower chamber 20 to the reservoir chamber 6 through the passage holes 285. The disc 282 suppresses a flow of the oil fluid from the reservoir chamber 6 to the lower chamber 20 through the passage holes 285. The disc 283 allows a flow of the oil fluid from the reservoir chamber 6 to the lower chamber 20 through the passage holes 286. The disc 283 suppresses a flow of the oil fluid from the lower chamber 20 to the reservoir chamber 6 through the passage holes 286.

The disc 282, together with the base valve member 281, constitutes a damping force generation mechanism 287. The damping force generation mechanism 287 opens during the compression stroke of the shock absorber 1 to allow the oil fluid to flow from the lower chamber 20 to the reservoir chamber 6. The damping force generation mechanism 287 generates a damping force at that time. The damping force generation mechanism 287 is a compression-side damping force generation mechanism. The disc 283, together with the base valve member 281, constitutes a suction valve 288. The suction valve 288 opens during the extension stroke of the shock absorber 1 to allow the oil fluid to flow from the reservoir chamber 6 to the lower chamber 20. Further, the suction valve 288 allows the oil fluid to flow from the reservoir chamber 6 to the lower chamber 20 so that a shortage of the fluid caused mainly due to extension of the piston rod 21 from the cylinder 2 is supplemented. At that time, the suction valve 288 performs a function of causing the oil fluid to flow substantially without generating a damping force.

Next, an operation of the shock absorber 1 will be described. In the following, a moving speed of the piston 18 will be referred to as a piston speed. Also, a frequency of reciprocation of the piston 18 is hereinafter referred to as a piston frequency.

It is assumed that the frequency sensitive mechanism 195 is not provided in the shock absorber 1. Then, during the extension stroke in which the piston rod 21 moves to the extension side, in a very low speed region in which the piston speed is lower than a first predetermined value, the oil fluid from the upper chamber 19 flows to the lower chamber 20 through the piston passage 210 without opening the damping valve 63 shown in FIG. 3. At this time, the oil fluid from the upper chamber 19 is throttled by the fixed orifice 215 and flows into the lower chamber 20. Thereby, a damping force having orifice characteristics is generated in the shock absorber 1. The orifice characteristics are characteristics in which the damping force is substantially proportional to the square of the piston speed. At this time, the damping force characteristic with respect to the piston speed exhibits hard characteristics in which an increasing rate of the damping force is relatively high with respect to an increase in the piston speed.

When the piston speed reaches a low speed region that is equal to or higher than the first predetermined value, the oil fluid from the upper chamber 19 flows to the lower chamber 20 through the piston passage 210 while opening the damping valve 63. Then, a damping force having valve characteristics is generated in the shock absorber 1. The valve characteristics are characteristics in which the damping force is substantially proportional to the piston speed. In the low speed region, an increasing rate of the damping force with respect to an increase in the piston speed is lower than the increasing rate in the very low speed region. In the low speed region, the damping force exhibits softer characteristics than the characteristics in the very low speed region.

When the piston speed reaches a medium speed region equal to or higher than a second predetermined value that is higher than the first predetermined value, the oil fluid from the upper chamber 19 flows to the throttle 198, the rod chamber 90, and the bypass passage 225 in addition to the flow to the lower chamber 20 via the piston passage 210 while opening the damping valve 63. The oil fluid flowing from the upper chamber 19 to the bypass passage 225 flows to the lower chamber 20 while opening the hard valve 221 of the damping force generation mechanism 231. Thereby, an increase in damping force is suppressed more than that in the low speed region. Therefore, in the medium speed region, an increasing rate of the damping force with respect to an increase in the piston speed is lower than that in the low speed region. In the medium speed region, the damping force exhibits softer characteristics than the characteristics in the low speed region.

When the piston speed reaches a high speed region equal to or higher than a third predetermined value that is higher than the second predetermined value, a relationship of a force acting on the damping valve 63 is such that a force in an opening direction exerted from the passage in the passage groove 38 is larger than a force in a closing direction exerted from the pilot chamber 211. Therefore, in this region, as the piston speed increases, the damping valve 63 opens further away from the valve seat part 47 of the piston 18 than that described above. Then, in addition to the flow of the oil fluid into the lower chamber 20 through the bypass passage 225 while opening the hard valve 221 as described above, the damping valve 63 is further opened to allow the oil fluid to flow into the lower chamber 20 through the piston passage 210. Therefore, an increase in damping force is further suppressed. Therefore, in the high speed region, an increasing rate of the damping force with respect to an increase in the piston speed is lower than that in the medium speed region. In the high speed region, the damping force exhibits softer characteristics than the characteristics in the medium speed region.

In the compression stroke in which the piston rod 21 moves to the compression side, in a very low speed region in which the piston speed is lower than a fourth predetermined value, the oil fluid from the lower chamber 20 flows to the upper chamber 19 through the piston passage 260 without opening the disc valve 255. At this time, the oil fluid from the lower chamber 20 is throttled by the fixed orifice 265 and flows into the upper chamber 19. Thereby, a damping force having orifice characteristics is generated in the shock absorber 1. At this time, the damping force characteristic with respect to the piston speed exhibits hard characteristics in which an increasing rate of the damping force is relatively high with respect to an increase in the piston speed.

Also, when the piston speed becomes higher than the fourth predetermined value, the oil fluid from the lower chamber 20 opens the disc valve 255 and flows to the upper chamber 19 through the piston passage 260. Thereby, a damping force having valve characteristics is generated in the shock absorber 1. Therefore, the damping force characteristic with respect to the piston speed is such that an increasing rate of the damping force with respect to an increase in the piston speed is lower than that in the very low speed region. Therefore, at this time, the damping force exhibits softer characteristics than the characteristics in the very low speed region.

Description above is a case of an operation of the shock absorber 1 on the assumption that the frequency sensitive mechanism 195 is not provided. In contrast, in the first embodiment, the frequency sensitive mechanism 195 makes the damping force variable according to the piston frequency even when the piston speed is the same.

When the piston frequency is high, an amplitude of the piston 18 is small. In the extension stroke at the time of such a high piston frequency, when a pressure in the upper chamber 19 increases, the oil fluid is introduced from the upper chamber 19 into the upper chamber communicating chamber 185 of the seal chamber 171 from the piston passage 210 via the throttle 198 and the upper chamber side passage 181. Then, in accordance with this, the seal member 73 provided in the seal chamber 171 receives a pressure of the oil fluid on the upper chamber side passage 181 side with the pressure receiving part 193 while communication between the upper chamber side passage 181 and the lower chamber side passage 173 is blocked by the seal parts 191 and 192. Thereby, the seal member 73 deforms while moving in a direction of increasing an inner diameter in the seal chamber 171. Then, the seal member 73 comes into contact with the wall surface portion 122 of the seal chamber 171 and is compressively deformed to the wall surface portion 122 side. At that time, the seal member 73 discharges the oil fluid in the lower chamber communicating chamber 186 of the seal chamber 171 from the lower chamber side passage 173 to the lower chamber 20. That is, the seal member 73 is deformed to be brought closer to the lower chamber 20 side in the seal chamber 171 to extend a volume of the upper chamber communicating chamber 185. Further, at this time, the seal member 73 blocks the communication between the upper chamber side passage 181 and the lower chamber side passage 173. Therefore, no oil fluid is discharged from the upper chamber side passage 181 to the lower chamber 20.

When the piston frequency is high, the oil fluid is introduced from the upper chamber 19 into the upper chamber communicating chamber 185 whose volume increases due to the deformation of the seal member 73 as described above in each extension stroke. As a result, a flow rate of the oil fluid flowing from the upper chamber 19 to the lower chamber 20 through the piston passage 210 while opening the damping force generation mechanism 41 reduces. In addition, when the oil fluid is introduced from the upper chamber 19 into the upper chamber communicating chamber 185, an increase in pressure of the pilot chamber 211 is suppressed compared to a case without the upper chamber communicating chamber 185, and the damping valve 63 of the damping force generation mechanism 41 is easily deformed in a valve opening direction. Thereby, a damping force on the extension side becomes soft when the piston frequency is high. At this time, the damping force generation mechanism 231 including the hard valve 221 does not open.

On the other hand, when the piston frequency is low, an amplitude of the piston 18 is large. In the extension stroke at the time of such a low piston frequency, the frequency of deformation of the seal member 73 also decreases accordingly. Then, at the beginning of the extension stroke, a larger amount of the oil fluid is introduced from the piston passage 210 into the upper chamber communicating chamber 185 of the seal chamber 171 via the throttle 198 and the upper chamber side passage 181 than when the piston frequency is high. Then, the seal member 73 is greatly deformed to be closer to the lower chamber 20 side in the seal chamber 171. Then, the seal member 73 comes into contact with the wall surface portion 122 of the seal chamber 171, is compressively deformed to the wall surface portion 122 side, and stops moving and deforming. Then, the oil fluid does not flow from the upper chamber 19 to the upper chamber communicating chamber 185. Also at this time, the seal member 73 blocks the communication between the upper chamber side passage 181 and the lower chamber side passage 173. Therefore, no oil fluid is discharged from the upper chamber side passage 181 to the lower chamber 20. When the oil fluid does not flow from the upper chamber 19 to the upper chamber communicating chamber 185, a pressure in the upper chamber communicating chamber 185 increases, and a pressure in the pilot chamber 211 communicating with the upper chamber communicating chamber 185 also increases, thereby making a state in which opening of the damping valve 63 of the damping force generation mechanism 41 is suppressed. That is, the damping force generation mechanism 41 enters a state in which the oil fluid is caused to flow from the upper chamber 19 to the lower chamber 20 through the fixed orifice 215 without opening the damping valve 63. Therefore, the damping force on the extension side when the piston frequency is low becomes harder than the damping force on the extension side when the piston frequency is high.

When the piston frequency is low and the pressure in the pilot chamber 211 further increases, the oil fluid flowing through the rod chamber 90 opens the hard valve 221 of the damping force generation mechanism 231. Then, the oil fluid flowing through the rod chamber 90 flows into the lower chamber 20 through the bypass passage 225 including a gap between the hard valve 221 and the valve seat part 153. When the pressure in the pilot chamber 211 further increases, the oil fluid flows from the piston passage 210 to the lower chamber 20 by opening the damping valve 63 of the damping force generation mechanism 41 in addition to the flow through the bypass passage 225.

Also, in the compression stroke when the piston frequency is high, if the pressure in the lower chamber 20 increases, the oil fluid is introduced from the lower chamber 20 into the lower chamber communicating chamber 186 of the seal chamber 171 via the lower chamber side passage 173. Then, the seal member 73 provided in the seal chamber 171 receives a pressure of the oil fluid of the lower chamber side passage 173 with the pressure receiving part 194 while communication between the lower chamber side passage 173 and the upper chamber side passage 181 is blocked by the seal parts 191 and 192. Thereby, the seal member 73 moves while being deformed in a direction in which the outer diameter is reduced. Then, the seal member 73 comes into contact with the wall surface portion 121 of the seal chamber 171 and is compressively deformed to the wall surface portion 121 side. At this time, the seal member 73 discharges the oil fluid in the upper chamber communicating chamber 185 of the seal chamber 171 from the upper chamber side passage 181 to the upper chamber 19 via the throttle 198 and the piston passage 210. That is, the seal member 73 is deformed to be brought closer to the upper chamber 19 side in the seal chamber 171. Also at this time, the seal member 73 blocks the communication between the lower chamber side passage 173 and the upper chamber side passage 181. Therefore, no oil fluid is introduced into the upper chamber side passage 181 from the lower chamber 20.

When the piston frequency is high, the seal member 73 is deformed in this manner in each compression stroke, and thereby the oil fluid is introduced from the lower chamber 20 into the lower chamber communicating chamber 186. As a result, a flow rate of the oil fluid flowing from the lower chamber 20 to the upper chamber 19 via the piston passage 260 while opening the disc valve 255 of the damping force generation mechanism 42 is reduced. Thereby, a damping force on the compression side becomes soft when the piston frequency is high.

On the other hand, in the compression stroke when the piston frequency is low, the frequency of deformation of the seal member 73 also decreases accordingly. Then, at the beginning of the compression stroke, a larger amount of the oil fluid flows into the lower chamber communicating chamber 186 through the lower chamber side passage 173 than when the piston frequency is high, and the seal member 73 is greatly deformed. Thereby, the seal member 73 comes into contact with the wall surface portion 121 of the seal chamber 171, is compressively deformed to the wall surface portion 121 side, and stops moving and deforming. Then, the oil fluid does not flow from the lower chamber 20 to the lower chamber communicating chamber 186. Also at this time, the seal member 73 blocks the communication between the lower chamber side passage 173 and the upper chamber side passage 181. Therefore, no oil fluid is introduced into the upper chamber side passage 181 from the lower chamber 20. When the oil fluid does not flow from the lower chamber 20 to the lower chamber communicating chamber 186, it becomes a state in which a flow rate of the oil fluid flowing to the upper chamber 19 through the piston passage 260 while opening the disc valve 255 of the damping force generation mechanism 42 is not reduced. Thereby, the damping force on the compression side when the piston frequency is low becomes harder than the damping force on the compression side when the piston frequency is high.

Further, the throttle 106 is set so that the pilot chamber 211 and the rod chamber 90 have the same pressure. The throttle 172 is set so that a portion of the seal chamber 171 closer to the rod chamber 90 than the seal member 73 and the rod chamber 90 have the same pressure.

A frequency sensitive part that makes a damping force variable in response to a frequency is provided in the shock absorbers of Patent Documents 1 and 2 described above. The frequency sensitive parts of Patent Documents 1 and 2 have a large number of parts and a complicated structure.

In the shock absorber 1 of the first embodiment, the damping valve 63 that changes a flow path area due to a flow of the oil fluid is provided in the piston passage 210 through which the oil fluid in the cylinder 2 flows due to movement of the piston 18 during the extension stroke. The shock absorber 1 also includes the upper chamber side passage 181 that communicates, via the throttle 198, with an upstream side of the damping valve 63 in a flow direction of the oil fluid in the piston passage 210 during the extension stroke. Also, the shock absorber 1 includes the lower chamber side passage 173 communicating with the lower chamber 20 downstream of the damping valve 63 in the flow direction of the oil fluid in the piston passage 210 during the extension stroke. Also, the shock absorber 1 includes the seal chamber 171 provided between the upper chamber side passage 181 and the lower chamber side passage 173. Then, the shock absorber 1 includes the seal member 73 having rubber elasticity provided in the seal chamber 171. The seal member 73 includes the seal parts 191 and 192 that suppress a flow of the oil fluid from the upper chamber side passage 181 to the lower chamber side passage 173 during the extension stroke, and the pressure receiving part 193 that receives a pressure of the upper chamber side passage 181 during the extension stroke. Therefore, when the seal member 73 is moved and deformed within the seal chamber 171, some of the oil fluid from the piston passage 210 can be introduced into the seal chamber 171. As a result, in response to the piston frequency, a flow rate of the oil fluid that flows when the damping valve 63 opens can be made variable, and the damping force can be made variable. Since the frequency sensitive mechanism 195 has a structure of moving the seal member 73 within the seal chamber 171, the structure can be simplified.

The shock absorber 1 includes the pilot chamber 211 that communicates with the upper chamber side passage 181 and generates a force in a direction of reducing a flow path area between the damping valve 63 and the valve seat part 47 due to an internal pressure. Even with a structure having the pilot chamber 211 in addition to the frequency sensitive mechanism 195, the structure can be simplified by causing the pilot chamber 211 to communicate with the upper chamber side passage 181.

The shock absorber 1 includes the bypass passage 225 that allows the upper chamber side passage 181 to communicate with the lower chamber 20 downstream of the damping valve 63 in the flow direction of the oil fluid in the piston passage 210 during the extension stroke, and the damping force generation mechanism 231 provided in the bypass passage 225. Even with a structure having the damping force generation mechanism 231 in addition to the frequency sensitive mechanism 195, the structure can be simplified by causing the bypass passage 225 to communicate with the upper chamber side passage 181.

In the shock absorber 1, the pilot case 75 in which the pilot chamber 211 is formed is disposed to sandwich the damping valve 63 between itself and the piston 18. Therefore, a mounting structure of the damping valve 63 can be simplified.

In the shock absorber 1, the seal member 73 moves in the radial direction of the seal member 73 within the seal chamber 171. Thereby, an increase in size of the frequency sensitive mechanism 195 in the axial direction can be minimized.

In the shock absorber 1, the pilot chamber 211 and the seal chamber 171 are formed in the pilot case 75 at positions at which they overlap each other in the axial direction of the pilot case 75. Thereby, an increase in size of the pilot case 75 in the axial direction can be minimized.

In the shock absorber 1, the seal chamber 171 and the lower chamber side passage 173 are formed of two members including the case member 71 and the seat member 72. Therefore, the seal chamber 171 and the lower chamber side passage 173 can be formed with a simple structure. Also, incorporation of the seal member 73 into the seal chamber 171 is also facilitated.

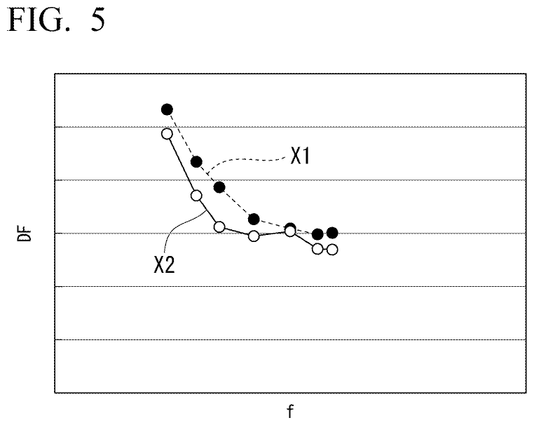

FIG. 5 compares a frequency characteristic of the shock absorber described in Patent Document 1 and a frequency characteristic of the shock absorber 1 of the first embodiment when piston speeds are the same. The vertical axis in FIG. 5 represents a damping force (DF). The horizontal axis in FIG. 5 represents a frequency (f). FIG. 5 shows a case in which a throttle having a flow path area equivalent to the flow path area of the throttle 198 of the shock absorber 1 of the first embodiment is provided in the shock absorber described in Patent Document 1. Also, FIG. 5 shows a case in which the flow path areas of the throttles 106 and 172 other than the throttle 198 in the shock absorber 1 of the first embodiment are increased than that of the throttle 198. The frequency characteristic of the shock absorber described in Patent Document 1 is X1, and the frequency characteristic of the shock absorber 1 of the first embodiment is X2. From FIG. 5, it is ascertained that, even with the shock absorber 1 of the first embodiment having a simpler structure than the shock absorber described in Patent Document 1, a frequency characteristic equivalent to that of the shock absorber described in Patent Document 1 can be obtained. Further, a cutoff frequency of the shock absorber 1 can be adjusted by adjusting an area of the throttle 198.

### Second Embodiment

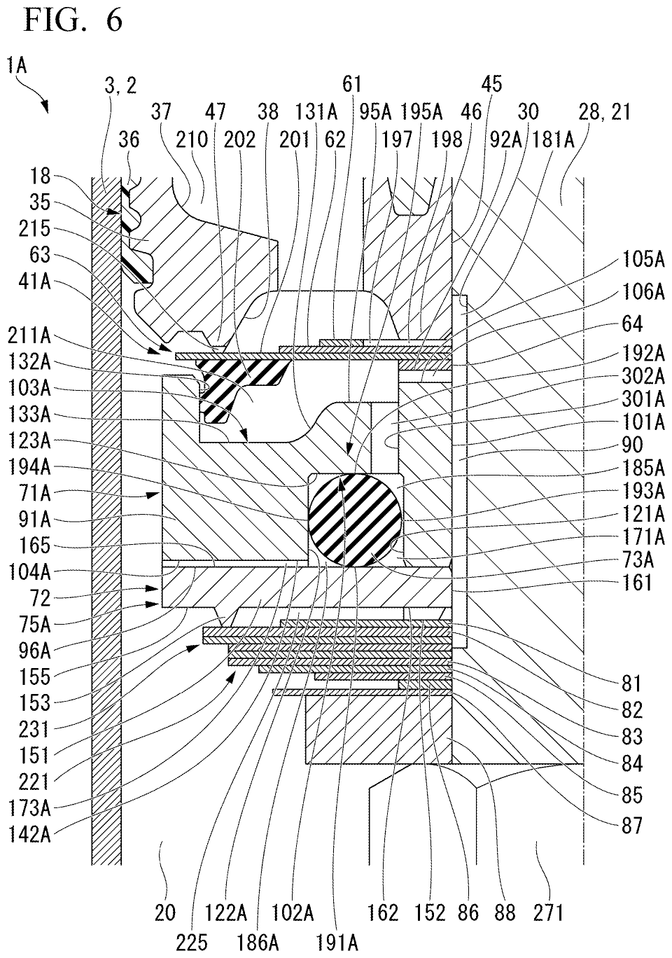

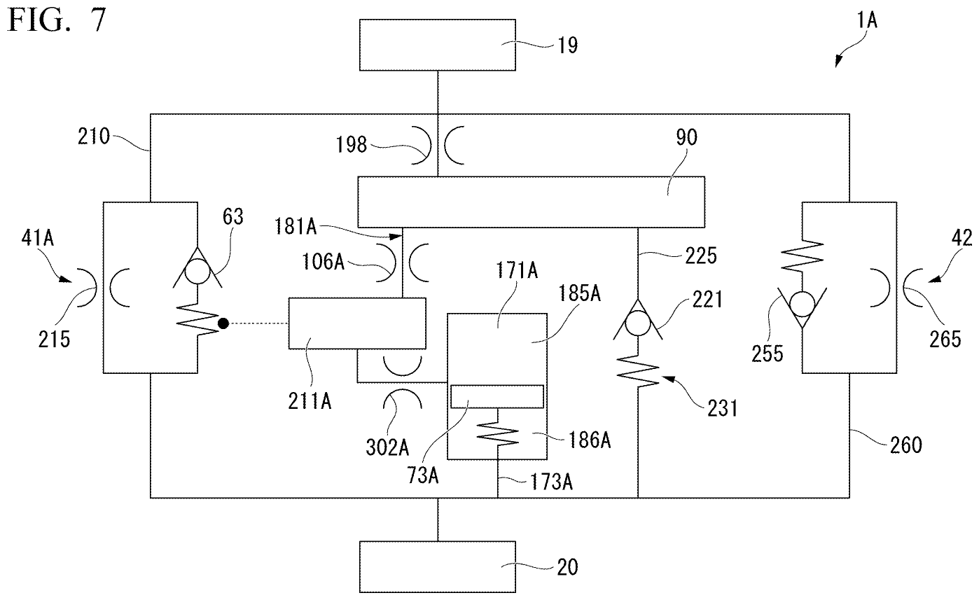

A shock absorber according to a second embodiment of the present invention will be described mainly on the basis of FIGS. 6 and 7, focusing on differences from the first embodiment. Further, parts common to those in the first embodiment will be denoted by the same terms and the same reference signs.

As shown in FIG. 6, a shock absorber 1A of the second embodiment includes a pilot case 75A instead of the pilot case 75. The pilot case 75A includes a case member 71A different from the case member 71. The pilot case 75A includes a seat member 72 similar to that of the first embodiment. In the shock absorber 1A, a seal member 73A (elastic member, moving member) having a size different from that of the seal member 73 of the first embodiment is provided in the pilot case 75A. The seal member 73A is also an O-ring. The seal member 73A is also an elastic member having rubber elasticity.

The case member 71A is made of a metal. The case member 71A is integrally formed by sintering. The case member 71A may be formed by cutting. The case member 71A is annular. A mounting shaft part 28 of a piston rod 21 is fitted to an inner circumferential side of the case member 71A. The pilot case 75A overlaps a passage groove 30 of the mounting shaft part 28 in position in an axial direction of the pilot case 75A.

The case member 71A includes a member main body part 91A and a protruding part 92A. The member main body part 91A is annular. The protruding part 92A is also annular. The protruding part 92A is provided on an inner circumferential side of the member main body part 91A. A central axis of the member main body part 91A and a central axis of the protruding part 92A coincide with each other. These central axes serve as a central axis of the case member 71A. The protruding part 92A protrudes in an axial direction of the case member 71A from a surface portion 95A on one end side of the member main body part 91A in the axial direction of the case member 71A. The surface portion 95A extends to be orthogonal to the central axis of the case member 71A. The case member 71A is in contact with the disc 64 at an end surface of the protruding part 92A on a side opposite to the member main body part 91A in the axial direction of the case member 71A.

A through hole 101A, a seat member side annular groove 102A, a piston side annular groove 103A, a seat member side radial groove 104A, a piston side radial groove 105A, and a passage hole 301A are formed in the case member 71A. The through hole 101A is formed at a center in a radial direction of the case member 71A. The through hole 101A penetrates the case member 71A in the axial direction of the case member 71A. The through hole 101A is formed of an inner circumferential surface of the member main body part 91A and an inner circumferential surface of the protruding part 92A. The inner circumferential surface of the member main body part 91A has a cylindrical surface shape. An outer circumferential surface of the member main body part 91A also has a cylindrical surface shape. A central axis of the through hole 101A coincides with the central axis of the case member 71A.

The member main body part 91A includes the seat member side annular groove 102A formed in a surface portion 96A on a side opposite to the surface portion 95A in an axial direction of the member main body part 91A. The surface portion 96A has a planar shape extending to be orthogonal to the central axis of the member main body part 91A. The seat member side annular groove 102A is recessed in the axial direction of the member main body part 91A from the surface portion 96A. The seat member side annular groove 102A surrounds the through hole 101A from an outer side in a radial direction of the member main body part 91A. The seat member side annular groove 102A is annular. A central axis of the seat member side annular groove 102A coincides with the central axis of the through hole 101A.

The seat member side annular groove 102A includes a wall surface portion 121A, a wall surface portion 122A, and a bottom surface portion 123A. The wall surface portion 122A is disposed on an outer side with respect to the wall surface portion 121A in the radial direction of the member main body part 91A. The wall surface portion 121A has a cylindrical surface shape. The wall surface portion 121A faces outward in the radial direction of the member main body part 91A. The wall surface portion 122A has a cylindrical surface shape. The wall surface portion 122A faces inward in the radial direction of the member main body part 91A. The bottom surface portion 123A connects an end edge portion of the wall surface portion 121A on a side opposite to the surface portion 96A and an end edge portion of the wall surface portion 122A on a side opposite to the surface portion 96A. The bottom surface portion 123A has a planar shape extending parallel to the surface portion 96A. A central axis of the wall surface portion 121A, a central axis of the wall surface portion 122A, and a central axis of the bottom surface portion 123A are the same as the central axis of the seat member side annular groove 102A.

The piston side annular groove 103A is recessed in the axial direction of the member main body part 91A from the surface portion 95A of the member main body part 91A. The piston side annular groove 103A is shifted outward in the radial direction of the member main body part 91A from the seat member side annular groove 102A. The piston side annular groove 103A is annular. A central axis of the piston side annular groove 103A coincides with the central axis of the through hole 101A.

The piston side annular groove 103A includes a wall surface portion 131A, a wall surface portion 132A, and a bottom surface portion 133A. The wall surface portion 132A is disposed on an outer side with respect to the wall surface portion 131A in the radial direction of the member main body part 91A. The wall surface portion 131A is an inclined surface in which a diameter thereof decreases toward the surface portion 95A in the axial direction of the member main body part 91A. The wall surface portion 131A faces outward in the radial direction of the member main body part 91A. The wall surface portion 132A has a cylindrical surface shape. The wall surface portion 132A faces inward in the radial direction of the member main body part 91A. The bottom surface portion 133A connects an end edge portion of the wall surface portion 131A on a side opposite to the surface portion 95A and an end edge portion of the wall surface portion 132A on a side opposite to the surface portion 95A. The bottom surface portion 133A has a planar shape extending parallel to the surface portion 95A. A central axis of the wall surface portion 131A, a central axis of the wall surface portion 132A, and a central axis of the bottom surface portion 133A are the same as the central axis of the piston side annular groove 103A. A portion of the seat member side annular groove 102A on the wall surface portion 122A side and a portion of the wall surface portion 131A of the piston side annular groove 103A overlap each other in position in the radial direction of the case member 71A. The seat member side annular groove 102A and the piston side annular groove 103A are formed on opposite sides of the case member 71A in the axial direction.

The seat member side radial groove 104A is formed in the surface portion 96A of the member main body part 91A. The seat member side radial groove 104A is recessed in the axial direction of the member main body part 91A from the surface portion 96A. The seat member side radial groove 104A has a depth from the surface portion 96A that is smaller than a depth of the seat member side annular groove 102A from the surface portion 96A. The seat member side radial groove 104A extends from the seat member side annular groove 102A to a radial outer end of the case member 71A. The seat member side radial groove 104A extends from the wall surface portion 122A of the seat member side annular groove 102A to the outer circumferential surface of the member main body part 91A. The seat member side radial groove 104A does not open to the rod chamber 90.

The passage hole 301A extends in the axial direction of the member main body part 91A. The passage hole 301A extends from the surface portion 95A of the member main body part 91A to the bottom surface portion 123A of the seat member side annular groove 102A. The passage hole 301A is disposed on the wall surface portion 121A side with respect to a center of the bottom surface portion 123A in the radial direction of the member main body part 91A. In other words, the passage hole 301A is provided at an inner position of the seat member side annular groove 102A in the radial direction of the member main body part 91A. A passage in the passage hole 301A constitutes a throttle 302A.

The piston side radial groove 105A is formed in the protruding part 92A. The piston side radial groove 105A is recessed in the axial direction of the case member 71A from a distal end surface of the protruding part 92A on a side opposite to the member main body part 91A in the axial direction of the case member 71A. The piston side radial groove 105A extends from the inner circumferential surface of the protruding part 92A to an outer circumferential surface of the protruding part 92A. The piston side radial groove 105A traverses the protruding part 92A in a radial direction of the protruding part 92A. The piston side radial groove 105A opens to the rod chamber 90. A passage inside the piston side radial groove 105A serves as a throttle 106A that communicates with the rod chamber 90.

When both the case member 71A and the seat member 72 are fitted on the mounting shaft part 28 of the piston rod 21, central axes thereof are made to be coincident with each other. In this state, the surface portion 96A of the case member 71A overlaps an abutment surface 165 of the seat member 72 to be in surface contact with each other. Then, the case member 71A and the seat member 72 form a seal chamber 171A (passage part) and a lower chamber side passage 173A (third passage).

The seal chamber 171A is formed inside the seat member side annular groove 102A. The seal chamber 171A is formed to be surrounded by the wall surface portion 121A, the wall surface portion 122A, the bottom surface portion 123A, and the abutment surface 165. The seal chamber 171A has an annular shape. A central axis of the seal chamber 171A and the central axes of the through holes 101A and 161 coincide with each other. The throttle 302A communicates with the seal chamber 171A.

The lower chamber side passage 173A is formed inside the seat member side radial groove 104A. The lower chamber side passage 173A is formed to be surrounded by the seat member side radial groove 104A and the abutment surface 165. One end of the lower chamber side passage 173A opens to the seal chamber 171A, and the other end opens to the lower chamber 20. The lower chamber side passage 173A communicates with the seal chamber 171A and the lower chamber 20. The seal chamber 171A is provided between the lower chamber side passage 173A and the throttle 302A.

A damping valve 63 is disposed on the piston side annular groove 103A side of the case member 71A in the axial direction of the case member 71A. At that time, the disc 64 is in contact with a disc 201 of the damping valve 63 and the protruding part 92A of the case member 71A. In the damping valve 63, a seal part 202 is slidably fitted in a liquid-tight manner to the wall surface portion 132A of the case member 71A over the entire circumference. The seal part 202 constantly seals a gap between the damping valve 63 and the wall surface portion 132A. The damping valve 63, the case member 71A, and the disc 64 form a pilot chamber 211A. In other words, the pilot case 75A includes the pilot chamber 211A formed in the case member 71A. The pilot chamber 211A includes an inner portion of the piston side annular groove 103A. The pilot chamber 211A exerts a pressure on the damping valve 63 in a direction of the piston 18. In other words, the pilot chamber 211A causes the damping valve 63 to generate a force in a direction of reducing a flow path area between the damping valve 63 and the valve seat part 47 due to an internal pressure.

The pilot chamber 211A communicates with the rod chamber 90 via the throttle 106A. In the pilot case 75A, the seal chamber 171A and the pilot chamber 211A are formed at different positions in the axial direction of the pilot case 75A. The positions of the seal chamber 171A and the pilot chamber 211A overlap each other in a radial direction of the pilot case 75A.

The shock absorber 1A of the second embodiment has a damping force generation mechanism 41A which is different from the damping force generation mechanism 41 in that it has the pilot chamber 211A different from the pilot chamber 211. The damping force generation mechanism 41A is also provided in a piston passage 210 similarly to the damping force generation mechanism 41. The damping force generation mechanism 41A also is an extension-side damping force generation mechanism similarly to the damping force generation mechanism 41.

One end of the throttle 302A opens to the seal chamber 171A, and the other end opens to the pilot chamber 211A. The throttle 302A communicates with the seal chamber 171A and the pilot chamber 211A. The rod chamber 90, the throttles 106A and 302A, and the pilot chamber 211A form an upper chamber side passage 181A (second passage).

The seal member 73A is housed in the seal chamber 171A. The seal member 73A is in contact with the bottom surface portion 123A of the seat member side annular groove 102A and the abutment surface 165 of the seat member 72 at the same time. At that time, the seal member 73A elastically deforms in an axial direction of the seal member 73A. The seal member 73A moves in a radial direction of the seal member 73A within the seal chamber 171A. The seal member 73A deforms in the radial direction of the seal member 73A within the seal chamber 171A. At least an inner diameter of the seal member 73A can be increased in the radial direction of the seal member 73A within the seal chamber 171A. At least an outer diameter of the seal member 73A can be reduced in the radial direction of the seal member 73A within the seal chamber 171A.

A seal part 191A of the seal member 73A comes into contact with the abutment surface 165 to seal between itself and the abutment surface 165. A seal part 192A of the seal member 73A comes into contact with the bottom surface portion 123A to seal between itself and the bottom surface portion 123A. The seal parts 191A and 192A are also provided in the seal chamber 171A. The seal parts 191A and 192A of the seal member 73A suppress a flow of an oil fluid from the upper chamber side passage 181A side including the throttles 106A and 302A to the lower chamber side passage 173A side. The seal parts 191A and 192A also suppress a flow of the oil fluid from the lower chamber side passage 173A side to the upper chamber side passage 181A side. A pressure receiving part 193A on the wall surface portion 121A side of the seal member 73A receives a pressure on the upper chamber side passage 181A side. A pressure receiving part 194A on the wall surface portion 122A side of the seal member 73A receives a pressure on the lower chamber side passage 173 side. The seal member 73A has a seal function that partitions the inside of the seal chamber 171A into an upper chamber communicating chamber 185A communicating with the upper chamber side passage 181A and a lower chamber communicating chamber 186A communicating with the lower chamber side passage 173A. The seal member 73A has both the seal function and a property of elastic deformation at the same time.

The seal chamber 171A, the throttles 106A and 302A, the pilot chamber 211A, the lower chamber side passage 173A, and the seal member 73A constitute a frequency sensitive mechanism 195A that makes a damping force variable in response to a frequency of reciprocation of the piston 18. The frequency sensitive mechanism 195A is provided in the pilot case 75A. In the frequency sensitive mechanism 195A, the seal chamber 171A, the lower chamber side passage 173A, and the throttle 302A are formed of two members including the case member 71A and the seat member 72.

The damping force generation mechanism 41A introduces some of the flow of the oil fluid in the piston passage 210 into the pilot chamber 211A via a throttle 198, the rod chamber 90, and the throttle 106A. The damping force generation mechanism 41A controls an opening of the damping valve 63 using a pressure in the pilot chamber 211A. The frequency sensitive mechanism 195A introduces some of the flow of the oil fluid in the piston passage 210 into the upper chamber communicating chamber 185A of the seal chamber 171A via the throttle 198, the rod chamber 90, the throttle 106A, the pilot chamber 211A, and the throttle 302A.

The upper chamber side passage 181A including the rod chamber 90 communicates with an upstream side of the damping valve 63 in a flow direction of the oil fluid in the piston passage 210 via the throttle 198 during an extension stroke. The upper chamber side passage 181A communicates with the upper chamber communicating chamber 185A of the seal chamber 171A. The lower chamber side passage 173A communicates with the lower chamber communicating chamber 186A of the seal chamber 171A. The lower chamber side passage 173A communicates with the lower chamber 20 downstream of the damping valve 63 in the flow direction of the oil fluid in the piston passage 210 during the extension stroke.

Here, when the above-described parts are assembled to the mounting shaft part 28 of the piston rod 21, the case member 71A is assembled instead of the case member 71. Also, the seal member 73A is assembled instead of the seal member 73. Other than these, assembly is performed in the same manner as in the first embodiment. Thereby, the pilot case 75A is disposed to sandwich the damping valve 63 between itself and the piston 18. Thereby, the central axis of the case member 71A is made to coincide with a central axis of the piston rod 21.

FIG. 7 shows a hydraulic circuit diagram of a portion of the vicinity of the piston 18 of the shock absorber 1A configured as described above. As shown in FIG. 7, in the shock absorber 1A, the rod chamber 90 communicates with the pilot chamber 211A via the throttle 106A. The pilot chamber 211A communicates with the upper chamber communicating chamber 185A of the seal chamber 171A via the throttle 302A. The upper chamber side passage 181A is constituted by the rod chamber 90, the throttles 106A and 302A, and the pilot chamber 211A. The throttle 302A is provided between the pilot chamber 211A and the upper chamber communicating chamber 185A of the seal chamber 171A. The lower chamber communicating chamber 186A of the seal chamber 171A communicates with the lower chamber 20 through the lower chamber side passage 173A.

During the extension stroke of the shock absorber 1A configured as described above, the oil fluid is introduced from the piston passage 210 into the upper chamber communicating chamber 185A of the seal chamber 171A via the throttle 198 and the upper chamber side passage 181A. Then, the seal member 73A deforms while moving in a direction in which a diameter thereof increases. At that time, the oil fluid is discharged from the lower chamber communicating chamber 186A of the seal chamber 171A to the lower chamber 20 through the lower chamber side passage 173A. During a compression stroke of the shock absorber 1A, the oil fluid is introduced from the lower chamber 20 into the lower chamber communicating chamber 186A of the seal chamber 171A through the lower chamber side passage 173A. Then, the seal member 73A moves and deforms in a direction in which the diameter is reduced. At that time, the oil fluid is discharged from the upper chamber communicating chamber 185A of the seal chamber 171A to the piston passage 210, that is, the upper chamber 19, through the upper chamber side passage 181A and the throttle 198. Operations other than these of the frequency sensitive mechanism 195A are substantially the same as those of the shock absorber 1.

The shock absorber 1A of the second embodiment includes the upper chamber side passage 181A that communicates, via the throttle 198, with an upstream side of the damping valve 63 in the flow direction of the oil fluid in the piston passage 210 during the extension stroke. Also, the shock absorber 1A includes the lower chamber side passage 173A that communicates with the lower chamber 20 downstream of the damping valve 63 in the flow direction of the oil fluid in the piston passage 210 during the extension stroke. Also, the shock absorber 1A includes the seal chamber 171A provided between the upper chamber side passage 181A and the lower chamber side passage 173A. Then, the shock absorber 1A includes the seal member 73A having rubber elasticity provided in the seal chamber 171A. Therefore, the shock absorber 1A has a structure in which the frequency sensitive mechanism 195A moves and deforms the seal member 73A within the seal chamber 171A. Also, the shock absorber 1A includes the pilot chamber 211A provided in the upper chamber side passage 181A. Also, in the shock absorber 1A, the bypass passage 225 communicates with the upper chamber side passage 181A. Also, in the shock absorber 1A, the pilot case 75A in which the pilot chamber 211A is formed is disposed to sandwich the damping valve 63 between itself and the piston 18. Also, in the shock absorber 1A, the seal chamber 171A and the lower chamber side passage 173A are formed of two members including the case member 71A and the seat member 72. As described above, a structure of the shock absorber 1A can be simplified similarly to the shock absorber 1.

Further, in the shock absorber 1A, the piston side radial groove 105A of the protruding part 92A may be removed, and a throttle forming disc similar to the disc 61 may be provided between the protruding part 92A and the damping valve 63. Thereby, the throttle 106A can be formed by a notch in the throttle forming disc similarly to the notch 197. In this way, a size of the throttle 106A can be easily changed by exchanging the throttle forming disc, and a flow rate of the oil fluid to the seal chamber 171A can be easily adjusted.

### Third Embodiment

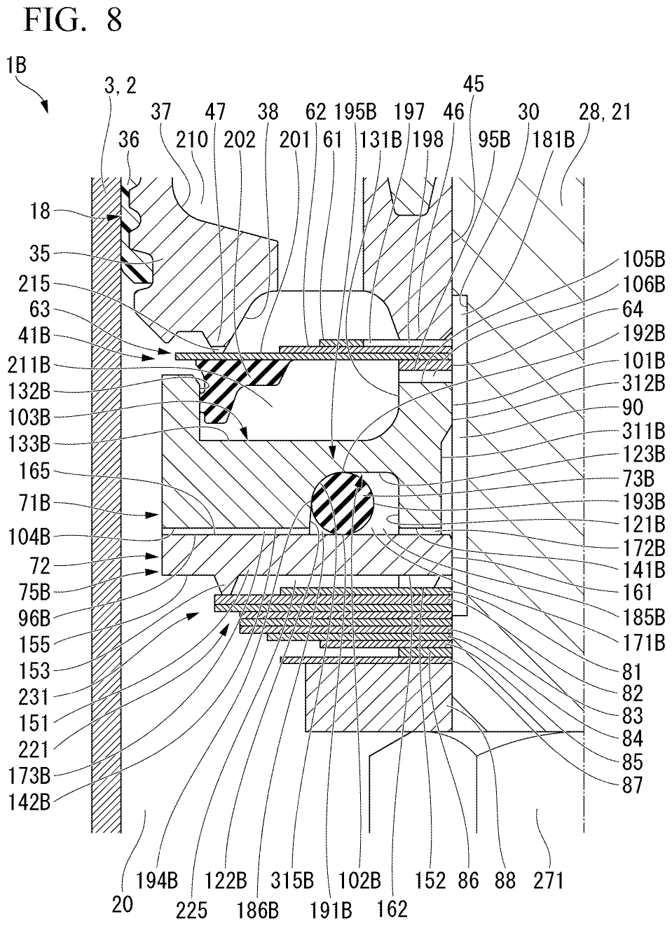

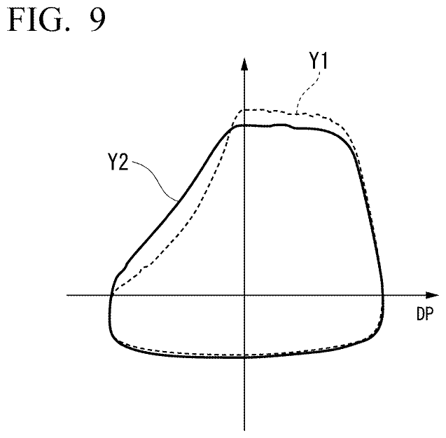

A shock absorber according to a third embodiment of the present invention will be described mainly on the basis of FIGS. 8 and 9, focusing on differences from the first embodiment. Further, parts common to those in the first embodiment will be denoted by the same terms and the same reference signs.

As shown in FIG. 8, a shock absorber 1B of the third embodiment includes a pilot case 75B instead of the pilot case 75. The pilot case 75B includes a case member 71B different from the case member 71. The pilot case 75B includes a seat member 72 similar to that of the first embodiment. In the shock absorber 1B, a seal member 73B (elastic member, moving member) having a size different from that of the seal member 73 of the first embodiment is provided in the pilot case 75B. The seal member 73B also is an O-ring. The seal member 73B also is an elastic member having rubber elasticity.

The case member 71B is made of a metal. The case member 71B is integrally formed by sintering. The case member 71B may be formed by cutting. The case member 71B has an annular shape. A mounting shaft part 28 of a piston rod 21 is fitted to an inner circumferential side of the case member 71B. The pilot case 75B overlaps a passage groove 30 of the mounting shaft part 28 in position in an axial direction of the pilot case 75B.

In the case member 71B, a surface portion 95B on one end side in an axial direction of the case member 71B is in contact with a disc 64. The surface portion 95B extends to be orthogonal to a central axis of the case member 71B. A through hole 101B, a seat member side annular groove 102B, a piston side annular groove 103B, a seat member side radial groove 104B, and a piston side radial groove 105B are formed in the case member 71B.

The through hole 101B is formed at a center in a radial direction of the case member 71B. The through hole 101B penetrates the case member 71B in the axial direction of the case member 71B. The through hole 101B has a large diameter hole portion 311B and a small diameter hole portion 312B. A central axis of the large diameter hole portion 311B and a central axis of the small diameter hole portion 312B coincide with each other. An inner diameter of the large diameter hole portion 311B is larger than an inner diameter of the small diameter hole portion 312B. The small diameter hole portion 312B is provided on the surface portion 95B side with respect to the large diameter hole portion 311B in an axial direction of the through hole 101B. The through hole 101B is formed of an inner circumferential surface of the case member 71B. The inner circumferential surface of the case member 71B has a stepped cylindrical surface shape. An outer circumferential surface of the case member 71B has a cylindrical surface shape. A central axis of the through hole 101B coincides with the central axis of the case member 71B. The mounting shaft part 28 is fitted in the small diameter hole portion 312B of the case member 71B.

The case member 71B includes the seat member side annular groove 102B formed in a surface portion 96B on a side opposite to the surface portion 95B in the axial direction of the case member 71B. The surface portion 96B has a planar shape extending to be orthogonal to the central axis of the case member 71B. The seat member side annular groove 102B is recessed in the axial direction of the case member 71B from the surface portion 96B. The seat member side annular groove 102B surrounds the through hole 101B from an outer side in the radial direction of the case member 71B. The seat member side annular groove 102B is annular. A central axis of the seat member side annular groove 102B coincides with the central axis of the through hole 101B.

The seat member side annular groove 102B has a wall surface portion 121B, a wall surface portion 122B, and a bottom surface portion 123B. The wall surface portion 122B is disposed on an outer side with respect to the wall surface portion 121B in the radial direction of the case member 71B. The wall surface portion 121B has a cylindrical surface shape. The wall surface portion 121B faces outward in the radial direction of the case member 71B. A portion of the wall surface portion 122B on a side opposite to the surface portion 96B in the axial direction of the case member 71B has a substantially cylindrical surface shape with an R chamfer 315B. The wall surface portion 122B faces inward in the radial direction of the case member 71B. The bottom surface portion 123B connects an end edge portion of the wall surface portion 121B on a side opposite to the surface portion 96B and an end edge portion of the wall surface portion 122B on a side opposite to the surface portion 96B. The bottom surface portion 123B has a planar shape extending parallel to the surface portion 96B. A central axis of the wall surface portion 121B, a central axis of the wall surface portion 122B, and a central axis of the bottom surface portion 123B are the same as the central axis of the seat member side annular groove 102B.

The piston side annular groove 103B is recessed in the axial direction of the case member 71B from the surface portion 95B of the case member 71B. In the radial direction of the case member 71B, a position of the piston side annular groove 103B and a position of the seat member side annular groove 102B overlap each other. The piston side annular groove 103B is annular. A central axis of the piston side annular groove 103B coincides with the central axis of the through hole 101B.

The piston side annular groove 103B has a wall surface portion 131B, a wall surface portion 132B, and a bottom surface portion 133B. The wall surface portion 132B is disposed on an outer side with respect to the wall surface portion 131B in the radial direction of the case member 71B. A portion of the wall surface portion 131B on a side opposite to the surface portion 95B in the axial direction of the case member 71B has a substantially cylindrical surface shape with an R chamfering. The wall surface portion 131B faces outward in the radial direction of the case member 71B. The wall surface portion 132B has a cylindrical surface shape. The wall surface portion 132B faces inward in the radial direction of the case member 71B. The bottom surface portion 133B connects an end edge portion of the wall surface portion 131B on a side opposite to the surface portion 95B and an end edge portion of the wall surface portion 132B on a side opposite to the surface portion 95B. The bottom surface portion 133B has a planar shape extending parallel to the surface portion 95B. A central axis of the wall surface portion 131B, a central axis of the wall surface portion 132B, and a central axis of the bottom surface portion 133B are the same as the central axis of the piston side annular groove 103B. The seat member side annular groove 102B and the piston side annular groove 103B are formed on opposite sides of the case member 71B in the axial direction.

The seat member side radial groove 104B is formed in the surface portion 96B of the case member 71B. The seat member side radial groove 104B is recessed in the axial direction of the case member 71B from the surface portion 96B. The seat member side radial groove 104B has a depth from the surface portion 96B that is smaller than a depth of the seat member side annular groove 102B from the surface portion 96B. The seat member side radial groove 104B traverses the seat member side annular groove 102B in the radial direction of the case member 71B. The seat member side radial groove 104B has an inner groove part 141B and an outer groove part 142B. The inner groove part 141B extends from the large diameter hole portion 311B of the case member 71B to the wall surface portion 121B of the seat member side annular groove 102B. The outer groove part 142B extends from the wall surface portion 122B of the seat member side annular groove 102B to the outer circumferential surface of the case member 71B. The inner groove part 141B communicates with a rod chamber 90.

The piston side radial groove 105B is formed in the surface portion 95B of the case member 71B. The piston side radial groove 105B is recessed in the axial direction of the case member 71B from the surface portion 95B. The piston side radial groove 105B extends from the inner circumferential surface of the case member 71B to the wall surface portion 131B of the piston side annular groove 103B. The piston side radial groove 105B opens to the rod chamber 90. A passage inside the piston side radial groove 105B serves as a throttle 106B that communicates with the rod chamber 90.

When both the case member 71B and the seat member 72 are fitted on the mounting shaft part 28 of the piston rod 21, central axes thereof are made to be coincident with each other. In this state, the surface portion 96B of the case member 71B overlaps an abutment surface 165 of the seat member 72 to be in surface contact with each other. Then, the case member 71B and the seat member 72 form a seal chamber 171B (passage part), a throttle 172B, and a lower chamber side passage 173B (third passage).

The seal chamber 171B is formed inside the seat member side annular groove 102B. The seal chamber 171B is formed to be surrounded by the wall surface portion 121B, the wall surface portion 122B, the bottom surface portion 123B, and the abutment surface 165. The seal chamber 171B has an annular shape. A central axis of the seal chamber 171B and the central axes of the through holes 101B and 161 coincide with each other.

The throttle 172B is formed inside the inner groove part 141B. The throttle 172B is formed to be surrounded by the inner groove part 141B and the abutment surface 165. One end of the throttle 172B opens to the seal chamber 171B, and the other end opens to a passage in the large diameter hole portion 311B. The passage in the large diameter hole portion 311B communicates with the rod chamber 90. The throttle 172B communicates with the seal chamber 171B and the rod chamber 90. The rod chamber 90, the passage in the large diameter hole portion 311B, and the throttle 172B form an upper chamber side passage 181B (second passage).

The lower chamber side passage 173B is formed inside the outer groove part 142B. The lower chamber side passage 173B is formed to be surrounded by the outer groove part 142B and the abutment surface 165. One end of the lower chamber side passage 173B opens to the seal chamber 171B, and the other end opens to the lower chamber 20. The lower chamber side passage 173B communicates with the seal chamber 171B and the lower chamber 20. The seal chamber 171B is provided between the lower chamber side passage 173B and the throttle 172B of the upper chamber side passage 181B.

The seal member 73B is housed in the seal chamber 171B. The seal member 73B is in contact with the bottom surface portion 123B of the seat member side annular groove 102B and the abutment surface 165 of the seat member 72 at the same time. At that time, the seal member 73B elastically deforms in an axial direction of the seal member 73B. When a pressure in the seal chamber 171B is constant, a curvature of the R chamfer 315B is determined so that the seal member 73B comes in surface contact with the R chamfer 315B of the wall surface portion 122B. The seal member 73B moves in a radial direction of the seal member 73B within the seal chamber 171B. The seal member 73B deforms in the radial direction of the seal member 73B within the seal chamber 171B. At least an inner diameter of the seal member 73B can be increased in the radial direction of the seal member 73B within the seal chamber 171B. At least an outer diameter of the seal member 73B can be reduced in the radial direction of the seal member 73B within the seal chamber 171B.

A seal part 191B of the seal member 73B comes into contact with the abutment surface 165 to seal between itself and the abutment surface 165. A seal part 192B of the seal member 73B comes into contact with the bottom surface portion 123B to seal between itself and the bottom surface portion 123B. The seal parts 191B and 192B of the seal member 73B are also provided in the seal chamber 171B. The seal parts 191B and 192B of the seal member 73B suppress a flow of an oil fluid from the upper chamber side passage 181B side including the throttle 172B to the lower chamber side passage 173B side. The seal parts 191B and 192B also suppress a flow of the oil fluid from the lower chamber side passage 173B side to the upper chamber side passage 181B side. A pressure receiving part 193B on the wall surface portion 121B side of the seal member 73B receives a pressure on the upper chamber side passage 181B side. In the seal member 73B, a pressure receiving part 194B on the wall surface portion 122B side receives a pressure on the lower chamber side passage 173B side. The seal member 73B has a seal function that partitions the inside of the seal chamber 171B into an upper chamber communicating chamber 185B communicating with the upper chamber side passage 181B and a lower chamber communicating chamber 186B communicating with the lower chamber side passage 173B. The seal member 73B has both the seal function and a property of elastic deformation at the same time.

The seal chamber 171B, the throttle 172B, the lower chamber side passage 173B, and the seal member 73B constitute a frequency sensitive mechanism 195B that makes a damping force variable in response to a frequency of reciprocation of the piston 18. The frequency sensitive mechanism 195B is provided in the pilot case 75B. In the frequency sensitive mechanism 195B, the seal chamber 171B, the throttle 172B, and the lower chamber side passage 173B are formed of two members including the case member 71B and the seat member 72.

A damping valve 63 is disposed on the piston side annular groove 103B side of the case member 71B in the axial direction of the case member 71B. At that time, the disc 64 is in contact with a disc 201 of the damping valve 63 and the surface portion 95B of the case member 71B. In the damping valve 63, a seal part 202 is slidably fitted in a liquid-tight manner to the wall surface portion 132B of the case member 71B over the entire circumference. The seal part 202 constantly seals a gap between the damping valve 63 and the wall surface portion 132B. The damping valve 63, the case member 71B, and the disc 64 form a pilot chamber 211B. In other words, the pilot chamber 211B is formed in the case member 71B. The pilot chamber 211B includes an inner portion of the piston side annular groove 103B. The pilot chamber 211B exerts a pressure on the damping valve 63 in a direction of the piston 18. In other words, the pilot chamber 211B causes the damping valve 63 to generate a force in a direction of reducing a flow path area between the damping valve 63 and the valve seat part 47 due to an internal pressure.

The pilot chamber 211B communicates with the rod chamber 90 of the upper chamber side passage 181B via the throttle 106B. In the pilot case 75B, the seal chamber 171B and the pilot chamber 211B are formed at different positions in the axial direction of the pilot case 75B. The positions of the seal chamber 171B and the pilot chamber 211B overlap each other in a radial direction of the pilot case 75B.

The shock absorber 1B of the third embodiment includes the damping force generation mechanism 41B which is different from the damping force generation mechanism 41 in that it has the pilot chamber 211B different from the pilot chamber 211. The damping force generation mechanism 41B is also provided in the piston passage 210 similarly to the damping force generation mechanism 41. The damping force generation mechanism 41B also is an extension-side damping force generation mechanism similarly to the damping force generation mechanism 41.

In the damping force generation mechanism 41B, some of the flow of the oil fluid in the piston passage 210 is introduced into the pilot chamber 211B via the throttle 198, the rod chamber 90, and the throttle 106B. The damping force generation mechanism 41B controls an opening of the damping valve 63 due to a pressure in the pilot chamber 211B. In the frequency sensitive mechanism 195B, some of the flow of the oil fluid in the piston passage 210 is introduced into the upper chamber communicating chamber 185B of the seal chamber 171B via the throttle 198, the rod chamber 90, and the throttle 172B.

The upper chamber side passage 181B including the rod chamber 90 communicates, via the throttle 198, with an upstream side of the damping valve 63 in a flow direction of the oil fluid in the piston passage 210 during the extension stroke. The upper chamber side passage 181B communicates with the upper chamber communicating chamber 185B of the seal chamber 171B. The lower chamber side passage 173B communicates with the lower chamber communicating chamber 186B of the seal chamber 171B. The lower chamber side passage 173B communicates with the lower chamber 20 downstream of the damping valve 63 in the flow direction of the oil fluid in the piston passage 210 during the extension stroke.

Here, when the above-described parts are assembled to the mounting shaft part 28 of the piston rod 21, the case member 71B is assembled instead of the case member 71. Also, the seal member 73B is assembled instead of the seal member 73. Other than these, assembly is performed in the same manner as in the first embodiment. Thereby, the pilot case 75B is disposed to sandwich the damping valve 63 between itself and the piston 18. Thereby, the central axis of the case member 71B is made to coincide with a central axis of the piston rod 21.

A hydraulic circuit diagram of a portion of the vicinity of the piston 18 of the shock absorber 1B configured as described above is the same as the hydraulic circuit diagram of the shock absorber 1 shown in FIG. 4.

During the extension stroke of the shock absorber 1B configured as described above, the oil fluid is introduced from the piston passage 210 into the upper chamber communicating chamber 185B of the seal chamber 171B via the throttle 198 and the upper chamber side passage 181B. At this time, the seal member 73B comes in surface contact with the R chamfer 315B of the wall surface portion 122B. Therefore, the seal member 73B immediately starts compressive deformation outward in the radial direction of the seal member 73B. During the compression stroke of the shock absorber 1B, the oil fluid is introduced from the lower chamber 20 into the lower chamber communicating chamber 186B of the seal chamber 171B through the lower chamber side passage 173B. Then, the seal member 73B deforms while moving to reduce a diameter thereof. At that time, the oil fluid is discharged from the upper chamber communicating chamber 185B of the seal chamber 171B to the piston passage 210, that is, the upper chamber 19, through the upper chamber side passage 181B and the throttle 198. Operations other than these of the frequency sensitive mechanism 195B are substantially the same as those of the shock absorber 1.

The shock absorber 1B of the third embodiment includes the upper chamber side passage 181B that communicates, via the throttle 198, with an upstream side of the damping valve 63 in the flow direction of the oil fluid in the piston passage 210 during the extension stroke. Also, the shock absorber 1B includes the lower chamber side passage 173B that communicates with the lower chamber 20 downstream of the damping valve 63 in the flow direction of the oil fluid in the piston passage 210 during the extension stroke. Also, the shock absorber 1B includes the seal chamber 171B provided between the upper chamber side passage 181B and the lower chamber side passage 173B. Then, the shock absorber 1B includes the seal member 73B having rubber elasticity provided in the seal chamber 171B. Therefore, the shock absorber 1B has a structure in which the frequency sensitive mechanism 195B moves the seal member 73B within the seal chamber 171B. Also, in the shock absorber 1B, the pilot chamber 211B communicates with the upper chamber side passage 181B. Also, in the shock absorber 1B, the bypass passage 225 communicates with the upper chamber side passage 181B. Also, in the shock absorber 1B, the pilot case 75B in which the pilot chamber 211B is formed is disposed to sandwich the damping valve 63 between the pilot case 75B and the piston 18. Also, in the shock absorber 1B, the seal chamber 171B and the lower chamber side passage 173B are formed of two members including the case member 71B and the seat member 72. As described above, a structure of the shock absorber 1B can be simplified similarly to the shock absorber 1.

Also, in the shock absorber 1B, the seal member 73B moves in the radial direction of the seal member 73 within the seal chamber 171B. Thereby, similarly to the shock absorber 1, the shock absorber 1B can suppress an increase in size of the frequency sensitive mechanism 195B in the axial direction.

Also, in the shock absorber 1B, the seal member 73B comes in surface contact with the R chamfer 315B of the wall surface portion 122B of the seal chamber 171B. In other words, the shock absorber 1B eliminates a gap between the seal member 73B and the R chamfer 315B of the seal chamber 171B. Thereby, rigidity due to linear compression of the seal member 73B is larger than rigidity due to the seal member 73B moving to fill the gap between itself and the wall surface portion 122B. FIG. 9 shows a Lissajous waveform Y1 of the shock absorber 1 of the first embodiment and a Lissajous waveform Y2 of the shock absorber 1B of the third embodiment. In FIG. 9, the horizontal axis represents displacement (DP). As shown in FIG. 9, the Lissajous waveform Y2 of the shock absorber 1B has a larger inclination from a soft damping force to a hard damping force compared to the Lissajous waveform Y1 of the shock absorber 1 of the first embodiment.

### Fourth Embodiment

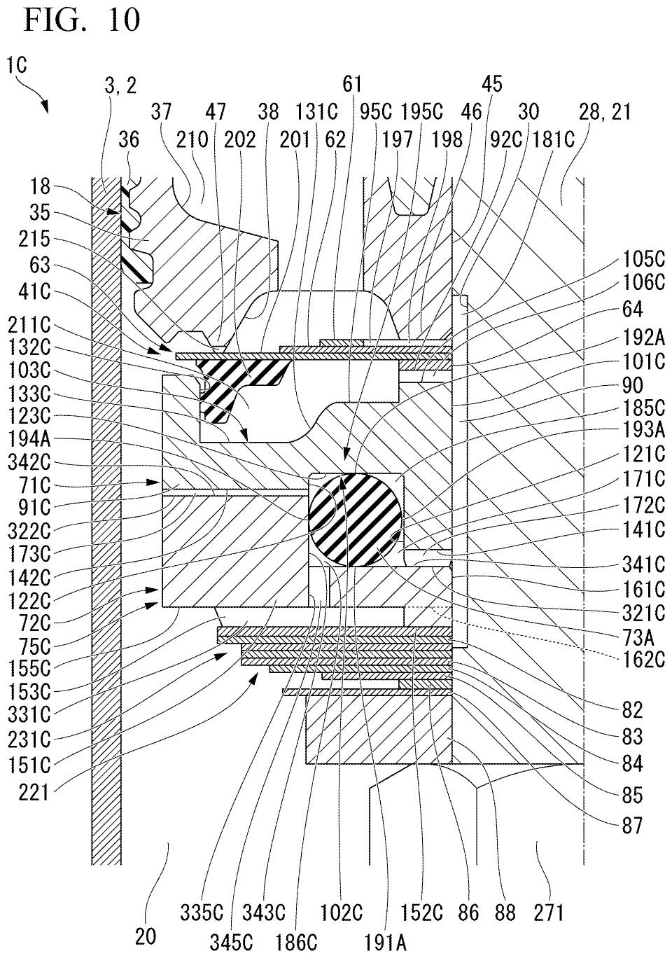

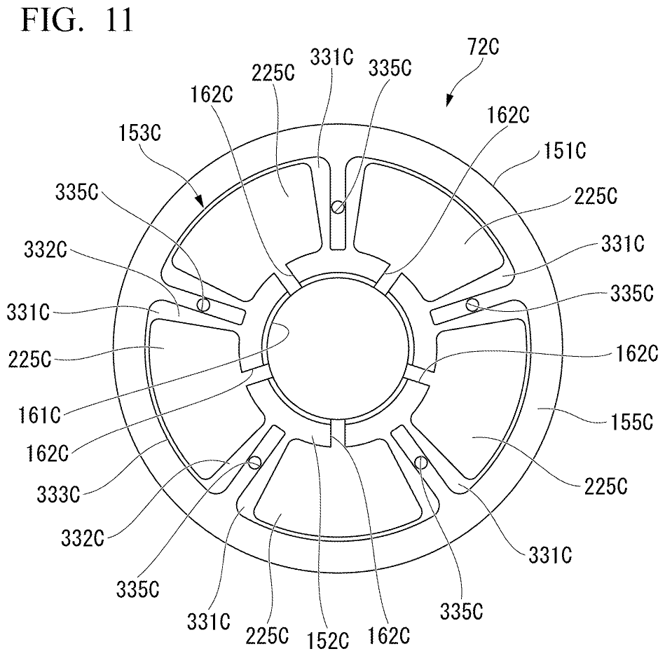

A shock absorber according to a fourth embodiment of the present invention will be described mainly on the basis of FIGS. 10 and 11, focusing on differences from the first and second embodiments. Further, parts common to those in the first and second embodiments will be denoted by the same terms and the same reference signs.

As shown in FIG. 10, a shock absorber 1C of the third embodiment includes a pilot case 75C instead of the pilot cases 75 and 75A. The pilot case 75C includes a case member 71C that is partially different from the case members 71 and 71A. The pilot case 75C includes a seat member 72C that is partially different from the seat member 72. A seal member 73A similar to that of the second embodiment is provided in the pilot case 75C.

Both the case member 71C and the seat member 72C are made of a metal. Both the case member 71C and the seat member 72C are integrally formed by sintering. At least either of the case member 71C and the seat member 72C may be formed by cutting. Both the case member 71C and the seat member 72C are annular. Both the case member 71C and the seat member 72C have a mounting shaft part 28 of a piston rod 21 fitted to an inner circumferential side thereof. The pilot case 75C overlaps a passage groove 30 of the mounting shaft part 28 in position in an axial direction of the piston rod 21.

The case member 71C includes a member main body part 91C and a protruding part 92C. The member main body part 91C has an annular shape. The protruding part 92C is provided on an inner circumferential side of the member main body part 91C. A central axis of the member main body part 91C and a central axis of the protruding part 92C coincide with each other. These central axes serve as a central axis of the case member 71C. The protruding part 92C protrudes in an axial direction of the case member 71C from a surface portion 95C on one end side of the member main body part 91C in the axial direction of the case member 71C. The surface portion 95C extends to be orthogonal to the central axis of the case member 71C. The case member 71C is in contact with a disc 64 at an end surface of the protruding part 92C on a side opposite to the member main body part 91C in the axial direction of the case member 71C.

A through hole 101C, a seat member side annular groove 102C, a piston side annular groove 103C, a seat member side inner groove 141C, a seat member side outer groove 142C, and a piston side radial groove 105C are formed in the case member 71C. The through hole 101C is formed at a center in a radial direction of the case member 71C. The through hole 101C penetrates the case member 71C in the axial direction of the case member 71C. The through hole 101C is formed of an inner circumferential surface of the member main body part 91C and an inner circumferential surface of the protruding part 92C. The inner circumferential surface of the member main body part 91C has a cylindrical surface shape. An outer circumferential surface of the member main body part 91C also has a cylindrical surface shape. A central axis of the through hole 101C coincides with the central axis of the case member 71C.

The member main body part 91C has a surface portion 321C and a surface portion 322C. The surface portion 321C and the surface portion 322C are both disposed on a side of the member main body part 91C opposite to the surface portion 95C in the axial direction of the case member 71C. The surface portion 322C is on an outer side with respect to the surface portion 321C in a radial direction of the member main body part 91C. The surface portion 322C is on the surface portion 95C side with respect to the surface portion 321C in the axial direction of the member main body part 91C. Both the surface portions 321C and 322C have a planar shape extending to be orthogonal to the central axis of the member main body part 91C. The seat member side annular groove 102C is formed between the surface portion 321C and the surface portion 322C. The seat member side annular groove 102C is recessed in the axial direction of the member main body part 91C from the surface portion 321C and the surface portion 322C. The seat member side annular groove 102C surrounds the through hole 101C from an outer side in the radial direction of the member main body part 91C. The seat member side annular groove 102C is annular. A central axis of the seat member side annular groove 102C coincides with the central axis of the through hole 101C.

The seat member side annular groove 102C has a wall surface portion 121C, a wall surface portion 122C, and a bottom surface portion 123C. The wall surface portion 122C is disposed on an outer side with respect to the wall surface portion 121C in the radial direction of the member main body part 91C. The wall surface portion 121C has a cylindrical surface shape. The wall surface portion 121C faces outward in the radial direction of the member main body part 91C. The wall surface portion 122C has a cylindrical surface shape. The wall surface portion 122C faces inward in the radial direction of the member main body part 91C. The bottom surface portion 123C connects an end edge portion of the wall surface portion 121C on a side opposite to the surface portion 321C in the axial direction of the seat member side annular groove 102C and an end edge portion of the wall surface portion 122C on a side opposite to the surface portion 322C. The bottom surface portion 123C has a planar shape extending parallel to the surface portions 321C and 322C. A central axis of the wall surface portion 121C, a central axis of the wall surface portion 122C, and a central axis of the bottom surface portion 123C are the same as the central axis of the seat member side annular groove 102C.

The piston side annular groove 103C is recessed in the axial direction of the member main body part 91C from the surface portion 95C of the member main body part 91C. The piston side annular groove 103C is disposed on an outer side with respect to the seat member side annular groove 102C in the radial direction of the member main body part 91C. The piston side annular groove 103C is annular. A central axis of the piston side annular groove 103C coincides with the central axis of the through hole 101C.

The piston side annular groove 103C has a wall surface portion 131C, a wall surface portion 132C, and a bottom surface portion 133C. The wall surface portion 132C is disposed on an outer side with respect to the wall surface portion 131C in the radial direction of the member main body part 91C. The wall surface portion 131C is an inclined surface an inclined surface in which a diameter thereof decreases toward the surface portion 95C in the axial direction of the member main body part 91C. The wall surface portion 131C faces outward in the radial direction of the member main body part 91C. The wall surface portion 132C has a cylindrical surface shape. The wall surface portion 132C faces inward in the radial direction of the member main body part 91C. The bottom surface portion 133C connects an end edge portion of the wall surface portion 131C on a side opposite to the surface portion 95C and an end edge portion of the wall surface portion 132C on a side opposite to the surface portion 95C. The bottom surface portion 133C has a planar shape extending parallel to the surface portion 95C. A central axis of the wall surface portion 131C, a central axis of the wall surface portion 132C, and a central axis of the bottom surface portion 133C are the same as the central axis of the piston side annular groove 103C. A part of the seat member side annular groove 102C on the wall surface portion 122C side and a portion of the piston side annular groove 103C on the wall surface portion 131C side overlap each other in position in the radial direction of the member main body part 91C. The seat member side annular groove 102C and the piston side annular groove 103C are formed on opposite sides of the case member 71 in the axial direction.

The seat member side inner groove 141C is formed in the surface portion 321C of the member main body part 91C. The seat member side inner groove 141C is recessed in the axial direction of the member main body part 91C from the surface portion 321C. The seat member side inner groove 141C has a depth from the surface portion 321C that is smaller than a depth of the seat member side annular groove 102C from the surface portion 321C. The seat member side inner groove 141C extends from an inner circumferential surface of the member main body part 91C to the wall surface portion 121C of the seat member side annular groove 102C. The seat member side inner groove 141C opens to a rod chamber 90.

The seat member side outer groove 142C is formed in the surface portion 322C. The seat member side outer groove 142C is recessed in the axial direction of the member main body part 91C from the surface portion 322C. The seat member side outer groove 142C has a depth from the surface portion 322C that is smaller than a depth from the surface portion 322C of the seat member side annular groove 102C. The seat member side outer groove 142C extends from the wall surface portion 122C of the seat member side annular groove 102C to the outer circumferential surface of the member main body part 91C.

The piston side radial groove 105C is formed in the protruding part 92C. The piston side radial groove 105C is recessed in the axial direction of the case member 71C from a distal end surface of the protruding part 92C on a side opposite to the member main body part 91C in the axial direction of the case member 71C. The piston side radial groove 105C extends from the inner circumferential surface of the protruding part 92C to an outer circumferential surface of the protruding part 92C. The piston side radial groove 105C traverses the protruding part 92C in a radial direction of the protruding part 92C. The piston side radial groove 105C opens to the rod chamber 90. A passage inside the piston side radial groove 105C serves as a throttle 106C that communicates with the rod chamber 90.

The seat member 72C has an annular shape. The seat member 72C includes a member main body part 151C, a protruding part 152C, and a valve seat part 153C. The member main body part 151C is annular. The protruding part 152C is also annular. The protruding part 152C is provided on an inner circumferential side of the member main body part 151C. A central axis of the member main body part 151C and a central axis of the protruding part 152C coincide with each other. These central axes serve as a central axis of the seat member 72C. The protruding part 152C protrudes in an axial direction of the seat member 72C from a surface portion 155C on one end side of the member main body part 151C in the axial direction of the seat member 72C. The seat member 72C comes in contact with a disc 82 at the protruding part 152C and the valve seat part 153C.

As shown in FIG. 11, the valve seat part 153C is not annular. The valve seat part 153C includes a plurality of seat constituting parts 331C formed at regular intervals in a circumferential direction of the protruding part 152C. The seat constituting parts 331C each include a pair of radially extending parts 332C and a circumferentially extending part 333C. The radially extending parts 332C extend outward in a radial direction of the protruding part 152C from an outer circumferential portion of the protruding part 152C. The pair of radially extending parts 332C are disposed at a distance in the circumferential direction of the protruding part 152C. The circumferentially extending part 333C extends in the circumferential direction of the protruding part 152C. The circumferentially extending part 333C connects outer end portions of the pair of radially extending parts 332C in the radial direction of the protruding part 152C. The valve seat part 153C protrudes in an axial direction of the member main body part 151C from the surface portion 155C of the member main body part 151C.

A through hole 161C, a radial groove 162C, and a passage hole 335C are formed in the seat member 72C. The through hole 161C is formed at a center of the seat member 72C in a radial direction of the seat member 72C. The through hole 161C penetrates the seat member 72C in the axial direction of the seat member 72C. The through hole 161C is formed of an internal circumferential surface of the member main body part 151C and an internal circumferential surface of the protruding part 152C. The internal circumferential surface of the member main body part 151C has a cylindrical surface shape. An outer circumferential surface of the member main body part 151C also has a cylindrical surface shape. A central axis of the through hole 161C coincides with the central axis of the seat member 72C.

The radial groove 162C is formed in the protruding part 152C. The radial groove 162C is recessed in the axial direction of the seat member 72C from a distal end surface of the protruding part 152C on a side opposite to the member main body part 151C in the axial direction of the seat member 72C. The radial groove 162C extends from an inner circumferential surface of the protruding part 152C to an outer circumferential surface of the protruding part 152C. The radial groove 162C traverses the protruding part 152C in the radial direction. The radial groove 162C is disposed between the pair of radially extending parts 332C forming the same seat constituting part 331C in the circumferential direction of the protruding part 152C. In other words, the radial groove 162C opens to each corresponding seat constituting part 331C. The radial groove 162C opens to the rod chamber 90 shown in FIG. 10. Thereby, a pressure in the seat constituting part 331C is the same as that of the rod chamber 90. The inside of the seat constituting part 331C serves as a bypass passage 225C that communicates with the rod chamber 90. The passage inside the radial groove 162C constitutes the bypass passage 225C.

As shown in FIG. 10, the member main body part 151C has an abutment surface 341C, an abutment surface 342C, and a wall surface portion 343C. The abutment surface 341C and the abutment surfaces 342C are formed on a side of the member main body part 151C opposite to the protruding part 152C in the axial direction of the seat member 72C. The abutment surface 341C is on the protruding part 152C side with respect to the abutment surface 342C in the axial direction of the member main body part 91C. The abutment surface 342C is on an outer side with respect to the abutment surface 341C in a radial direction of the member main body part 151C. Both the abutment surfaces 341C and 342C have a planar shape extending to be orthogonal to the central axis of the member main body part 151C. The wall surface portion 343C connects an outer circumferential edge portion of the abutment surface 341C and an inner circumferential edge portion of the abutment surface 342C. The wall surface portion 343C has a cylindrical surface shape. A central axis of the wall surface portion 343C coincides with the central axis of the through hole 161C. The wall surface portion 343C has the same diameter as the wall surface portion 122C.

The passage hole 335C is formed in the member main body part 151C. The passage hole 335C penetrates the member main body part 151C in the axial direction of the member main body part 151C. The passage hole 335C extends in the axial direction of the member main body part 151C. One end of the passage hole 335C opens at a position in the vicinity of the wall surface portion 343C of the abutment surface 341C in the radial direction of the member main body part 151C. The other end of the passage hole 335C opens to the surface portion 155C. As shown in FIG. 11, the passage hole 335C is disposed between seat constituting parts 331C adjacent to each other in a circumferential direction of the seat member 72C. In other words, the passage hole 335C is disposed apart from the bypass passage 225C with the seat constituting part 331C therebetween.

As shown in FIG. 10, when both the case member 71C and the seat member 72C are fitted on the mounting shaft part 28 of the piston rod 21, central axes thereof are made to be coincident with each other. In this state, the abutment surface 341C of the seat member 72C overlaps the surface portion 321C of the case member 71C to be in surface contact with each other. At the same time, the abutment surface 342C of the seat member 72C overlaps the surface portion 322C of the case member 71C to be in surface contact with each other. The wall surface portion 343C of the seat member 72C is disposed on the same cylindrical surface as the wall surface portion 122C of the case member 71C. Then, the case member 71C and the seat member 72C form a seal chamber 171C (passage part), a throttle 172C, and a lower chamber side passage 173C (third passage).

The seal chamber 171C is formed inside the seat member side annular groove 102C. The seal chamber 171C is formed to be surrounded by the wall surface portion 121C, the wall surface portion 122C, the wall surface portion 343C, the bottom surface portion 123C, and the abutment surface 341C. The seal chamber 171C has an annular shape. A central axis of the seal chamber 171C and the central axes of the through holes 101C and 161C coincide with each other.

The throttle 172C is formed inside the seat member side inner groove 141C. The throttle 172C is formed to be surrounded by the seat member side inner groove 141C and the abutment surface 341C. One end of the throttle 172C opens to the seal chamber 171C, and the other end opens to the rod chamber 90. The throttle 172C communicates with the seal chamber 171C and the rod chamber 90. The rod chamber 90 and the throttle 172C form an upper chamber side passage 181C (second passage).

The lower chamber side passage 173C is formed inside the seat member side outer groove 142C. The lower chamber side passage 173C is formed to be surrounded by the seat member side outer groove 142C and the abutment surface 342C. One end of the lower chamber side passage 173C opens to the seal chamber 171C, and the other end opens to the lower chamber 20. The lower chamber side passage 173C communicates with the seal chamber 171C and the lower chamber 20.

The passage in the passage hole 335C of the seat member 72C serves as a lower chamber side passage 345C (third passage). One end of the lower chamber side passage 345C opens to the seal chamber 171C, and the other end opens to the lower chamber 20. The lower chamber side passage 345C communicates with the seal chamber 171C and the lower chamber 20. The seal chamber 171C is provided between the lower chamber side passages 173C and 345C and the throttle 172C of the upper chamber side passage 181C.

The seal member 73A is housed in the seal chamber 171C. The seal member 73A is in contact with the bottom surface portion 123C of the seat member side annular groove 102C and the abutment surface 341C of the seat member 72C at the same time. At that time, the seal member 73A elastically deforms in the axial direction of the seal member 73A. The seal member 73A moves in a radial direction of the seal member 73A within the seal chamber 171C. The seal member 73A deforms in the radial direction of the seal member 73A within the seal chamber 171C. At least an inner diameter of the seal member 73A can be increased in the radial direction of the seal member 73A within the seal chamber 171C. At least an outer diameter of the seal member 73A can be reduced in the radial direction of the seal member 73A within the seal chamber 171C.

A seal part 191A of the seal member 73A comes into contact with the abutment surface 341C to seal between itself and the abutment surface 341C. A seal part 192A of the seal member 73A comes into contact with the bottom surface portion 123C to seal between itself and the bottom surface portion 123C. The seal parts 191A and 192A are also provided in the seal chamber 171C. The seal parts 191A and 192A of the seal member 73A suppress a flow of an oil fluid from the upper chamber side passage 181C side including the throttle 172C to a side of the lower chamber side passages 173C and 345C. The seal parts 191A and 192A also suppress a flow of the oil fluid from the lower chamber side passages 173C and 345C to the upper chamber side passage 181C. A pressure receiving part 193A on the wall surface portion 121C side of the seal member 73A receives a pressure on the upper chamber side passage 181C side. A pressure receiving part 194A on a side of the wall surface portions 122C and 343C of the seal member 73A receives a pressure on a side of the lower chamber side passages 173C and 345C. The seal member 73A has a seal function that partitions the inside of the seal chamber 171C into an upper chamber communicating chamber 185C communicating with the upper chamber side passage 181C and a lower chamber communicating chamber 186C communicating with the lower chamber side passages 173C and 345C. The seal member 73A has both the seal function and a property of elastic deformation at the same time.

The seal chamber 171C, the throttle 172C, the lower chamber side passages 173C and 345C, and the seal member 73A constitute a frequency sensitive mechanism 195C that makes a damping force variable in response to a frequency of reciprocation of the piston 18. The frequency sensitive mechanism 195C is provided in the pilot case 75C. In the frequency sensitive mechanism 195C, the seal chamber 171C, the throttle 172C, and the lower chamber side passage 173C are formed of two members including the case member 71C and the seat member 72C.

A damping valve 63 is disposed on the piston side annular groove 103C side of the case member 71C in the axial direction of the case member 71C. At that time, the disc 64 is in contact with a disc 201 of the damping valve 63 and the protruding part 92C of the case member 71C. In the damping valve 63, a seal part 202 is slidably fitted in a liquid-tight manner to the wall surface portion 132C of the case member 71C over the entire circumference. The seal part 202 constantly seals a gap between the damping valve 63 and the wall surface portion 132C. The damping valve 63, the case member 71C, and the disc 64 form a pilot chamber 211C. In other words, the pilot chamber 211C is formed in the case member 71C. The pilot chamber 211C includes an inner portion of the piston side annular groove 103C. The pilot chamber 211C exerts a pressure on the damping valve 63 in a direction of the piston 18. In other words, the pilot chamber 211C causes the damping valve 63 to generate a force in a direction of reducing a flow path area between the damping valve 63 and the valve seat part 47 due to an internal pressure.

The pilot chamber 211C communicates with the rod chamber 90 of the upper chamber side passage 181C via the throttle 106C. The seal chamber 171C and the pilot chamber 211C are disposed at different positions in the axial direction of the pilot case 75C. The positions of the seal chamber 171C and the pilot chamber 211C overlap in the radial direction of the pilot case 75C.

The shock absorber 1C of the fourth embodiment has a damping force generation mechanism 41C which is different from the damping force generation mechanism 41 in that it has the pilot chamber 211C different from the pilot chamber 211. The damping force generation mechanism 41C is also provided in the piston passage 210 similarly to the damping force generation mechanism 41. The damping force generation mechanism 41C also is an extension-side damping force generation mechanism similarly to the damping force generation mechanism 41. In the damping force generation mechanism 41C, some of the flow of the oil fluid in the piston passage 210 is introduced into the pilot chamber 211C via a throttle 198, the rod chamber 90, and the throttle 106C. The damping force generation mechanism 41C controls an opening of the damping valve 63 due to a pressure in the pilot chamber 211C. In the frequency sensitive mechanism 195C, some of the flow of the oil fluid in the piston passage 210 is introduced into the upper chamber communicating chamber 185C of the seal chamber 171C via the throttle 198, the rod chamber 90, and the throttle 172C.

The upper chamber side passage 181C including the rod chamber 90 communicates, via the throttle 198, with an upstream side of the damping valve 63 in a flow direction of the oil fluid in the piston passage 210 during the extension stroke. The upper chamber side passage 181C communicates with the upper chamber communicating chamber 185C of the seal chamber 171C. The lower chamber side passage 173C communicates with the lower chamber communicating chamber 186C of the seal chamber 171C. The lower chamber side passage 173C communicates with the lower chamber 20 downstream of the damping valve 63 in the flow direction of the oil fluid in the piston passage 210 during the extension stroke.

The shock absorber 1C of the fourth embodiment has a damping force generation mechanism 231C which is different from the damping force generation mechanism 231 in that it has the valve seat part 153C having a shape different from that of the valve seat part 153. The damping force generation mechanism 231C opens and closes the bypass passage 225C with a hard valve 221.

Here, when the above-described parts are assembled to the mounting shaft part 28 of the piston rod 21, the case member 71C is assembled instead of the case member 71. Also, the seal member 73A is assembled instead of the seal member 73. Further, the seat member 72C is assembled instead of the seat member 72. Other than these, assembly is performed in the same manner as in the first embodiment. Thereby, the pilot case 75C is disposed to sandwich the damping valve 63 between itself and the piston 18. Also, central axes of the case member 71C and the seat member 72C are made to coincide with a central axis of the piston rod 21.

A hydraulic circuit diagram of a portion of the vicinity of the piston 18 of the shock absorber 1C configured as described above is the same as the hydraulic circuit diagram of the shock absorber 1 shown in FIG. 4.

During the extension stroke of the shock absorber 1C configured as described above, the oil fluid is introduced from the piston passage 210 into the upper chamber communicating chamber 185C of the seal chamber 171C via the throttle 198 and the upper chamber side passage 181C. Then, the seal member 73A deforms while moving in a direction in which a diameter thereof increases. At that time, the oil fluid is discharged from the lower chamber communicating chamber 186C of the seal chamber 171C to the lower chamber 20 through the lower chamber side passages 173C and 345C. During a compression stroke of the shock absorber 1C, the oil fluid is introduced from the lower chamber 20 into the lower chamber communicating chamber 186C of the seal chamber 171C through the lower chamber side passages 173C and 345C. Then, the seal member 73A deforms while moving in a direction in which the diameter is reduced. At that time, the oil fluid is discharged from the upper chamber communicating chamber 185C of the seal chamber 171C to the piston passage 210, that is, the upper chamber 19, through the upper chamber side passage 181C and the throttle 198. Operations other than these of the frequency sensitive mechanism 195C are substantially the same as those of the shock absorber 1.

The shock absorber 1C of the fourth embodiment includes the upper chamber side passage 181C that communicates, via the throttle 198, with an upstream side of the damping valve 63 in the flow direction of the oil fluid in the piston passage 210 during the extension stroke. Also, the shock absorber 1C includes the lower chamber side passages 173C and 345C communicating with the lower chamber 20 downstream of the damping valve 63 in the flow direction of the oil fluid in the piston passage 210 during the extension stroke. Also, the shock absorber 1C includes the seal chamber 171C provided between the lower chamber side passages 173C and 345C and the upper chamber side passage 181C. Then, the shock absorber 1C includes the seal member 73A having rubber elasticity provided in the seal chamber 171C. Therefore, the shock absorber 1C has a structure in which the frequency sensitive mechanism 195C moves the seal member 73A within the seal chamber 171C. Also, in the shock absorber 1C, the pilot chamber 211C communicates with the upper chamber side passage 181C. Also, in the shock absorber 1C, the bypass passage 225C communicates with the upper chamber side passage 181C. Also, in the shock absorber 1C, the pilot case 75C in which the pilot chamber 211C is formed is disposed to sandwich the damping valve 63 between itself and the piston 18. Also, in the shock absorber 1C, the seal chamber 171C, the throttle 172C, and the lower chamber side passages 173C and 345C are formed of two members including the case member 71C and the seat member 72C. As described above, a structure of the shock absorber 1C can be simplified similarly to the shock absorber 1.

Also, in the shock absorber 1C, the lower chamber 20 and the lower chamber communicating chamber 186C of the seal chamber 171C are allowed to communicate with each other through the lower chamber side passages 173C and 345C. Therefore, a flow of the oil fluid between the lower chamber 20 and the lower chamber communicating chamber 186C is made smooth.

### Fifth Embodiment

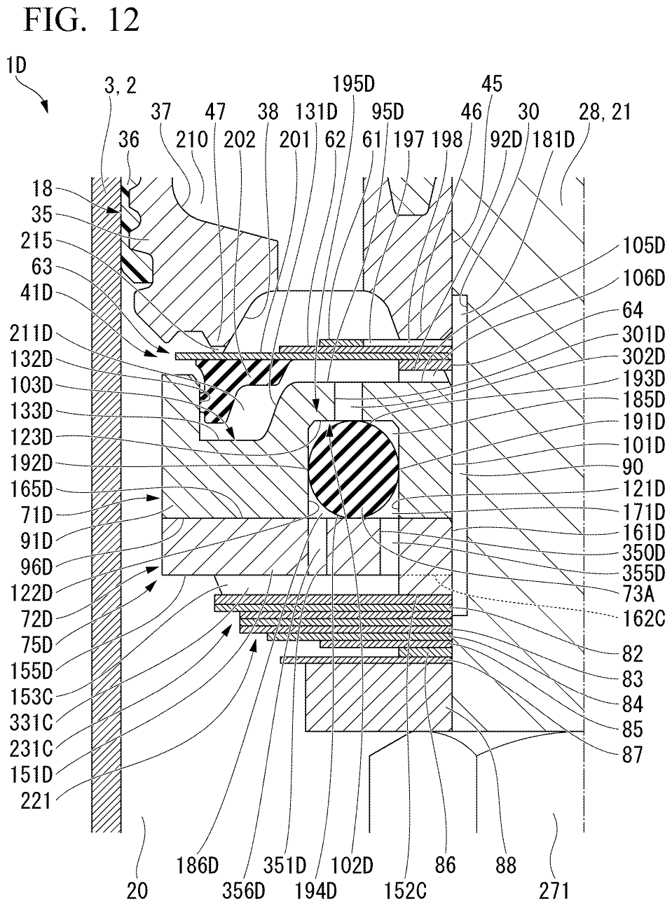

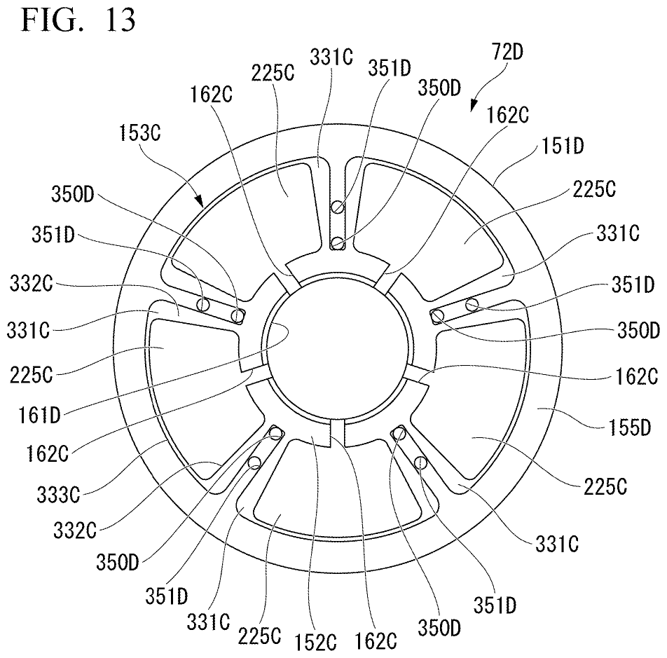

A shock absorber according to a fifth embodiment of the present invention will be described mainly on the basis of FIGS. 12 and 13, focusing on differences from the first, second, and fourth embodiments. Further, parts common to those in the first, second, and fourth embodiments will be denoted by the same terms and the same reference signs.

As shown in FIG. 12, a shock absorber 1D of the fifth embodiment includes a pilot case 75D instead of the pilot cases 75, 75A, and 75C. The pilot case 75D includes a case member 71D that is partially different from the case members 71, 71A, and 71C. The pilot case 75D includes a seat member 72D that is partially different from the seat members 72 and 72C. A seal member 73A similar to that of the second embodiment is provided in the pilot case 75D.

Both the case member 71D and the seat member 72D are made of a metal. Both the case member 71D and the seat member 72D are integrally formed by sintering. At least either of the case member 71D and the seat member 72D may be formed by cutting. Both the case member 71D and the seat member 72D have an annular shape. Both the case member 71D and the seat member 72D have a mounting shaft part 28 of a piston rod 21 fitted to an inner circumferential side thereof. The pilot case 75D overlaps a passage groove 30 of the mounting shaft part 28 in position in an axial direction of the piston rod 21.

The case member 71D includes a member main body part 91D and a protruding part 92D. The member main body part 91D has an annular shape. The protruding part 92D also has an annular shape. The protruding part 92D is provided on an inner circumferential side of the member main body part 91D. A central axis of the member main body part 91D and a central axis of the protruding part 92D coincide with each other. These central axes serve as a central axis of the case member 71D. The protruding part 92D protrudes in an axial direction of the case member 71D from a surface portion 95D on one end side of the member main body part 91D in the axial direction of the case member 71D. The surface portion 95D extends to be orthogonal to the central axis of the case member 71D. The case member 71D is in contact with a disc 64 at an end surface of the protruding part 92D on a side opposite to the member main body part 91D in the axial direction of the case member 71D.

A through hole 101D, a seat member side annular groove 102D, a piston side annular groove 103D, a piston side radial groove 105D, and a passage hole 301D are formed in the case member 71D. The through hole 101D is formed at a center of the case member 71D in a radial direction. The through hole 101D penetrates the case member 71D in the axial direction of the case member 71D. The through hole 101D is formed of an inner circumferential surface of the member main body part 91D and an inner circumferential surface of the protruding part 92D. The inner circumferential surface of the member main body part 91D has a cylindrical surface shape. An outer circumferential surface of the member main body part 91D also has a cylindrical surface shape. A central axis of the through hole 101D coincides with the central axis of the case member 71D.

The member main body part 91D includes the seat member side annular groove 102D formed in a surface portion 96D on a side opposite to the surface portion 95D in the axial direction of the member main body part 91D. The surface portion 96D has a planar shape extending to be orthogonal to the central axis of the member main body part 91D. The seat member side annular groove 102D is recessed in the axial direction of the member main body part 91D from the surface portion 96D. The seat member side annular groove 102D surrounds the through hole 101D from an outer side in a radial direction of the member main body part 91D. The seat member side annular groove 102D has an annular shape. A central axis of the seat member side annular groove 102D coincides with the central axis of the through hole 101D.

The seat member side annular groove 102D has a wall surface portion 121D, a wall surface portion 122D, and a bottom surface portion 123D. The wall surface portion 122D is disposed on an outer side with respect to the wall surface portion 121D in the radial direction of the member main body part 91D. The wall surface portion 121D has a cylindrical surface shape. The wall surface portion 121D faces outward in the radial direction of the member main body part 91D. The wall surface portion 122D has a cylindrical surface shape. The wall surface portion 122D faces inward in the radial direction of the member main body part 91D. The bottom surface portion 123D connects an end edge portion of the wall surface portion 121D on a side opposite to the surface portion 96D and an end edge portion of the wall surface portion 122D on a side opposite to the surface portion 96D. The bottom surface portion 123D has a planar shape extending parallel to the surface portion 96D. A central axis of the wall surface portion 121D, a central axis of the wall surface portion 122D, and a central axis of the bottom surface portion 123D are the same as the central axis of the seat member side annular groove 102D.

The piston side annular groove 103D is recessed in the axial direction of the member main body part 91D from the surface portion 95D of the member main body part 91D. The piston side annular groove 103D is shifted outward in the radial direction of the member main body part 91D from the seat member side annular groove 102D. The piston side annular groove 103D has an annular shape. A central axis of the piston side annular groove 103D coincides with the central axis of the through hole 101D.

The piston side annular groove 103D has a wall surface portion 131D, a wall surface portion 132D, and a bottom surface portion 133D. The wall surface portion 132D is disposed on an outer side with respect to the wall surface portion 131D in the radial direction of the member main body part 91D. The wall surface portion 131D faces outward in the radial direction of the member main body part 91D. The wall surface portion 131D is a tapered surface. An outer diameter of the wall surface portion 131D becomes smaller toward the surface portion 95D in the axial direction of the member main body part 91D. The wall surface portion 132D has a cylindrical surface shape. The wall surface portion 132D faces inward in the radial direction of the member main body part 91D. The bottom surface portion 133D connects an end edge portion of the wall surface portion 131D on a side opposite to the surface portion 95D and an end edge portion of the wall surface portion 132D on a side opposite to the surface portion 95D. The bottom surface portion 133D has a planar shape extending parallel to the surface portion 95D. A central axis of the wall surface portion 131D, a central axis of the wall surface portion 132D, and a central axis of the bottom surface portion 133D are the same as the central axis of the piston side annular groove 103D. A portion of the seat member side annular groove 102D on the bottom surface portion 123D side and a portion of the bottom surface portion 133D of the piston side annular groove 103D overlap each other in position in the axial direction of the member main body part 91D. The seat member side annular groove 102D and the piston side annular groove 103D are formed on opposite sides of the case member 71D in the axial direction.

The passage hole 301D extends in the axial direction of the member main body part 91D. The passage hole 301D extends from the surface portion 95D of the member main body part 91D to the bottom surface portion 123D of the seat member side annular groove 102D. The passage hole 301D is disposed in the vicinity of a center of the bottom surface portion 123D in the radial direction of the member main body part 91D. A passage in the passage hole 301D constitutes a throttle 302D.

The piston side radial groove 105D is formed in the protruding part 92D. The piston side radial groove 105D is recessed in the axial direction of the case member 71D from a distal end surface of the protruding part 92D on a side opposite to the member main body part 91D in the axial direction of the case member 71D. The piston side radial groove 105D extends from the inner circumferential surface of the protruding part 92D to an outer circumferential surface of the protruding part 92D. The piston side radial groove 105D traverses the protruding part 92D in a radial direction of the protruding part 92D. The piston side radial groove 105D opens to a rod chamber 90. A passage inside the piston side radial groove 105D serves as a throttle 106D that communicates with the rod chamber 90.

The seat member 72D has an annular shape. The seat member 72D has a member main body part 151D. The seat member 72D includes a protruding part 152C similar to that of the fourth embodiment and a valve seat part 153C similar to that of the fourth embodiment. The member main body part 151D has an annular shape. The protruding part 152C is also annular. The protruding part 152D is provided on an inner circumferential side of the member main body part 151D. A central axis of the member main body part 151D and a central axis of the protruding part 152D coincide with each other. These central axes serve as a central axis of the seat member 72D. The protruding part 152C protrudes in an axial direction of the seat member 72D from the surface portion 155D on one end side of the member main body part 151D in the axial direction of the seat member 72D. A radial groove 162C is formed in the protruding part 152C. The radial groove 162C opens in the rod chamber 90. The seat member 72D is in contact with a disc 82 at the protruding part 152C and the valve seat part 153C.

A through hole 161D, a passage hole 350D, and a passage hole 351D are formed in the seat member 72D. The through hole 161D is formed at a center of the seat member 72D in a radial direction of the seat member 72D. The through hole 161D penetrates the seat member 72D in the axial direction of the seat member 72D. The through hole 161D is formed of an inner circumferential surface of the member main body part 151D and an inner circumferential surface of the protruding part 152C. An inner circumferential surface of the member main body part 151D has a cylindrical surface shape. An outer circumferential surface of the member main body part 151D also has a cylindrical surface shape. A central axis of the through hole 161D coincides with the central axis of the seat member 72D.

The member main body part 151D has an abutment surface 165D. The abutment surface 165D is formed at an end portion of the member main body part 151D on a side opposite to the protruding part 152C and the valve seat part 153C in the axial direction of the seat member 72D. The abutment surface 165D has a planar shape extending to be orthogonal to the central axis of the member main body part 151D.

The passage holes 350D and 351D are formed in the member main body part 151D. Both the passage holes 350D and 351D penetrate the member main body part 151D in an axial direction of the member main body part 151D. Both the passage holes 350D and 351D extend in the axial direction of the member main body part 151D. One end of each of the passage holes 350D and 351D opens to the abutment surface 165D of the member main body part 151D. The other end of each of the passage holes 350D and 351D opens to the surface portion 155D. As shown in FIG. 13, the passage holes 350D and 351D are both disposed at positions between a seat constituting part 331C and a seat constituting part 331C adjacent to each other in a circumferential direction of the seat member 72D. In other words, the passage holes 350D and 351D are both disposed apart from the bypass passage 225C with the seat constituting part 331C therebetween. The passage hole 350D is disposed on an inner side with respect to the passage hole 351D in a radial direction of the member main body part 151D.

As shown in FIG. 12, when both the case member 71D and the seat member 72D are fitted on the mounting shaft part 28 of the piston rod 21, central axes thereof are made to be coincident with each other. In this state, the abutment surface 165D of the seat member 72D overlaps the surface portion 96D of the case member 71D to be in surface contact with each other. Then, the case member 71D and the seat member 72D form a seal chamber 171D (passage part).

The seal chamber 171D is formed inside the seat member side annular groove 102D. The seal chamber 171D is formed to be surrounded by the wall surface portion 121D, the wall surface portion 122D, the bottom surface portion 123D, and the abutment surface 165D. The seal chamber 171D has an annular shape. A central axis of the seal chamber 171D and the central axes of the through holes 101D and 161D coincide with each other. The throttle 302D opens to the seal chamber 171D.

A passage in the passage hole 350D of the seat member 72D serves as a lower chamber side passage 355D (third passage). A passage in the passage hole 351D of the seat member 72D serves as a lower chamber side passage 356D (third passage). One end of each of the lower chamber side passages 355D and 356D opens to the seal chamber 171D. The other end of each of the lower chamber side passages 355D and 356D opens to a lower chamber 20. The lower chamber side passage 355D opens at a position in the vicinity of the wall surface portion 121D in the seal chamber 171D. The lower chamber side passage 356D opens at a position in the vicinity of the wall surface portion 122D in the seal chamber 171D. The lower chamber side passage 356D is on an outer side with respect to the lower chamber side passage 355D in a radial direction of the seal chamber 171D. The seal chamber 171D is provided between the lower chamber side passages 355D and 356D and the throttle 302D.

A damping valve 63 is disposed on the piston side annular groove 103D side of the case member 71D in the axial direction of the case member 71D. At that time, the disc 64 is in contact with a disc 201 of the damping valve 63 and the protruding part 92D of the case member 71D. In the damping valve 63, a seal part 202 is slidably fitted in a liquid-tight manner to the wall surface portion 132D of the case member 71D over the entire circumference. The seal part 202 constantly seals a gap between the damping valve 63 and the wall surface portion 132D. The damping valve 63, the case member 71D, and the disc 64 form a pilot chamber 211D. In other words, in the pilot case 75D, the pilot chamber 211D is formed in the case member 71D. The pilot chamber 211D includes an inner portion of the piston side annular groove 103D. The pilot chamber 211D exerts a pressure on the damping valve 63 in a direction of the piston 18. In other words, the pilot chamber 211D causes the damping valve 63 to generate a force in a direction of reducing a flow path area between the damping valve 63 and the valve seat part 47 due to an internal pressure.

The throttle 106D opens to the pilot chamber 211D and the rod chamber 90. The pilot chamber 211D communicates with rod chamber 90 via throttle 106D. A portion of the seal chamber 171D on the bottom surface portion 123D side and a portion of the pilot chamber 211D on the bottom surface portion 133D side overlap each other in position in an axial direction of the pilot case 75D. The seal chamber 171D and the pilot chamber 211D overlap each other in position in a radial direction of the pilot case 75D.

The shock absorber 1D of the fifth embodiment has a damping force generation mechanism 41D which is different from the damping force generation mechanism 41 in that it has the pilot chamber 211D different from the pilot chamber 211. The damping force generation mechanism 41D is also provided in a piston passage 210 similarly to the damping force generation mechanism 41. The damping force generation mechanism 41D also is an extension-side damping force generation mechanism similarly to the damping force generation mechanism 41.

One end of the throttle 302D opens to the seal chamber 171D, and the other end opens to the pilot chamber 211D. The throttle 302D communicates with the seal chamber 171D and the pilot chamber 211D. The rod chamber 90, the throttles 106D and 302D, and the pilot chamber 211D form an upper chamber side passage 181D (second passage).

The seal member 73A is housed in the seal chamber 171D. The seal member 73A is in contact with the wall surface portion 121D and the wall surface portion 122D of the seat member side annular groove 102D at the same time. At that time, the seal member 73A elastically deforms in a radial direction of the seal member 73A. The seal member 73A moves in an axial direction of the seal member 73A within the seal chamber 171D. The seal member 73A deforms in the axial direction of the seal member 73A within the seal chamber 171D. At least the bottom surface portion 123D side of the seal member 73A is deformable to a side of the lower chamber side passages 355D and 356D within the seal chamber 171A. At least the abutment surface 165D side of the seal member 73A is deformable to the throttle 302D side within the seal chamber 171D.

The seal member 73A includes a seal part 191D, a seal part 192D, a pressure receiving part 193D, and a pressure receiving part 194D. The seal part 191D comes into contact with the wall surface portion 121D to seal between itself and the wall surface portion 121D. The seal part 192D comes into contact with the wall surface portion 122D to seal between itself and the wall surface portion 122D. The seal parts 191D and 192D are also provided in the seal chamber 171D. The seal parts 191D and 192D of the seal member 73A suppress a flow of an oil fluid from the upper chamber side passage 181D side to a side of the lower chamber side passages 355D and 356D. The seal parts 191D and 192D also suppress a flow of the oil fluid from the lower chamber side passages 355D and 356D side to the upper chamber side passage 181D side. The pressure receiving part 193D is on the bottom surface portion 123D side of the seal member 73A. The pressure receiving part 193D receives a pressure on the upper chamber side passage 181D side. The pressure receiving part 194D is on the abutment surface 165D side of the seal member 73A. The pressure receiving part 194D receives a pressure on a side of the lower chamber side passages 355D and 356D. The seal member 73A has a seal function that partitions the inside of the seal chamber 171D into an upper chamber communicating chamber 185D communicating with the upper chamber side passage 181D and a lower chamber communicating chamber 186D communicating with the lower chamber side passages 355D and 356D. The seal member 73A has both the seal function and a property of elastic deformation at the same time.

The seal chamber 171D, the throttles 106D and 302D, the pilot chamber 211D, the lower chamber side passages 355D and 356D, and the seal member 73A constitute a frequency sensitive mechanism 195D that makes a damping force variable in response to a frequency of reciprocation of the piston 18. The frequency sensitive mechanism 195D is provided in the pilot case 75D. In the frequency sensitive mechanism 195D, the seal chamber 171D, the lower chamber side passages 355D and 356D, and the throttle 302A are formed of two members including the case member 71D and the seat member 72D.

In the damping force generation mechanism 41D, some of the flow of the oil fluid in the piston passage 210 is introduced into the pilot chamber 211D via the throttle 198, the rod chamber 90, and the throttle 106D. The damping force generation mechanism 41D controls an opening of the damping valve 63 due to a pressure in the pilot chamber 211D. In the frequency sensitive mechanism 195D, some of the flow of the oil fluid in the piston passage 210 is introduced into the upper chamber communicating chamber 185D of the seal chamber 171D via the throttle 198, the rod chamber 90, the throttle 106D, the pilot chamber 211D, and the throttle 302D.

The upper chamber side passage 181D including the rod chamber 90 communicates, via the throttle 198, with an upstream side of the damping valve 63 in a flow direction of the oil fluid in the piston passage 210 during an extension stroke. The upper chamber side passage 181D communicates with the upper chamber communicating chamber 185D of the seal chamber 171D. Both the lower chamber side passages 355D and 356D communicate with the lower chamber communicating chamber 186D of the seal chamber 171D. Both the lower chamber side passages 355D and 356D communicate with the lower chamber 20 downstream of the damping valve 63 in the flow direction of the oil fluid in the piston passage 210 during the extension stroke. Only one of the lower chamber side passage 355D and the lower chamber side passage 356D may be provided.

Here, when the above-described parts are assembled to the mounting shaft part 28 of the piston rod 21, the case member 71D is assembled instead of the case member 71. Also, the seal member 73A is assembled instead of the seal member 73. Further, the seat member 72D is assembled instead of the seat member 72. Other than these, assembly is performed in the same manner as in the first embodiment. Thereby, the pilot case 75D is disposed to sandwich the damping valve 63 between the pilot case 75D and the piston 18. Also, the central axis of the case member 71D is made to coincide with a central axis of the piston rod 21. Also, the central axis of the seat member 72D is made to coincide with the central axis of the piston rod 21.

A hydraulic circuit diagram of a portion of the vicinity of the piston 18 of the shock absorber 1D configured as described above is the same as the hydraulic circuit diagram of the shock absorber 1A shown in FIG. 7.

During the extension stroke of the shock absorber 1D configured as described above, the oil fluid is introduced from the piston passage 210 into the upper chamber communicating chamber 185D of the seal chamber 171D via the throttle 198 and the upper chamber side passage 181D. Then, the seal member 73A moves to a side opposite to the piston 18 in the axial direction of the seal member 73A and deforms. At that time, the oil fluid is discharged from the lower chamber communicating chamber 186D of the seal chamber 171D to the lower chamber 20 through the lower chamber side passages 355D and 356D. During a compression stroke of the shock absorber 1D, the oil fluid is introduced from the lower chamber 20 into the lower chamber communicating chamber 186D of the seal chamber 171D via the lower chamber side passages 355D and 356D. Then, the seal member 73A moves to the piston 18 side in the axial direction of the seal member 73A and deforms. At that time, the oil fluid is discharged from the upper chamber communicating chamber 185D of the seal chamber 171D to the piston passage 210, that is, the upper chamber 19, through the upper chamber side passage 181D and the throttle 198. Operations other than these of the frequency sensitive mechanism 195D are substantially the same as those of the shock absorber 1A.

The shock absorber 1D of the fifth embodiment includes the upper chamber side passage 181D that communicates, via the throttle 198, with an upstream side of the damping valve 63 in the flow direction of the oil fluid in the piston passage 210 during the extension stroke. Also, the shock absorber 1D includes the lower chamber side passages 355D and 356D communicating with the lower chamber 20 downstream of the damping valve 63 in the flow direction of the oil fluid in the piston passage 210 during the extension stroke. Also, the shock absorber 1D includes the seal chamber 171D provided between the upper chamber side passage 181D and the lower chamber side passages 355D and 356D. Then, the shock absorber 1D includes the seal member 73A having rubber elasticity provided in the seal chamber 171D. Therefore, the shock absorber 1D has a structure in which the frequency sensitive mechanism 195D moves the seal member 73A within the seal chamber 171D. Also, in the shock absorber 1D, the pilot chamber 211D constitutes the upper chamber side passage 181D. Also, in the shock absorber 1D, the bypass passage 225C communicates with the upper chamber side passage 181D. Also, in the shock absorber 1D, the pilot case 75D in which the pilot chamber 211D is formed is disposed to sandwich the damping valve 63 between the pilot case 75D and the piston 18. Also, in the shock absorber 1D, the seal chamber 171D and the lower chamber side passages 355D and 356D are formed of two members including the case member 71D and the seat member 72D. As described above, a structure of the shock absorber 1D can be simplified similarly to the shock absorber 1.

In the shock absorber 1D, the pilot chamber 211D and the seal chamber 171D are formed in the pilot case 75D at positions at which they overlap each other in the axial direction of the pilot case 75D. Thereby, an increase in size of the pilot case 75D in the axial direction can be minimized.

Further, in the shock absorber 1D, the piston side radial groove 105D of the protruding part 92D may be removed, and a throttle forming disc similar to the disc 61 may be provided between the protruding part 92D and the damping valve 63. Thereby, the throttle 106D can be formed by a notch in the throttle forming disc similarly to the notch 197. In this way, a size of the throttle 106D can be easily changed by exchanging the throttle forming disc, and a flow rate of the oil fluid to the seal chamber 171D can be easily adjusted.

### Sixth Embodiment

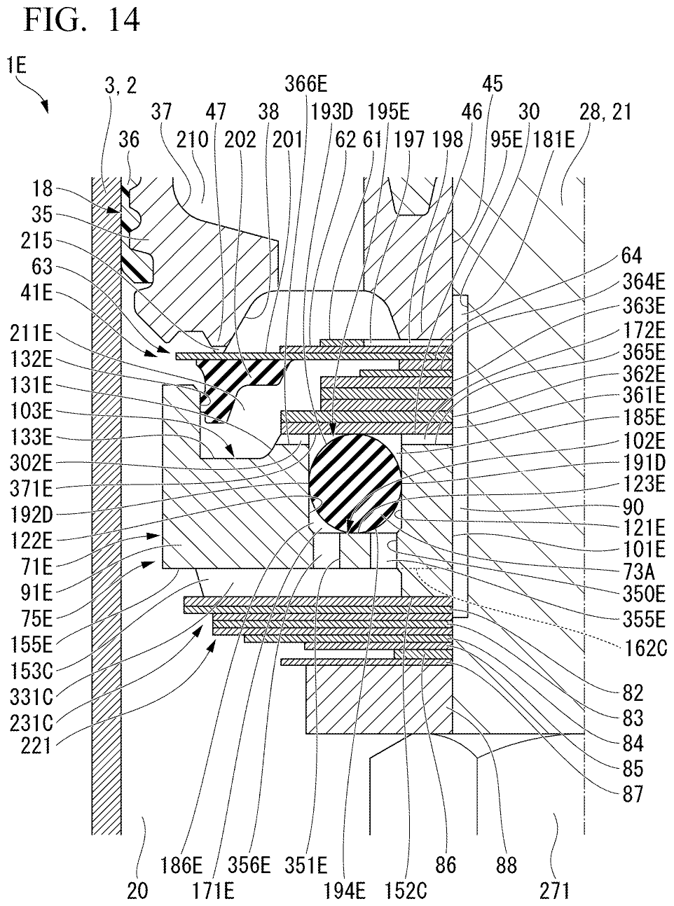

A shock absorber according to a sixth embodiment of the present invention will be described mainly on the basis of FIGS. 14 to 16, focusing on differences from the first, second, fourth, and fifth embodiments. Further, parts common to those in the first, second, fourth, and fifth embodiments will be denoted by the same terms and the same reference signs.

As shown in FIG. 14, the shock absorber 1E of the sixth embodiment includes a pilot case 75E instead of the pilot case 75. The pilot case 75E includes a case member 71E that is partially different from the case member 71. The pilot case 75E includes one cover disc 361E. A seal member 73A similar to that of the second embodiment is provided in the pilot case 75E. The shock absorber 1E includes one disc 362E, a plurality of discs 363E, and one disc 364E.

The case member 71E, the cover disc 361E, the disc 362E, the plurality of discs 363E, and the disc 364E are all made of a metal. The case member 71E is integrally formed by sintering. The case member 71E may be formed by cutting. The cover disc 361E, the disc 362E, the plurality of discs 363E, and the disc 364E are each formed by press-forming a plate material. All the case member 71E, the cover disc 361E, the disc 362E, the plurality of discs 363E, and the disc 364E have a flat plate shape with a constant thickness and are annular. The case member 71E, the cover disc 361E, the disc 362E, the plurality of discs 363E, and the disc 364E all have a mounting shaft part 28 of a piston rod 21 fitted to an inner circumferential side thereof. The pilot case 75E overlaps a passage groove 30 of the mounting shaft part 28 in position in an axial direction of the piston rod 21.

The case member 71E includes a member main body part 91E. The case member 71E includes a protruding part 152C similar to that of the fourth embodiment and a valve seat part 153C similar to that of the fourth embodiment. The member main body part 91E has an annular shape. The protruding part 152C is provided on an inner circumferential side of the member main body part 91E. A central axis of the member main body part 91E and a central axis of the protruding part 92C coincide with each other. These central axes serve as a central axis of the case member 71E. The protruding part 152C protrudes in an axial direction of the case member 71E from a surface portion 155E on one end side of the member main body part 91E in the axial direction of the case member 71E. The valve seat part 153C also protrudes in the axial direction of the case member 71E from the surface portion 155E of the member main body part 91E. The surface portion 155E extends to be orthogonal to the central axis of the case member 71E. The case member 71E is in contact with a disc 82 at the protruding part 152C and the valve seat part 153C.

A through hole 101E, an inner annular groove 102E, and an outer annular groove 103E are formed in the case member 71E. An inner groove part 365E, an outer groove part 366E, a passage hole 350E, and a passage hole 351E are formed in the case member 71E. The through hole 101E is formed at a center in a radial direction of the case member 71E. The through hole 101E penetrates the case member 71E in the axial direction of the case member 71E. The through hole 101E is formed of an inner circumferential surface of the member main body part 91E and an inner circumferential surface of the protruding part 152C. An inner circumferential surface of the member main body part 91E has a cylindrical surface shape. An outer circumferential surface of the member main body part 91E also has a cylindrical surface shape. A central axis of the through hole 101E coincides with the central axis of the case member 71E.

In the member main body part 91E, the inner annular groove 102E is formed in a surface portion 95E on a side opposite to the surface portion 155E in the axial direction of the member main body part 91E. The surface portion 95E has a planar shape extending to be orthogonal to the central axis of the member main body part 91E. The inner annular groove 102E is recessed in an axial direction of the member main body part 91E from the surface portion 95E. The inner annular groove 102E surrounds the through hole 101E from an outer side in a radial direction of the member main body part 91E. The inner annular groove 102E has an annular shape. A central axis of the inner annular groove 102E coincides with the central axis of the through hole 101E.

The inner annular groove 102E has a wall surface portion 121E, a wall surface portion 122E, and a bottom surface portion 123E. The wall surface portion 122E is disposed on an outer side with respect to the wall surface portion 121E in the radial direction of the member main body part 91E. The wall surface portion 121E has a cylindrical surface shape. The wall surface portion 121E faces outward in the radial direction of the member main body part 91E. The wall surface portion 122E has a cylindrical surface shape. The wall surface portion 122E faces inward in the radial direction of the member main body part 91E. The bottom surface portion 123E connects an end edge portion of the wall surface portion 121E on a side opposite to the surface portion 95E and an end edge portion of the wall surface portion 122E on a side opposite to the surface portion 95E. The bottom surface portion 123E has a planar shape extending parallel to the surface portion 95E. A central axis of the wall surface portion 121E, a central axis of the wall surface portion 122E, and a central axis of the bottom surface portion 123E are the same as the central axis of the inner annular groove 102E.

The outer annular groove 103E is recessed in the axial direction of the member main body part 91E from the surface portion 95E of the member main body part 91E. The outer annular groove 103E is disposed on an outer side with respect to the inner annular groove 102E in the radial direction of the member main body part 91E. The outer annular groove 103E surrounds the inner annular groove 102E from an outer side in a radial direction of the member main body part 91E. The outer annular groove 103E has an annular shape. A central axis of the outer annular groove 103E coincides with the central axis of the through hole 101E.

The outer annular groove 103E has a wall surface portion 131E, a wall surface portion 132E, and a bottom surface portion 133E. The wall surface portion 132E is disposed on an outer side with respect to the wall surface portion 131E in the radial direction of the member main body part 91E. The wall surface portion 131E faces outward in the radial direction of the member main body part 91E. The wall surface portion 131E is a tapered surface. An outer diameter of the wall surface portion 131E becomes smaller toward the surface portion 95E in the axial direction of the member main body part 91E. The wall surface portion 132E has a cylindrical surface shape. The wall surface portion 132E faces inward in the radial direction of the member main body part 91E. The bottom surface portion 133E connects an end edge portion of the wall surface portion 131E on a side opposite to the surface portion 95E and an end edge portion of the wall surface portion 132E on a side opposite to the surface portion 95E. The bottom surface portion 133E has a planar shape extending parallel to the surface portion 95E. A central axis of the wall surface portion 131E, a central axis of the wall surface portion 132E, and a central axis of the bottom surface portion 133E are the same as the central axis of the outer annular groove 103E.

The inner annular groove 102E and the outer annular groove 103E overlap each other in position in the axial direction of the case member 71E. Positions of the inner annular groove 102E and the outer annular groove 103E are shifted from each other in the radial direction of the case member 71E. The inner annular groove 102E and the outer annular groove 103E are formed on one side of the same side in the axial direction of the case member 71E.

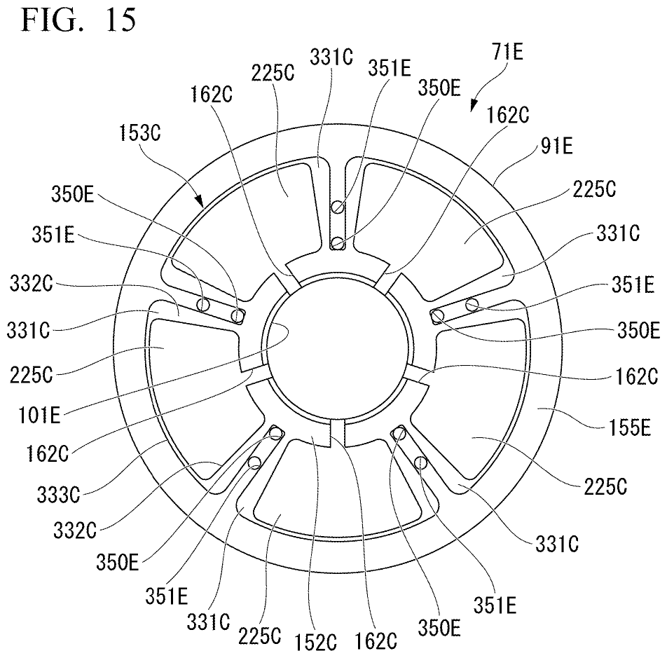

The passage holes 350E and 351E are formed in the member main body part 91E. Both the passage holes 350E and 351E penetrate the member main body part 91E in the axial direction of the member main body part 91E. Both the passage holes 350E and 351E extend in the axial direction of the member main body part 91E. One end of each of the passage holes 350E and 351E opens to the bottom surface portion 123E of the inner annular groove 102E. The other end of each of the passage holes 350E and 351E opens to the surface portion 155E. As shown in FIG. 15, the passage holes 350E and 351E are both disposed at positions between a seat constituting part 331C and a seat constituting part 331C adjacent to each other in a circumferential direction of the case member 71E. In other words, the passage holes 350E and 351E are disposed apart from a bypass passage 225C with the seat constituting part 331C therebetween. The passage hole 350E is disposed on an inner side with respect to the passage hole 351E in the radial direction of the member main body part 151E.

As shown in FIG. 14, both the inner groove part 365E and the outer groove part 366E are formed in the surface portion 95E. Both the inner groove part 365E and the outer groove part 366E are recessed in the axial direction of the member main body part 91E from the surface portion 95E. The inner groove part 365E extends from the through hole 101E to the wall surface portion 121E of the inner annular groove 102E. One end of the inner groove part 365E opens to a rod chamber 90. The other end of the inner groove part 365E opens to the inner annular groove 102E. The outer groove part 366E extends from the wall surface portion 122E of the inner annular groove 102E to the wall surface portion 131E of the outer annular groove 103E. One end of the outer groove part 366E opens to the inner annular groove 102E. The other end of the outer groove part 366E opens to the outer annular groove 103E.

An outer diameter of the cover disc 361E is the same as an outer diameter of an end portion of the wall surface portion 131E on the surface portion 95E side. When both the case member 71E and the cover disc 361E are fitted on the mounting shaft part 28 of the piston rod 21, central axes thereof are made to be coincident with each other. In this state, the cover disc 361E is in surface contact with the surface portion 95E of the member main body part 91E at an abutment surface 371E on one side in the axial direction of the cover disc 361E. Then, the case member 71E and the cover disc 361E form throttles 172E and 302E and a seal chamber 171E (passage part).

The throttle 172E is formed of the inner groove part 365E and the abutment surface 371E. The throttle 172E communicates with the rod chamber 90. The throttle 302E is formed of the outer groove part 366E and the abutment surface 371E.

The seal chamber 171E is formed inside the inner annular groove 102E. The seal chamber 171E is formed to be surrounded by the wall surface portion 121E, the wall surface portion 122E, the bottom surface portion 123E, and the abutment surface 371E. The seal chamber 171E has an annular shape. A central axis of the seal chamber 171E and the central axis of the through hole 101E coincide with each other. Both the throttles 172E and 302E communicate with the seal chamber 171E.

A passage in the passage hole 350E of the case member 71E serves as a lower chamber side passage 355E (third passage). A passage in the passage hole 351E of the case member 71E serves as a lower chamber side passage 356E (third passage). One end of each of the lower chamber side passages 355E and 356E opens to the seal chamber 171E. The other end of each of the lower chamber side passages 355E and 356E opens to a lower chamber 20. The lower chamber side passage 355E opens at a position in the vicinity of the wall surface portion 121E in the seal chamber 171E. The lower chamber side passage 356E opens at a position in the vicinity of the wall surface portion 122E in the seal chamber 171E. The lower chamber side passage 356E is on an outer side with respect to the lower chamber side passage 355E in a radial direction of the seal chamber 171E. The seal chamber 171E is provided between the lower chamber side passages 355E and 356E and the throttles 172E and 302E.

The disc 362E, the plurality of discs 363E, and the disc 364E are stacked between the cover disc 361E and a disc 64 in order from the cover disc 361E side. The disc 362E has an outer diameter the same as the outer diameter of the cover disc 361E. The discs 363E have an outer diameter smaller than an outer diameter of the disc 362E. Specifically, the number of the discs 363E is three. The disc 364E has an outer diameter smaller than the outer diameter of the discs 363E and larger than an outer diameter of the disc 64.

A damping valve 63 is disposed on the outer annular groove 103E side of the case member 71E in the axial direction of the case member 71E. In the damping valve 63, a seal part 202 is slidably fitted in a liquid-tight manner to the wall surface portion 132E of the case member 71E over the entire circumference. The seal part 202 constantly seals a gap between the damping valve 63 and the wall surface portion 132E. The damping valve 63, the case member 71E, the cover disc 361E, and the discs 64 and 362E to 364E form a pilot chamber 211E. In other words, the pilot case 75E includes the pilot chamber 211E formed in the case member 71E. The pilot chamber 211E includes an inner portion of the outer annular groove 103E. The pilot chamber 211E exerts a pressure on the damping valve 63 in a direction of the piston 18. In other words, the pilot chamber 211E causes the damping valve 63 to generate a force in a direction of reducing a flow path area between the damping valve 63 and a valve seat part 47 due to an internal pressure.

The pilot chamber 211E communicates with the seal chamber 171E via the throttle 302E. The seal chamber 171E communicates with the rod chamber 90 via the throttle 172E. Apart of the pilot chamber 211E on the bottom surface portion 133E side overlaps the seal chamber 171E in position in an axial direction of the pilot case 75E. The pilot chamber 211E and the seal chamber 171E overlap each other in position in a radial direction of the pilot case 75E.

The shock absorber 1E of the sixth embodiment has a damping force generation mechanism 41E which is different from the damping force generation mechanism 41 in that it has the pilot chamber 211E different from the pilot chamber 211. The damping force generation mechanism 41E is also provided in a piston passage 210 similarly to the damping force generation mechanism 41. The damping force generation mechanism 41E also is an extension-side damping force generation mechanism similarly to the damping force generation mechanism 41.

One end of the throttle 302E opens to the seal chamber 171E, and the other end opens to the pilot chamber 211E. The throttle 302E communicates with the seal chamber 171E and the pilot chamber 211E. The rod chamber 90 and the throttle 172E form an upper chamber side passage 181E (second passage).

The seal member 73A is housed in the seal chamber 171E. The seal member 73A is in contact with the wall surface portion 121E and the wall surface portion 122E of the inner annular groove 102E at the same time. At that time, the seal member 73A elastically deforms in a radial direction of the seal member 73A. The seal member 73A moves in an axial direction of the seal member 73A within the seal chamber 171E. The seal member 73A deforms in the axial direction of the seal member 73A within the seal chamber 171E. At least the abutment surface 371E side of the seal member 73A is deformable to a side of the lower chamber side passages 355E and 356E within the seal chamber 171E. At least the bottom surface portion 123E side of the seal member 73A is deformable to a side of the throttles 172E and 302E within the seal chamber 171E.

A seal part 191D of the seal member 73A comes in contact with the wall surface portion 121E to seal between itself and the wall surface portion 121E. A seal part 192D of the seal member 73A comes in contact with the wall surface portion 122E to seal between itself and the wall surface portion 122E. The seal parts 191D and 192D are also provided in the seal chamber 171E. The seal parts 191D and 192D of the seal member 73A suppress a flow of an oil fluid from the upper chamber side passage 181E side to a side of the lower chamber side passages 355E and 356E. The seal parts 191D and 192D also suppress a flow of the oil fluid from a side of the lower chamber side passages 355E and 356E to the upper chamber side passage 181E side. A pressure receiving part 193D on the abutment surface 371E side of the seal member 73A receives a pressure on the upper chamber side passage 181E side. A pressure receiving part 194D on the bottom surface portion 123E side of the seal member 73A receives a pressure on a side of the lower chamber side passages 355E and 356E. The seal member 73A has a seal function that partitions the inside of the seal chamber 171E into an upper chamber communicating chamber 185E that communicates with the upper chamber side passage 181E and a lower chamber communicating chamber 186E that communicates with the lower chamber side passages 355E and 356E. The seal member 73A has both the seal function and a property of elastic deformation at the same time.

The seal chamber 171E, the throttles 172E and 302E, the pilot chamber 211E, the lower chamber side passages 355E and 356E, and the seal member 73A constitute a frequency sensitive mechanism 195E that makes a damping force variable in response to a frequency of reciprocation of the piston 18. The frequency sensitive mechanism 195E is provided in the pilot case 75E. In the frequency sensitive mechanism 195E, the seal chamber 171E, the lower chamber side passages 355E and 356E, and the throttles 172E and 302E are formed by two members including the case member 71E and the cover disc 361E.

In the frequency sensitive mechanism 195E, some of the flow of the oil fluid in the piston passage 210 is introduced into the upper chamber communicating chamber 185E of the seal chamber 171E via the throttle 198, the rod chamber 90, and the throttle 172E. In the frequency sensitive mechanism 195E, some of the flow of the oil fluid in the piston passage 210 is introduced into the pilot chamber 211E via the throttle 198, the rod chamber 90, the throttle 172E, the upper chamber communicating chamber 185E of the seal chamber 171E, and the throttle 302E. The damping force generation mechanism 41E controls an opening of the damping valve 63 due to a pressure in the pilot chamber 211E.

The upper chamber side passage 181E including the rod chamber 90 communicates, via the throttle 198, with an upstream side of the damping valve 63 in a flow direction of the oil fluid in the piston passage 210 during the extension stroke. The upper chamber side passage 181E communicates with the upper chamber communicating chamber 185E of the seal chamber 171E. Both the lower chamber side passages 355E and 356E communicate with the lower chamber communicating chamber 186D of the seal chamber 171E. Both the lower chamber side passages 355E and 356E communicate with the lower chamber 20 downstream of the damping valve 63 in the flow direction of the oil fluid in the piston passage 210 during the extension stroke. Only one of the lower chamber side passage 355E and the lower chamber side passage 356E may be provided.

Here, when the above-described parts are assembled to the mounting shaft part 28 of the piston rod 21, the discs 362E to 364E, the cover disc 361E, and the case member 71E are assembled instead of the case member 71 and the seat member 72. At that time, the seal member 73A is assembled to the case member 71E in advance. Other than these, assembly is performed in the same manner as in the first embodiment. Thereby, the pilot case 75E is disposed to sandwich the damping valve 63 between the pilot case 75E and the piston 18. Also, the central axis of the case member 71E is made to coincide with a central axis of the piston rod 21. Also, a central axis of the cover disc 361E is made to coincide with the central axis of the piston rod 21.

In the shock absorber 1E, the throttles 172E and 302E are provided in the surface portion 95E of the case member 71E that serves as a seat surface of the cover disc 361E. The throttle 172E allows the rod chamber 90 and the seal chamber 171E to communicate with each other. The throttle 302E allows the seal chamber 171E and the pilot chamber 211E to communicate with each other. Therefore, the same pressure is maintained from the rod chamber 90 to the pilot chamber 211E, and the cover disc 361E does not function as a valve.

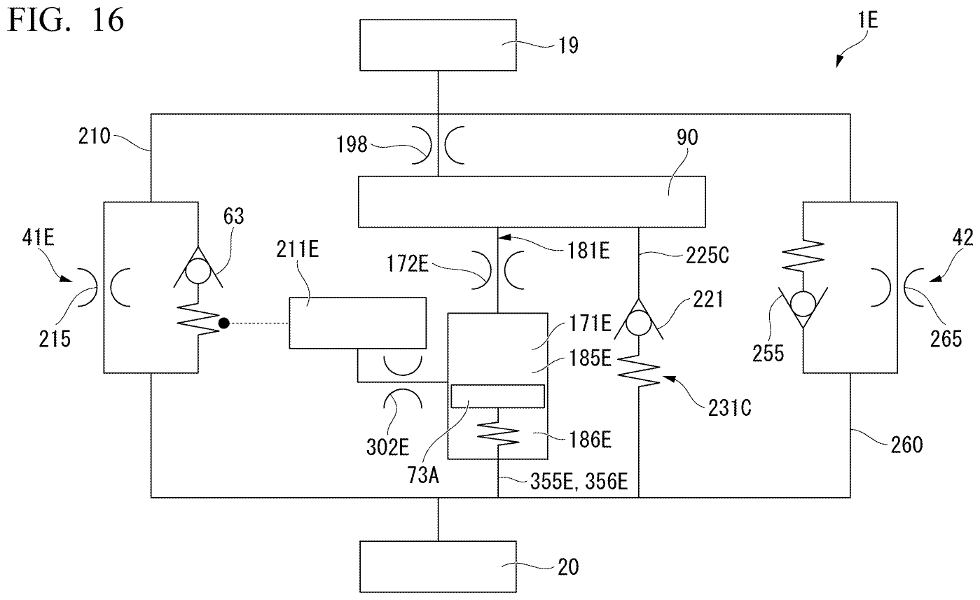

FIG. 16 shows a hydraulic circuit diagram of a portion of the vicinity of the piston 18 of the shock absorber 1E configured as described above. As shown in FIG. 16, in the shock absorber 1E, the rod chamber 90 communicates with the upper chamber communicating chamber 185E of the seal chamber 171E via the throttle 172E. The upper chamber communicating chamber 185E communicates with the pilot chamber 211E via the throttle 302E. The upper chamber side passage 181E includes the rod chamber 90 and the throttle 172E. The throttle 302E is provided between the pilot chamber 211E and the upper chamber communicating chamber 185E of the seal chamber 171E. The lower chamber communicating chamber 186E of the seal chamber 171E communicates with the lower chamber 20 through the lower chamber side passages 355E and 356E.

During the extension stroke of the shock absorber 1E configured as described above, the oil fluid is introduced from the piston passage 210 into the upper chamber communicating chamber 185E of the seal chamber 171E via the throttle 198 and the upper chamber side passage 181E. Then, the seal member 73A moves to a side opposite to the piston 18 in the axial direction of the seal member 73A and deforms. At that time, the oil fluid is discharged from the lower chamber communicating chamber 186E of the seal chamber 171E to the lower chamber 20 through the lower chamber side passages 355E and 356E. During a compression stroke of the shock absorber 1E, the oil fluid is introduced from the lower chamber 20 into the lower chamber communicating chamber 186E of the seal chamber 171E through the lower chamber side passages 355E and 356E. Then, the seal member 73A moves to the piston 18 side in the axial direction of the seal member 73A and deforms. At that time, the oil fluid is discharged from the upper chamber communicating chamber 185E of the seal chamber 171E to the piston passage 210, that is, the upper chamber 19, via the upper chamber side passage 181E and the throttle 198. Operations other than these of the frequency sensitive mechanism 195E are substantially the same as those of the shock absorber 1A.

The shock absorber 1E of the sixth embodiment includes the upper chamber side passage 181E that communicates, via the throttle 198, with an upstream side of the damping valve 63 in the flow direction of the oil fluid in the piston passage 210 during the extension stroke. Also, the shock absorber 1E includes the lower chamber side passages 355E and 356E communicating with the lower chamber 20 downstream of the damping valve 63 in the flow direction of the oil fluid in the piston passage 210 during the extension stroke. Also, the shock absorber 1E includes the seal chamber 171E provided between the upper chamber side passage 181E and the lower chamber side passages 355E and 356E. Then, the shock absorber 1E includes the seal member 73A having rubber elasticity provided in the seal chamber 171E. Therefore, the shock absorber 1E has a structure in which the frequency sensitive mechanism 195E moves the seal member 73A within the seal chamber 171E. Also, in the shock absorber 1E, the pilot chamber 211E communicates with the upper chamber side passage 181E. Also, in the shock absorber 1E, the bypass passage 225C communicates with the upper chamber side passage 181E. Also, in the shock absorber 1E, the pilot case 75E in which the pilot chamber 211E is formed is disposed to sandwich the damping valve 63 between the pilot case 75E and the piston 18. Also, in the shock absorber 1E, the seal chamber 171E and the lower chamber side passages 355E and 356E are formed of two members including the case member 71E and the cover disc 361E. In order words, while the seal chamber is formed by forging two forged parts in other embodiments, in the present sixth embodiment, the seal chamber is formed by the case member 71E formed of one forged part and the cover disc 361E which is less expensive and more productive than parts formed by forging. That is, the passage part includes the seal chamber 171E in which the seal member 73A is housed as an elastic member, and the seal chamber 171E is formed of the case member 71E formed by forging and capable of housing the seal member 73A, and the cover disc 361E serving as a cover member disposed to face the case member 71E. As described above, a structure of the shock absorber 1E can be simplified similarly to the shock absorber 1.

In the shock absorber 1E, the pilot chamber 211E and the seal chamber 171E are formed in the pilot case 75E at positions at which they overlap each other in the axial direction of the pilot case 75E. Thereby, an increase in size of the pilot case 75E in the axial direction can be minimized.

The cover disc 361E formed by pressing-forming a plate material is used in the pilot case 75E of the shock absorber 1E. Therefore, costs can be reduced compared to a case in which both parts constituting the pilot case 75E are parts formed by sintering or parts formed by cutting.

### Seventh Embodiment

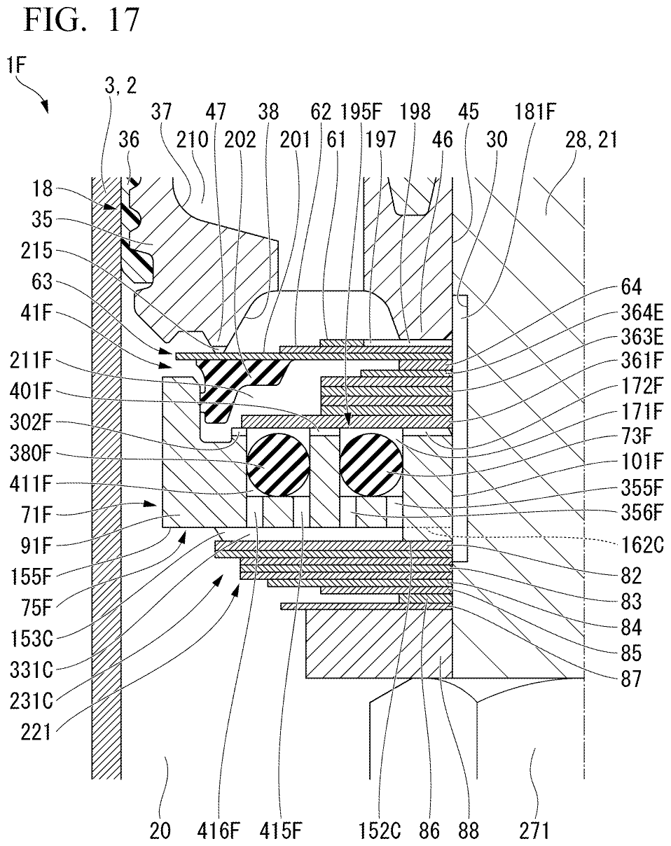

A shock absorber according to a seventh embodiment of the present invention will be described mainly on the basis of FIGS. 17 to 19, focusing on differences from the sixth embodiment. Further, parts common to those in the sixth embodiment will be denoted by the same terms and the same reference signs.

As shown in FIG. 17, a shock absorber 1F of the seventh embodiment includes a pilot case 75F instead of the pilot case 75E. The pilot case 75F includes a case member 71F that is partially different from the case member 71. The pilot case 75F includes a cover disc 361F that is different in size from the cover disc 361E. A seal member 73F (elastic member, moving member) and a seal member 380F (elastic member, moving member), which are different in size from the seal member 73A of the sixth embodiment, are provided in the pilot case 75F. Both the seal members 73F and 380F are O-rings. Both the seal members 73F and 380F are elastic members having rubber elasticity. The shock absorber 1F includes a plurality of, specifically four, discs 363E and one disc 364E. The cover disc 361F is different from the cover disc 361E in that an outer diameter thereof is larger than the outer diameter of the cover disc 361E.

The case member 71F is made of a metal. The case member 71F is integrally formed by sintering. The case member 71F may be formed by cutting. The case member 71F has an annular shape. The case member 71F has a mounting shaft part 28 of a piston rod 21 fitted to an inner circumferential side thereof. The pilot case 75F overlaps a passage groove 30 of the mounting shaft part 28 in position in the axial direction of the piston rod 21.

The case member 71F includes a member main body part 91F. The case member 71E includes a protruding part 152C similar to that of the fourth embodiment and a valve seat part 153C similar to that of the fourth embodiment. The member main body part 91F has an annular shape. The protruding part 152C is provided on an inner circumferential side of the member main body part 91F. A central axis of the member main body part 91F and a central axis of the protruding part 92C coincide with each other. These central axes serve as a central axis of the case member 71F. The protruding part 152C protrudes in an axial direction of the case member 71F from a surface portion 155F on one end side of the member main body part 91F in the axial direction of the case member 71F. The valve seat part 153C also protrudes in the axial direction of the case member 71F from the surface portion 155F of the member main body part 91F. The surface portion 155F extends to be orthogonal to the central axis of the case member 71F. The case member 71F is in contact with a disc 82 at the protruding part 152C.

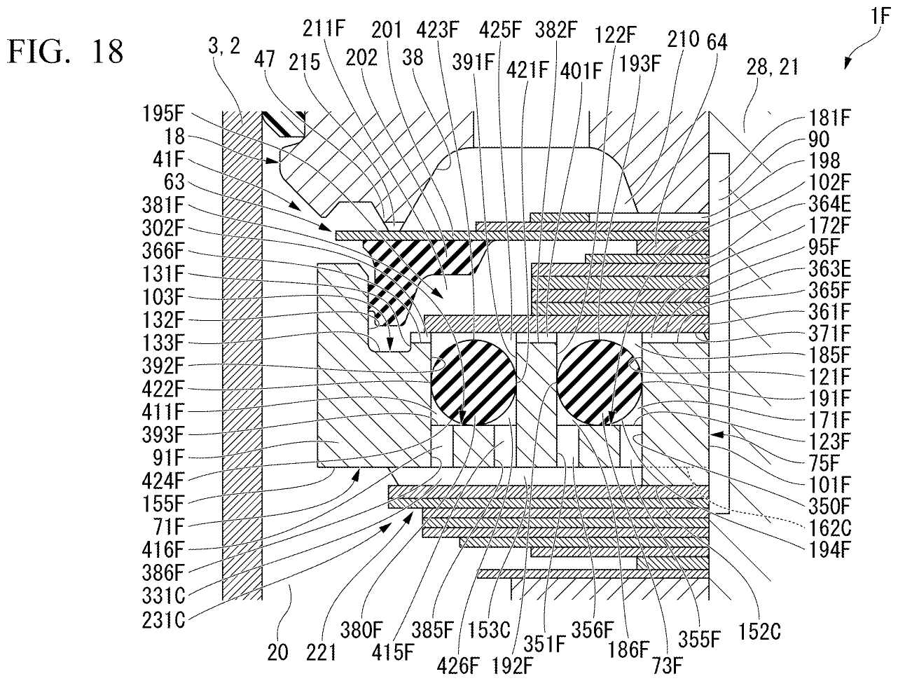

As shown in FIG. 18, a through hole 101F, an inner annular groove 102F, an intermediate annular groove 381F, and an outer annular groove 103F are formed in the case member 71F. An inner groove part 365F, an intermediate groove part 382F, and an outer groove part 366F are formed in the case member 71F. A passage hole 350F, a passage hole 351F, a passage hole 385F, and a passage hole 386F are formed in the case member 71F. The through hole 101F is formed at a center in a radial direction of the case member 71F. The through hole 101F penetrates the case member 71F in the axial direction of the case member 71F. The through hole 101F is formed of an inner circumferential surface of the member main body part 91F and an inner circumferential surface of the protruding part 152C. The inner circumferential surface of the member main body part 91F has a cylindrical surface shape. An outer circumferential surface of the member main body part 91F also has a cylindrical surface shape. A central axis of the through hole 101F coincides with the central axis of the case member 71F.

The inner annular groove 102F is formed in a surface portion 95F of the member main body part 91F on a side opposite to the surface portion 155F in an axial direction of the member main body part 91F. The surface portion 95F has a planar shape extending to be orthogonal to the central axis of the member main body part 91F. The inner annular groove 102F is recessed in the axial direction of the member main body part 91F from the surface portion 95F. The inner annular groove 102F surrounds the through hole 101F from an outer side in a radial direction of the member main body part 91F. The inner annular groove 102F has an annular shape. A central axis of the inner annular groove 102F coincides with the central axis of the through hole 101F.

The inner annular groove 102F has a wall surface portion 121F, a wall surface portion 122F, and a bottom surface portion 123F. The wall surface portion 122F is disposed on an outer side with respect to the wall surface portion 121F in the radial direction of the member main body part 91F. The wall surface portion 121F has a cylindrical surface shape. The wall surface portion 121F faces outward in the radial direction of the member main body part 91F. The wall surface portion 122F has a cylindrical surface shape. The wall surface portion 122F faces inward in the radial direction of the member main body part 91F. The bottom surface portion 123F connects an end edge portion of the wall surface portion 121F on a side opposite to the surface portion 95F and an end edge portion of the wall surface portion 122F on a side opposite to the surface portion 95F. The bottom surface portion 123F has a planar shape extending parallel to the surface portion 95F. A central axis of the wall surface portion 121F, a central axis of the wall surface portion 122F, and a central axis of the bottom surface portion 123F are the same as the central axis of the inner annular groove 102F.

The intermediate annular groove 381F is formed in the surface portion 95F of the member main body part 91F. The intermediate annular groove 381F is recessed in the axial direction of the member main body part 91F from the surface portion 95F. The intermediate annular groove 381F surrounds the inner annular groove 102F from an outer side in the radial direction of the member main body part 91F. The intermediate annular groove 381F has an annular shape. A central axis of the intermediate annular groove 381F coincides with the central axis of the through hole 101F.

The intermediate annular groove 381F has a wall surface portion 391F, a wall surface portion 392F, and a bottom surface portion 393F. The wall surface portion 392F is disposed on an outer side with respect to the wall surface portion 391F in the radial direction of the member main body part 91F. The wall surface portion 391F has a cylindrical surface shape. The wall surface portion 391F faces outward in the radial direction of the member main body part 91F. The wall surface portion 392F has a cylindrical surface shape. The wall surface portion 392F faces inward in the radial direction of the member main body part 91F. The bottom surface portion 393F connects an end edge portion of the wall surface portion 391F on a side opposite to the surface portion 95F and an end edge portion of the wall surface portion 392F on a side opposite to the surface portion 95F. The bottom surface portion 393F has a planar shape extending parallel to the surface portion 95F. A central axis of the wall surface portion 391F, a central axis of the wall surface portion 392F, and a central axis of the bottom surface portion 393F are the same as the central axis of the intermediate annular groove 381F.

The outer annular groove 103F is recessed in the axial direction of the member main body part 91F from the surface portion 95F of the member main body part 91F. The outer annular groove 103F is disposed on an outer side with respect to the intermediate annular groove 381F in the radial direction of the member main body part 91F. The outer annular groove 103F surrounds the intermediate annular groove 381F from an outer side in the radial direction of the member main body part 91F. The outer annular groove 103F has an annular shape. A central axis of the outer annular groove 103F coincides with the central axis of the through hole 101F.

The outer annular groove 103F has a wall surface portion 131F, a wall surface portion 132F, and a bottom surface portion 133F. The wall surface portion 132F is disposed on an outer side with respect to the wall surface portion 131F in the radial direction of the member main body part 91F. The wall surface portion 131F faces outward in the radial direction of the member main body part 91F. The wall surface portion 131F has a cylindrical surface shape. The wall surface portion 132F has a cylindrical surface shape. The wall surface portion 132F faces inward in the radial direction of the member main body part 91F. The bottom surface portion 133F connects an end edge portion of the wall surface portion 131F on a side opposite to the surface portion 95F and an end edge portion of the wall surface portion 132F on a side opposite to the surface portion 95F. The bottom surface portion 133F has a planar shape extending parallel to the surface portion 95F. A central axis of the wall surface portion 131F, a central axis of the wall surface portion 132F, and a central axis of the bottom surface portion 133F are the same as the central axis of the outer annular groove 103F.

The inner annular groove 102F, the intermediate annular groove 381F, and the outer annular groove 103F overlap each other in position in the axial direction of the case member 71F. The inner annular groove 102F, the intermediate annular groove 381F, and the outer annular groove 103F are formed on one side of the same side in the axial direction of the case member 71F.

The passage holes 350F and 351F are formed in the member main body part 91F. Both the passage holes 350F and 351F penetrate the member main body part 91F in the axial direction of the member main body part 91F. Both the passage holes 350F and 351F extend in the axial direction of the member main body part 91F. One end of each of the passage holes 350F and 351F opens to the bottom surface portion 123F of the inner annular groove 102F. The other end of each of the passage holes 350F and 351F opens to the surface portion 155F. The passage holes 350F and 351F are both disposed at positions between a seat constituting part 331C and a seat constituting part 331C adjacent to each other in a circumferential direction of the case member 71F. The passage hole 350F is disposed on an inner side with respect to the passage hole 351F in the radial direction of the member main body part 91F.

The passage holes 385F and 386F are formed in the member main body part 91F. Both the passage holes 385F and 386F penetrate the member main body part 91F in the axial direction of the member main body part 91F. Both the passage holes 385F and 386F extend in the axial direction of the member main body part 91F. One end of each of the passage holes 385F and 386F opens to the bottom surface portion 393F of the intermediate annular groove 381F. The other end of each of the passage holes 385F and 386F opens to the surface portion 155F. The passage holes 385F and 386F are both disposed at positions between a seat constituting part 331C and a seat constituting part 331C adjacent to each other in the circumferential direction of the case member 71F. The passage hole 385F is disposed on an inner side with respect to the passage hole 386F in the radial direction of the member main body part 91F. The passage hole 385F is disposed on an outer side with respect to the passage hole 351F in the radial direction of the member main body part 91F.

The inner groove part 365F, the intermediate groove part 382F, and the outer groove part 366F are all formed in the surface portion 95F. The inner groove part 365F, the intermediate groove part 382F, and the outer groove part 366F are all recessed in the axial direction of the member main body part 91F from the surface portion 95F. The inner groove part 365F extends from the through hole 101F to the wall surface portion 121F of the inner annular groove 102F. One end of the inner groove part 365F opens to a rod chamber 90. The other end of the inner groove part 365E opens to the inner annular groove 102F. The intermediate groove part 382F extends from the wall surface portion 122F of the inner annular groove 102F to the wall surface portion 391F of the intermediate annular groove 381F. One end of the intermediate groove part 382F opens to the inner annular groove 102E. The other end of the intermediate groove part 382F opens to the intermediate annular groove 381F. The outer groove part 366F extends from the wall surface portion 392F of the intermediate annular groove 381F to the wall surface portion 131F of the outer annular groove 103F. One end of the outer groove part 366F opens to the intermediate annular groove 381F. The other end of the outer groove part 366F opens to the outer annular groove 103F.

The cover disc 361F has an outer diameter larger than an inner diameter of the wall surface portion 392F of the intermediate annular groove 381F and smaller than an outer diameter of the wall surface portion 131F of the outer annular groove 103F. When both the case member 71F and the cover disc 361F are fitted on the mounting shaft part 28 of the piston rod 21, central axes thereof are made to be coincident with each other. In this state, the cover disc 361F is in surface contact with the surface portion 95F of the member main body part 91F at an abutment surface 371F on one side in the axial direction of the cover disc 361F. Then, the case member 71F and the cover disc 361F form throttles 172F, 401F, and 302F, a seal chamber 171F (passage part), and a seal chamber 411F (passage part).

The throttle 172F is formed of the inner groove part 365F and the abutment surface 371F. The throttle 172F communicates with the rod chamber 90. The throttle 401F is formed of the intermediate groove part 382F and the abutment surface 371F. The throttle 302F is formed of the outer groove part 366F and the cover disc 361F.

The seal chamber 171F is formed inside the inner annular groove 102F. The seal chamber 171F is formed to be surrounded by the wall surface portion 121F, the wall surface portion 122F, the bottom surface portion 123F, and the abutment surface 371F. The seal chamber 171F has an annular shape. A central axis of the seal chamber 171F and the central axis of the through hole 101F coincide with each other. The throttle 172F communicates with the seal chamber 171F.

The seal chamber 411F is formed inside the intermediate annular groove 381F. The seal chamber 411F is formed to be surrounded by the wall surface portion 391F, the wall surface portion 392F, the bottom surface portion 393F, and the abutment surface 371F. The seal chamber 411F has an annular shape. A central axis of the seal chamber 411F and the central axis of the through hole 101F coincide with each other. The throttle 401F communicates with the seal chambers 171F and 411F. The throttle 302F communicates with the seal chamber 411F.

A passage in the passage hole 350F of the case member 71F serves as a lower chamber side passage 355F (third passage). A passage in the passage hole 351F of the case member 71F serves as a lower chamber side passage 356F (third passage). One end of each of the lower chamber side passages 355F and 356F opens to the seal chamber 171F. The other end of each of lower chamber side passages 355F and 356F opens to a lower chamber 20. The lower chamber side passage 355F opens at a position in the vicinity of the wall surface portion 121F in the seal chamber 171F. The lower chamber side passage 356F opens at a position in the vicinity of the wall surface portion 122F in the seal chamber 171F. The lower chamber side passage 356F is on an outer side with respect to the lower chamber side passage 355F in a radial direction of the seal chamber 171F. The seal chamber 171F is provided between the lower chamber side passages 355F and 356F and the throttles 172F and 401F.

A passage in the passage hole 385F of the case member 71F serves as a lower chamber side passage 415F (third passage). A passage in the passage hole 386F of the case member 71F serves as a lower chamber side passage 416F (third passage). One end of each of the lower chamber side passages 415F and 416F opens to the seal chamber 411F. The other end of each of the lower chamber side passages 415F and 416F opens to the lower chamber 20. The lower chamber side passage 415F opens at a position in the vicinity of the wall surface portion 391F in the seal chamber 411F. The lower chamber side passage 416F opens at a position in the vicinity of the wall surface portion 392F in the seal chamber 411F. The lower chamber side passage 416F is on an outer side with respect to the lower chamber side passage 415F in a radial direction of the seal chamber 411F. The seal chamber 411F is provided between the lower chamber side passages 415F and 416F and the throttles 401F and 302F.

The plurality of discs 363E and the disc 364E are stacked between the cover disc 361F and the disc 64 in order from the cover disc 361F side. Specifically, the number of the discs 363E is four.

A damping valve 63 is disposed on the outer annular groove 103F side of the case member 71F in the axial direction of the case member 71F. In the damping valve 63, a seal part 202 is slidably fitted in a liquid-tight manner to the wall surface portion 132F of the case member 71F over the entire circumference. The seal part 202 constantly seals a gap between the damping valve 63 and the wall surface portion 132F. The damping valve 63, the case member 71F, the cover disc 361F, and the discs 64, 363E, and 364E form a pilot chamber 211F. In other words, the pilot case 75F has the pilot chamber 211F formed in the case member 71F. The pilot chamber 211F includes an inner portion of the outer annular groove 103F. The pilot chamber 211F exerts a pressure on the damping valve 63 in a direction of the piston 18. In other words, the pilot chamber 211F causes the damping valve 63 to generate a force in a direction of reducing a flow path area between the damping valve 63 and a valve seat part 47 due to an internal pressure.

The pilot chamber 211F communicates with the seal chamber 411F via the throttle 302F. The seal chamber 411F communicates with the seal chamber 171F via the throttle 401F. The seal chamber 171F communicates with the rod chamber 90 via the throttle 172F. A portion of the pilot chamber 211F on the bottom surface portion 133F side and the seal chambers 171F and 411F overlap each other in position in an axial direction of the pilot case 75F. The pilot chamber 211F and the seal chambers 171F and 411F overlap each other in position in a radial direction of the pilot case 75F. The seal chamber 171F and the seal chamber 411F are positioned differently in the radial direction of the pilot case 75F.

The shock absorber 1F of the seventh embodiment has a damping force generation mechanism 41F which is different from the damping force generation mechanism 41E in that it has the pilot chamber 211F different from the pilot chamber 211E. The damping force generation mechanism 41F is also provided in the piston passage 210 similarly to the damping force generation mechanism 41E. Similarly to the damping force generation mechanism 41E, the damping force generation mechanism 41F is also an extension-side damping force generation mechanism.

One end of the throttle 302F opens to the seal chamber 411F and the other end opens to the pilot chamber 211F. The throttle 302F communicates with the seal chamber 411F and the pilot chamber 211F. One end of the throttle 401F opens to the seal chamber 411F and the other end opens to the seal chamber 171F. The throttle 401F communicates with the seal chamber 411F and the seal chamber 171F. The rod chamber 90 and the throttle 172F form an upper chamber side passage 181F (second passage).

The seal member 73F is housed in the seal chamber 171F. The seal member 73F is in contact with the wall surface portion 121F and the wall surface portion 122F of the inner annular groove 102F at the same time. At that time, the seal member 73F elastically deforms in a radial direction of the seal member 73F. The seal member 73F moves in the axial direction of the seal member 73F within the seal chamber 171F. The seal member 73F deforms in the axial direction of the seal member 73F within the seal chamber 171F. The seal member 73F is deformable to a side of the lower chamber side passage 355F and the lower chamber side passage 356F within the seal chamber 171F. The seal member 73F is deformable to a side of the throttles 172F and 401F within the seal chamber 171F.

The seal member 73F includes a seal part 191F, a seal part 192F, a pressure receiving part 193F, and a pressure receiving part 194F. The seal part 191F comes into contact with the wall surface portion 121F to seal between itself and the wall surface portion 121F. The seal part 192F comes into contact with the wall surface portion 122F to seal between itself and the wall surface portion 122F. The seal parts 191F and 192F are also provided in the seal chamber 171F. The seal parts 191F and 192F of the seal member 73F suppress a flow of an oil fluid from a side of the throttles 172F and 401F to a side of the lower chamber side passages 355F and 356F. The seal parts 191F and 192F also suppress a flow of the oil fluid from a side of the lower chamber side passages 355F and 356F to a side of the throttles 172F and 401F. The pressure receiving part 193F is on the abutment surface 371F side of the seal member 73F. The pressure receiving part 193F receives a pressure on the upper chamber side passage 181F side. The pressure receiving part 194F is on the bottom surface portion 123F side of the seal member 73F. The pressure receiving part 194F receives a pressure on a side of the lower chamber side passages 355F and 356F. The seal member 73F has a seal function that partitions the inside of the seal chamber 171F into an upper chamber communicating chamber 185F communicating with the upper chamber side passage 181F and a lower chamber communicating chamber 186F communicating with the lower chamber side passages 355F and 356F. The seal member 73F has both the seal function and a property of elastic deformation at the same time.

The seal member 380F has an inner diameter larger than an outer diameter of the seal member 73F. The seal member 380F is housed in the seal chamber 411F. The seal member 380F is in contact with the wall surface portion 391F and the wall surface portion 392F of the intermediate annular groove 381F at the same time. At that time, the seal member 380F elastically deforms in a radial direction of the seal member 380F. The seal member 380F moves in an axial direction of the seal member 380F within the seal chamber 411F. The seal member 380F deforms in the axial direction of the seal member 380F within the seal chamber 411F. The seal member 380F is deformable to a side of the lower chamber side passage 415F and the lower chamber side passage 416F within the seal chamber 411F. The seal member 380F is deformable to a side of the throttles 302F and 401F within the seal chamber 411F.

The seal member 380F includes a seal part 421F, a seal part 422F, a pressure receiving part 423F, and a pressure receiving part 424F. The seal part 421F comes in contact with the wall surface portion 391F to seal between itself and the wall surface portion 391F. The seal part 422F comes in contact with the wall surface portion 392F to seal between itself and the wall surface portion 392F. The seal parts 421F and 422F are also provided in the seal chamber 411F. The seal parts 421F and 422F of the seal member 380F suppress a flow of the oil fluid from a side of the throttles 302F and 401F to a side of the lower chamber side passages 415F and 416F. The seal parts 421F and 422F also suppress a flow of the oil fluid from a side of the lower chamber side passages 415F and 416F to a side of the throttles 302F and 401F. The pressure receiving part 423F is on the abutment surface 371F side of the seal member 380F. The pressure receiving part 423F receives a pressure on the upper chamber side passage 181F side. The pressure receiving part 424F is on the bottom surface portion 393F side of the seal member 380F. The pressure receiving part 424F receives a pressure on a side of the lower chamber side passages 415F and 416F. The seal member 380F has a seal function that partitions the inside of the seal chamber 411F into an upper chamber communicating chamber 425F that communicates with the upper chamber side passage 181F via the seal chamber 171F and the throttle 401F, and a lower chamber communicating chamber 426F that communicates with the lower chamber side passages 415F and 416F. The seal member 380F has both the seal function and a property of elastic deformation at the same time.

The seal chambers 171F and 411F, the throttles 172F, 401F, and 302F, the pilot chamber 211F, the lower chamber side passages 355F, 356F, 415F, and 416F, and the seal members 73F and 380F constitute a frequency sensitive mechanism 195F that makes a damping force variable in response to a frequency of reciprocation of the piston 18. The frequency sensitive mechanism 195F is provided in the pilot case 75F. In the frequency sensitive mechanism 195F, the seal chambers 171F and 411F, the lower chamber side passages 355F, 356F, 415F, and 416F, and the throttles 172F, 401F, and 302F are formed of two members including the case member 71F and the cover disc 361F.

In the frequency sensitive mechanism 195F, some of the flow of the oil fluid in the piston passage 210 is introduced into the upper chamber communicating chamber 185F of the seal chamber 171F via the throttle 198, the rod chamber 90, and the throttle 172F. In the frequency sensitive mechanism 195F, some of the flow of the oil fluid in the piston passage 210 is introduced into the upper chamber communicating chamber 425F of the seal chamber 411F via the throttle 198, the rod chamber 90, the throttle 172F, the upper chamber communicating chamber 185F, and the throttle 401F. In the frequency sensitive mechanism 195F, some of the flow of the oil fluid in the piston passage 210 is introduced into the pilot chamber 211F via the throttle 198, the rod chamber 90, the throttle 172F, the upper chamber communicating chamber 185F, the throttle 401F, the upper chamber communicating chamber 425F, and the throttle 302F. The damping force generation mechanism 41F controls an opening of the damping valve 63 due to a pressure in the pilot chamber 211F.

The upper chamber side passage 181F including the rod chamber 90 communicates, via the throttle 198, with an upstream side of the damping valve 63 in a flow direction of the oil fluid in the piston passage 210 during the extension stroke. The upper chamber side passage 181F communicates with the upper chamber communicating chamber 185F of the seal chamber 171F. The upper chamber side passage 181F communicates with the upper chamber communicating chamber 425F of the seal chamber 411F via the upper chamber communicating chamber 185F and the throttle 401F. Both the lower chamber side passages 355F and 356F communicate with the lower chamber communicating chamber 186F of the seal chamber 171F. Both the lower chamber side passages 415F and 416F communicate with the lower chamber communicating chamber 426F of the seal chamber 411F. All the lower chamber side passages 355F, 356F, 415F, and 416F communicate with the lower chamber 20 downstream of the damping valve 63 in the flow direction of the oil fluid in the piston passage 210 during the extension stroke. Only one of the lower chamber side passage 355F and the lower chamber side passage 356F may be provided. Only one of the lower chamber side passage 415F and the lower chamber side passage 416F may be provided.

Here, when the above-described parts are assembled to the mounting shaft part 28 of the piston rod 21, the cover disc 361F is assembled instead of the cover disc 361E. Also, the case member 71F is assembled instead of the case member 71E. At that time, the seal members 73F and 380F are assembled to the case member 71F in advance. Other than these, assembly is performed in the same manner as in the sixth embodiment. Thereby, the pilot case 75F is disposed to sandwich the damping valve 63 between the pilot case 75F and the piston 18. Also, the central axis of the case member 71F is made to coincide with a central axis of the piston rod 21. Also, a central axis of the cover disc 361F is made to coincide with the central axis of the piston rod 21.

In the shock absorber 1F, the throttles 172F, 401F, and 302F are provided in the surface portion 95F of the case member 71F that serves as a seat surface of the cover disc 361F. The throttle 172F allows the rod chamber 90 and the seal chamber 171F to communicate with each other. The throttle 401F allows the seal chamber 171F and the seal chamber 411F to communicate with each other. The throttle 302F allows the seal chamber 411F and the pilot chamber 211F to communicate with each other. Therefore, the same pressure is maintained from the rod chamber 90 to the pilot chamber 211F, and the cover disc 361F does not function as a valve.

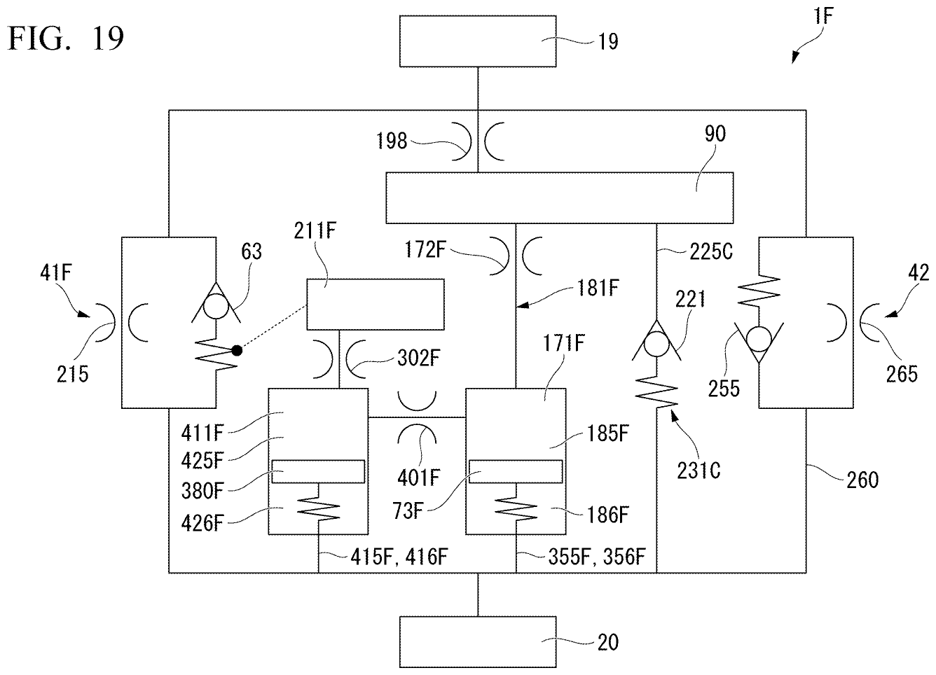

FIG. 19 shows a hydraulic circuit diagram of a portion of the vicinity of the piston 18 of the shock absorber 1F configured as described above. As shown in FIG. 19, in the shock absorber 1F, the rod chamber 90 communicates with the upper chamber communicating chamber 185F of the seal chamber 171F via the throttle 172F. The upper chamber communicating chamber 185E communicates with the upper chamber communicating chamber 425F of the seal chamber 411F via the throttle 401F. The upper chamber communicating chamber 425F communicates with the pilot chamber 211F via the throttle 302F. The upper chamber side passage 181F is formed of the rod chamber 90 and the throttle 172F. The lower chamber communicating chamber 186F of the seal chamber 171F communicates with the lower chamber 20 through the lower chamber side passages 355F and 356F. The lower chamber communicating chamber 426F of the seal chamber 411F communicates with the lower chamber 20 via the lower chamber side passages 415F and 416F.

During the extension stroke of the shock absorber 1F configured as described above, the oil fluid is introduced from the piston passage 210 into the upper chamber communicating chamber 185F of the seal chamber 171F via the throttle 198 and the upper chamber side passage 181F. At the same time, the oil fluid is introduced from the upper chamber communicating chamber 185F into the upper chamber communicating chamber 425F of the seal chamber 411F via the throttle 401F. Then, the seal member 73F moves to a side opposite to the piston 18 in the axial direction of the seal member 73F and deforms. At that time, the oil fluid is discharged from the lower chamber communicating chamber 186F of the seal chamber 171F to the lower chamber 20 through the lower chamber side passages 355F and 356F. At the same time, the seal member 380F moves to a side opposite to the piston 18 in the axial direction of the seal member 380F and deforms. At that time, the oil fluid is discharged from the lower chamber communicating chamber 426F of the seal chamber 411F to the lower chamber 20 through the lower chamber side passages 415F and 416F. During a compression stroke of the shock absorber 1F, the oil fluid is introduced from the lower chamber 20 into the lower chamber communicating chamber 186F of the seal chamber 171F through the lower chamber side passages 355F and 356F. Then, the seal member 73F moves to the piston 18 side in the axial direction of the seal member 73F and deforms. At that time, the oil fluid is discharged from the upper chamber communicating chamber 185F of the seal chamber 171F to the piston passage 210, that is, an upper chamber 19, through the upper chamber side passage 181F and the throttle 198. Also, during the compression stroke of the shock absorber 1F, the oil fluid is introduced from the lower chamber 20 into the lower chamber communicating chamber 426F of the seal chamber 411F through the lower chamber side passages 415F and 416F. Then, the seal member 380F moves to the piston 18 side in the axial direction of the seal member 380F and deforms. At that time, the oil fluid is discharged from the upper chamber communicating chamber 425F of the seal chamber 411F to the piston passage 210, that is, the upper chamber 19, via the throttle 401F, the upper chamber communicating chamber 185F, the upper chamber side passage 181F, and the throttle 198. Operations other than these of the frequency sensitive mechanism 195F are substantially the same as those of the shock absorber 1A.

The shock absorber 1F of the seventh embodiment includes the upper chamber side passage 181F that communicates, via the throttle 198, with an upstream side of the damping valve 63 in the flow direction of the oil fluid in the piston passage 210 during the extension stroke. Also, the shock absorber 1F also includes the lower chamber side passages 355F, 356F, 415F and 416F communicating with the lower chamber 20 downstream of the damping valve 63 in the flow direction of the oil fluid in the piston passage 210 during the extension stroke. Also, the shock absorber 1F includes the seal chambers 171F and 411F provided between the upper chamber side passage 181F and the lower chamber side passages 355E, 356E, 415F and 416F. Then, the shock absorber 1F includes the seal member 73F having rubber elasticity provided in the seal chamber 171F. Also, the shock absorber 1F includes the seal member 380F having rubber elasticity provided in the seal chamber 411F. Therefore, the shock absorber 1F has a structure in which the frequency sensitive mechanism 195F moves the seal member 73F within the seal chamber 171F and the seal member 380F within the seal chamber 411F. Also, in the shock absorber 1F, the pilot chamber 211F communicates with the upper chamber side passage 181F. Also, in the shock absorber 1F, the bypass passage 225C communicates with the upper chamber side passage 181F. Also, in the shock absorber 1F, the pilot case 75F in which the pilot chamber 211F is formed is disposed to sandwich the damping valve 63 between the pilot case 75F and the piston 18. Also, in the shock absorber 1F, the seal chambers 171F and 411F and the lower chamber side passages 355F, 356F, 415F, and 416F are formed of two members including the case member 71F and the cover disc 361F. As described above, a structure of the shock absorber 1F can be simplified similarly to the shock absorber 1.

In the shock absorber 1F, the pilot chamber 211F and the seal chambers 171F and 411F are formed in the pilot case 75F at positions at which they overlap each other in the axial direction of the pilot case 75F. Thereby, an increase in size of the pilot case 75F in the axial direction can be minimized.

The cover disc 361F formed by pressing-forming a plate material is used in the pilot case 75F of the shock absorber 1F. Therefore, costs can be reduced compared to a case in which both parts constituting the pilot case 75F are parts formed by sintering or parts formed by cutting.

In the shock absorber 1F, the seal chambers 171F and 411F are provided in parallel, and the throttle 401F is provided therebetween. Thereby, respective pressures in the seal member 73F and the seal member 380F can be controlled by adjusting the throttle 401F. As a result, a damping force characteristic can be adjusted when a piston frequency is high. Also, a damping force characteristic can be adjusted when the piston frequency is high by changing respective characteristics of the seal member 73F and the seal member 380F.

In the shock absorber 1F, an outer diameter of the cover disc 361F is made larger than that of the wall surface portion 392F of the seal chamber 411F. Therefore, the seal member 73F and the seal member 380F can be kept inside the case member 71F by one cover disc 361F.

### Eighth Embodiment

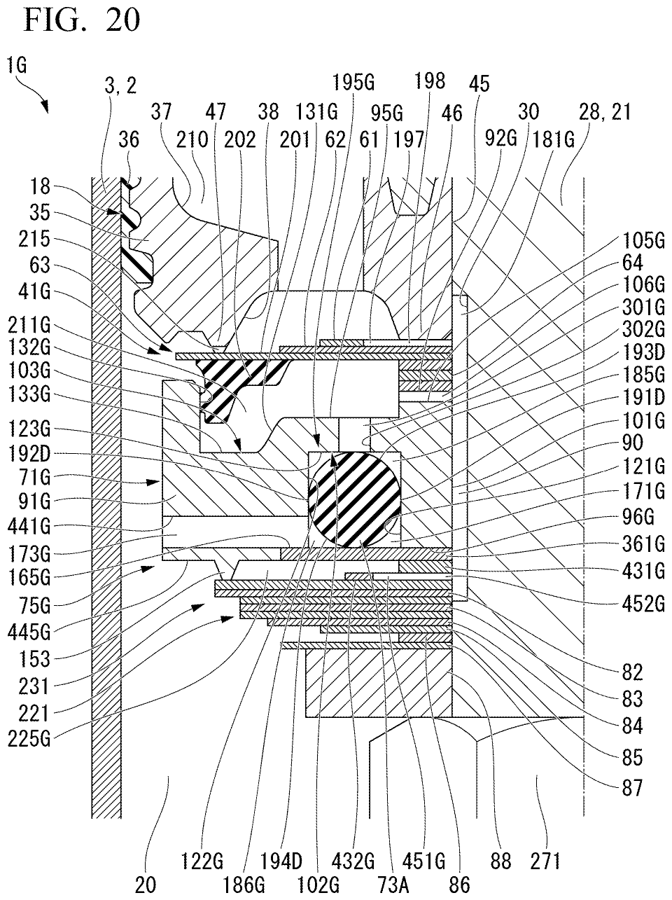

A shock absorber according to an eighth embodiment of the present invention will be described mainly on the basis of FIG. 20, focusing on differences from the second and fifth embodiments. Further, parts common to those in the second and fifth embodiments will be denoted by the same terms and the same reference signs.

As shown in FIG. 20, a shock absorber 1G of the eighth embodiment includes a pilot case 75G instead of the pilot case 75D. The pilot case 75G includes a case member 71G that is partially different from the case member 71D. The pilot case 75G includes a cover disc 361G instead of the seat member 72D. A seal member 73A similar to that of the second embodiment is provided in the pilot case 75G. A plurality of discs 64 similar to those of the fifth embodiment are provided in the shock absorber 1G. Specifically, three discs 64 are stacked. The shock absorber 1G includes a disc 431G and a disc 432G.

The case member 71G, the cover disc 361G, and the discs 431G and 432G are all made of a metal. The case member 71G is formed by cutting. The cover disc 361G and the discs 431G and 432G are formed by press-forming a plate material. The case member 71G, the cover disc 361G, and the discs 431G and 432G are all annular. The case member 71G, the cover disc 361G, and the discs 431G and 432G all have a mounting shaft part 28 of a piston rod 21 fitted to an inner circumferential side thereof. The pilot case 75G overlaps a passage groove 30 of the mounting shaft part 28 in position in an axial direction of the piston rod 21.

The case member 71G includes a member main body part 91G and a protruding part 92G. The member main body part 91G has an annular shape. The protruding part 92G also has an annular shape. The protruding part 92G is provided on an inner circumferential side of the member main body part 91G. A central axis of the member main body part 91G and a central axis of the protruding part 92G coincide with each other. These central axes serve as a central axis of the case member 71G. The protruding part 92G protrudes in an axial direction of the case member 71G from a surface portion 95G on one end side of the member main body part 91G in the axial direction of the case member 71G. The surface portion 95G extends to be orthogonal to the central axis of the case member 71G. The case member 71G is in contact with the disc 64 at an end surface of the protruding part 92G on a side opposite to the member main body part 91G in the axial direction of the case member 71G.

A through hole 101G, a cover disc side annular groove 102G, a piston side annular groove 103G, a piston side radial groove 105G, a passage hole 301G, and a passage hole 441G are formed in the case member 71G. The through hole 101G is formed at center in a radial direction of the case member 71G. The through hole 101G penetrates the case member 71G in the axial direction of the case member 71G. The through hole 101G is formed of an inner circumferential surface of the member main body part 91G and an inner circumferential surface of the protruding part 92G. An inner circumferential surface of the member main body part 91G has a cylindrical surface shape. An outer circumferential surface of the member main body part 91G also has a cylindrical surface shape. A central axis of the through hole 101G coincides with the central axis of the case member 71G.

The member main body part 91G has a surface portion 96G and a surface portion 445G on a side opposite to the surface portion 95G in the axial direction of the member main body part 91G. The surface portion 445G is disposed on an outer side with respect to the surface portion 96G in a radial direction of the member main body part 91G. The surface portion 96G is disposed on the surface portion 95G side with respect to the surface portion 445G in the axial direction of the member main body part 91G. The cover disc side annular groove 102G is formed in the surface portion 96G of the member main body part 91G. Both the surface portions 96G and 445G have a planar shape extending to be orthogonal to the central axis of the case member 71G. The cover disc side annular groove 102G is recessed in the axial direction of the member main body part 91G from the surface portion 96G. The cover disc side annular groove 102G surrounds the through hole 101G from an outer side in the radial direction of the member main body part 91G. The cover disc side annular groove 102G has an annular shape. A central axis of cover disc side annular groove 102G coincides with the central axis of the through hole 101G.

The cover disc side annular groove 102G has a wall surface portion 121G, a wall surface portion 122G, and a bottom surface portion 123G. The wall surface portion 122G is disposed on an outer side with respect to the wall surface portion 121G in the radial direction of the member main body part 91G. The wall surface portion 121G has a cylindrical surface shape. The wall surface portion 121G faces outward in the radial direction of the member main body part 91G. The wall surface portion 122G has a cylindrical surface shape. The wall surface portion 122G faces inward in the radial direction of the member main body part 91G. The bottom surface portion 123G connects an end edge portion of the wall surface portion 121G on a side opposite to the surface portion 96G and an end edge portion of the wall surface portion 122G on a side opposite to the surface portion 96G. The bottom surface portion 123G has a planar shape extending parallel to the surface portion 96G. A central axis of the wall surface portion 121G, a central axis of the wall surface portion 122G, and a central axis of the bottom surface portion 123G are the same as a central axis of the cover disc side annular groove 102G.

The piston side annular groove 103G is recessed in the axial direction of the member main body part 91G from the surface portion 95G of the member main body part 91G. The piston side annular groove 103G is shifted outward in the radial direction of the member main body part 91G from the cover disc side annular groove 102G. The piston side annular groove 103G has an annular shape. A central axis of the piston side annular groove 103G coincides with the central axis of the through hole 101G.

The piston side annular groove 103G has a wall surface portion 131G, a wall surface portion 132G, and a bottom surface portion 133G. The wall surface portion 132G is disposed on an outer side with respect to the wall surface portion 131G in the radial direction of the member main body part 91G. The wall surface portion 132G faces outward in the radial direction of the member main body part 91G. The wall surface portion 131G has a tapered surface. An outer diameter of the wall surface portion 131G becomes smaller toward the surface portion 95G in the axial direction of the member main body part 91G. The wall surface portion 132G has a cylindrical surface shape. The wall surface portion 132G faces inward in the radial direction of the member main body part 91G. The bottom surface portion 133G connects an end edge portion of the wall surface portion 131G on a side opposite to the surface portion 95G and an end edge portion of the wall surface portion 132G on a side opposite to the surface portion 95G. The bottom surface portion 133G has a planar shape extending parallel to the surface portion 95G. A central axis of the wall surface portion 131G, a central axis of the wall surface portion 132G, and a central axis of the bottom surface portion 133G are the same as the central axis of the piston side annular groove 103G.

The passage hole 301G extends in the axial direction of the member main body part 91G. The passage hole 301G extends from the surface portion 95G of the member main body part 91G to the bottom surface portion 123G of the cover disc side annular groove 102G. The passage hole 301G is disposed in the vicinity of a center of the bottom surface portion 123G in the radial direction of the member main body part 91G. A passage in the passage hole 301G constitutes a throttle 302G.

The passage hole 441G extends in the radial direction of the member main body part 91G. The passage hole 441G extends from the wall surface portion 122G of the cover disc side annular groove 102G to an outer circumferential surface of the member main body part 91G. The passage hole 441G is disposed in the vicinity of an end portion of the wall surface portion 122G on a side opposite to the bottom surface portion 123G in the axial direction of the member main body part 91G. A passage in the passage hole 441G constitutes a lower chamber side passage 173G (third passage).

The piston side radial groove 105G is formed in the protruding part 92G. The piston side radial groove 105G is recessed in the axial direction of the case member 71G from a distal end surface of the protruding part 92G on a side opposite to the member main body part 91G in the axial direction of the case member 71G. The piston side radial groove 105G extends from an inner circumferential surface of the protruding part 92G to an outer circumferential surface of the protruding part 92G. The piston side radial groove 105G traverses the protruding part 92G in a radial direction of the protruding part 92G. The piston side radial groove 105G opens to a rod chamber 90. A passage inside the piston side radial groove 105G serves as a throttle 106G that communicates with the rod chamber 90.

The case member 71G includes a valve seat part 153 similar to that of the first embodiment. The valve seat part 153 protrudes in the axial direction of the member main body part 91G from the surface portion 445G of the member main body part 91G. A disc 82 of a hard valve 221 is in contact with the valve seat part 153. A space between the hard valve 221 and a seat member 72 serves as a bypass passage 225G communicating with the rod chamber 90.

The cover disc 361G has an abutment surface 165G on one end side in an axial direction thereof. The abutment surface 165G of the cover disc 361G is in surface contact with the surface portion 96G of the case member 71G. Then, the case member 71G and the cover disc 361G form a seal chamber 171G (passage part).

The disc 431G has an outer diameter smaller than an outer diameter of the cover disc 361G. The disc 432G has an outer diameter smaller than an outer diameter of the cover disc 361G and larger than an outer diameter of the disc 431G. The disc 431G is positioned between the cover disc 361G and the disc 432G and is in contact with them. The disc 432G is positioned between the disc 431G and the disc 82 and is in contact with them. In the disc 432G, a notch 451G extending outward in a radial direction of the disc 432G from an inner circumferential edge portion thereof is formed. A passage in the notch 451G serves as a throttle 452G. The throttle 452G constitutes a part of the bypass passage 225G. The throttle 452G opens to the rod chamber 90. The throttle 452G communicates with the rod chamber 90.

The seal chamber 171G is formed inside the cover disc side annular groove 102G. The seal chamber 171G is formed to be surrounded by the wall surface portion 121G, the wall surface portion 122G, the bottom surface portion 123G, and the abutment surface 165G. The seal chamber 171G has an annular shape. A central axis of the seal chamber 171G and the central axis of the through hole 101G coincide with each other. The throttle 302G communicates with the seal chamber 171G. One end of the lower chamber side passage 173G communicates with the seal chamber 171G. The other end of the lower chamber side passage 173G communicates with a lower chamber 20. The seal chamber 171G is provided between the lower chamber side passage 173G and the throttle 302G.

A damping valve 63 is disposed on the piston side annular groove 103G side of the case member 71G in the axial direction of the case member 71G. At that time, the plurality of discs 64 are disposed between the disc 201 of the damping valve 63 and the protruding part 92G of the case member 71G. In the damping valve 63, a seal part 202 is slidably fitted in a liquid-tight manner to the wall surface portion 132G of the case member 71G over the entire circumference. The seal part 202 constantly seals a gap between the damping valve 63 and the wall surface portion 132G. The damping valve 63, the case member 71G, and the plurality of discs 64 form a pilot chamber 211G. In other words, the pilot case 75G has the pilot chamber 211G formed in the case member 71G. The pilot chamber 211G includes an inner portion of the piston side annular groove 103G. The pilot chamber 211G exerts a pressure on the damping valve 63 in a direction of the piston 18. In other words, the pilot chamber 211G causes the damping valve 63 to generate a force in a direction of reducing a flow path area between the damping valve 63 and a valve seat part 47 due to an internal pressure.

The pilot chamber 211G communicates with the rod chamber 90 via the throttle 106G. The seal chamber 171G and the pilot chamber 211G overlap each other in position in a radial direction of the pilot case 75G.

The shock absorber 1G of the eighth embodiment has a damping force generation mechanism 41G which is different from the damping force generation mechanism 41 in that it has the pilot chamber 211G different from the pilot chamber 211. The damping force generation mechanism 41G is also provided in a piston passage 210 similarly to the damping force generation mechanism 41. The damping force generation mechanism 41G also is an extension-side damping force generation mechanism similarly to the damping force generation mechanism 41.

One end of the throttle 302G opens to the seal chamber 171G, and the other end opens to the pilot chamber 211G. The throttle 302G communicates with the seal chamber 171G and the pilot chamber 211G. The rod chamber 90, the throttles 106G and 302G, and the pilot chamber 211G form an upper chamber side passage 181G (second passage).

The seal member 73A is housed in the seal chamber 171G. The seal member 73A is in contact with the wall surface portion 121G and the wall surface portion 122G of the cover disc side annular groove 102G at the same time. At that time, the seal member 73A elastically deforms in a radial direction of the seal member 73A. The seal member 73A moves in an axial direction of the seal member 73A within the seal chamber 171G. The seal member 73A deforms in the axial direction of the seal member 73A within the seal chamber 171G. The seal member 73A is deformable to the lower chamber side passage 173G side within the seal chamber 171G. The seal member 73A is deformable to the throttle 302G side within the seal chamber 171G.

The seal member 73A includes a seal part 191D, a seal part 192D, a pressure receiving part 193D, and a pressure receiving part 194D. The seal part 191D comes in contact with the wall surface portion 121G to seal between itself and the wall surface portion 121G. The seal part 192D comes in contact with the wall surface portion 122G to seal between itself and the wall surface portion 122G. The seal parts 191D and 192D are also provided in the seal chamber 171G. The seal parts 191D and 192D of the seal member 73A suppress a flow of an oil fluid from the upper chamber side passage 181G side to the lower chamber side passage 173G side. The seal parts 191D and 192D also suppress a flow of the oil fluid from the lower chamber side passage 173G side to the upper chamber side passage 181G side. The pressure receiving part 193D is on the bottom surface portion 123G side of the seal member 73A. The pressure receiving part 193D receives a pressure on the upper chamber side passage 181G side. The pressure receiving part 194D is on the abutment surface 165G side of the seal member 73A. The pressure receiving part 194D receives a pressure on the lower chamber side passage 173G side. The seal member 73A has a seal function that partitions the inside of the seal chamber 171G into an upper chamber communicating chamber 185G that communicates with the upper chamber side passage 181G and a lower chamber communicating chamber 186G that communicates with the lower chamber side passage 173G. The seal member 73A has both the seal function and a property of elastic deformation at the same time.

The seal chamber 171G, the throttles 106G and 302G, the pilot chamber 211G, the lower chamber side passage 173G, and the seal member 73 constitute a frequency sensitive mechanism 195G that makes a damping force variable in response to a frequency of reciprocation of the piston 18. The frequency sensitive mechanism 195G is provided in the pilot case 75G. In the frequency sensitive mechanism 195G, the seal chamber 171G, the lower chamber side passage 173G, and the throttle 302G are formed of two members including the case member 71G and the cover disc 361G.

In the damping force generation mechanism 41G, some of the flow of the oil fluid in the piston passage 210 is introduced into the pilot chamber 211G via a throttle 198, the rod chamber 90, and the throttle 106G. The damping force generation mechanism 41G controls an opening of the damping valve 63 due to a pressure in the pilot chamber 211G. In the frequency sensitive mechanism 195G, some of the flow of the oil fluid in the piston passage 210 is introduced into the upper chamber communicating chamber 185G of the seal chamber 171G via the throttle 198, the rod chamber 90, the throttle 106G, the pilot chamber 211G, and the throttle 302G.

The upper chamber side passage 181G including the rod chamber 90 communicates, via the throttle 198, with an upstream side of the damping valve 63 in a flow direction of the oil fluid in the piston passage 210 during an extension stroke. The upper chamber side passage 181G communicates with the upper chamber communicating chamber 185G of the seal chamber 171G. The lower chamber side passage 173G communicates with the lower chamber communicating chamber 186G of the seal chamber 171G. The lower chamber side passage 173G communicates with the lower chamber 20 downstream of the damping valve 63 in the flow direction of the oil fluid in the piston passage 210 during the extension stroke.

Here, when the above-described parts are assembled to the mounting shaft part 28 of the piston rod 21, not one disc 64 but four discs 64 are assembled. At the same time, the case member 71G is assembled instead of the case member 71D, and the cover disc 361G is assembled instead of the seat member 72D. Further, the discs 431G and 432G are assembled. Other than these, assembly is performed in the same manner as in the fifth embodiment. Thereby, the pilot case 75G is disposed to sandwich the damping valve 63 between the pilot case 75G and the piston 18. Also, the central axis of the case member 71G is made to coincide with a central axis of the piston rod 21. Also, a central axis of the cover disc 361G is made to coincide with the central axis of the piston rod 21.

A hydraulic circuit diagram of a portion of the vicinity of the piston 18 of the shock absorber 1G configured as described above is the same as the hydraulic circuit diagram of the shock absorber 1A shown in FIG. 7.

During the extension stroke of the shock absorber 1G configured as described above, the oil fluid is introduced from the piston passage 210 into the upper chamber communicating chamber 185G of the seal chamber 171G via the throttle 198 and the upper chamber side passage 181G. Then, the seal member 73A moves to a side opposite to the piston 18 in the axial direction of the seal member 73A and deforms. At that time, the oil fluid is discharged from the lower chamber communicating chamber 186G of the seal chamber 171G to the lower chamber 20 through the lower chamber side passage 173G. During a compression stroke of the shock absorber 1G, the oil fluid is introduced from the lower chamber 20 into the lower chamber communicating chamber 186G of the seal chamber 171G through the lower chamber side passage 173G. Then, the seal member 73A moves to the piston 18 side in the axial direction of the seal member 73A and deforms. At that time, the oil fluid is discharged from the upper chamber communicating chamber 185G of the seal chamber 171G to the piston passage 210, that is, an upper chamber 19, through the upper chamber side passage 181G and the throttle 198. Operations other than these of the frequency sensitive mechanism 195G are substantially the same as those of the shock absorber 1A.

The shock absorber 1G of the eighth embodiment includes the upper chamber side passage 181G that communicates, via the throttle 198, with an upstream side of the damping valve 63 in the flow direction of the oil fluid in the piston passage 210 during the extension stroke. Also, the shock absorber 1G includes the lower chamber side passage 173G that communicates with the lower chamber 20 downstream of the damping valve 63 in the flow direction of the oil fluid in the piston passage 210 during the extension stroke. Also, the shock absorber 1G includes the seal chamber 171G provided between the upper chamber side passage 181G and the lower chamber side passage 173G. Then, the shock absorber 1G includes the seal member 73A having rubber elasticity provided in the seal chamber 171G. Therefore, the shock absorber 1G has a structure in which the frequency sensitive mechanism 195G moves the seal member 73A within the seal chamber 171G. Also, in the shock absorber 1G, the pilot chamber 211G constitutes the upper chamber side passage 181G. Also, in the shock absorber 1G, the bypass passage 225G communicates with the upper chamber side passage 181G. Also, in the shock absorber 1G, the pilot case 75G in which the pilot chamber 211G is formed is disposed to sandwich the damping valve 63 between the pilot case 75G and the piston 18. Also, in the shock absorber 1G, the seal chamber 171G and the lower chamber side passage 173G are formed of two members including the case member 71G and the cover disc 361G. As described above, a structure of the shock absorber 1G can be simplified similarly to the shock absorber 1.

Further, in the shock absorber 1G, the piston side radial groove 105G of the protruding part 92G may be removed, and a throttle forming disc similar to the disc 61 may be provided between the protruding part 92G and the damping valve 63. Thereby, the throttle 106G can be formed by a notch in the throttle forming disc similarly to the notch 197. In this way, a size of the throttle 106G can be easily changed by exchanging the throttle forming disc, and the throttle 106G can be easily adjusted.

### Ninth Embodiment

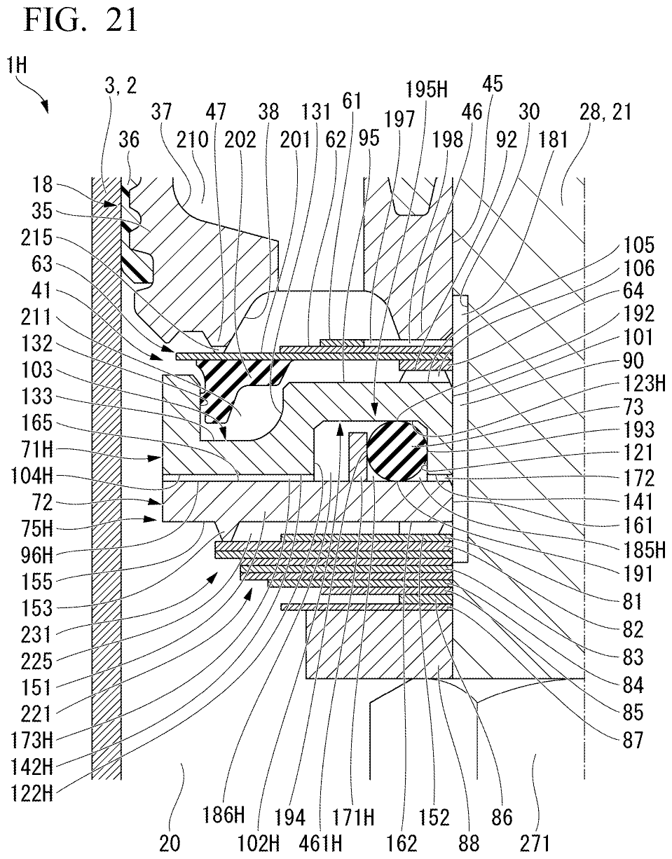

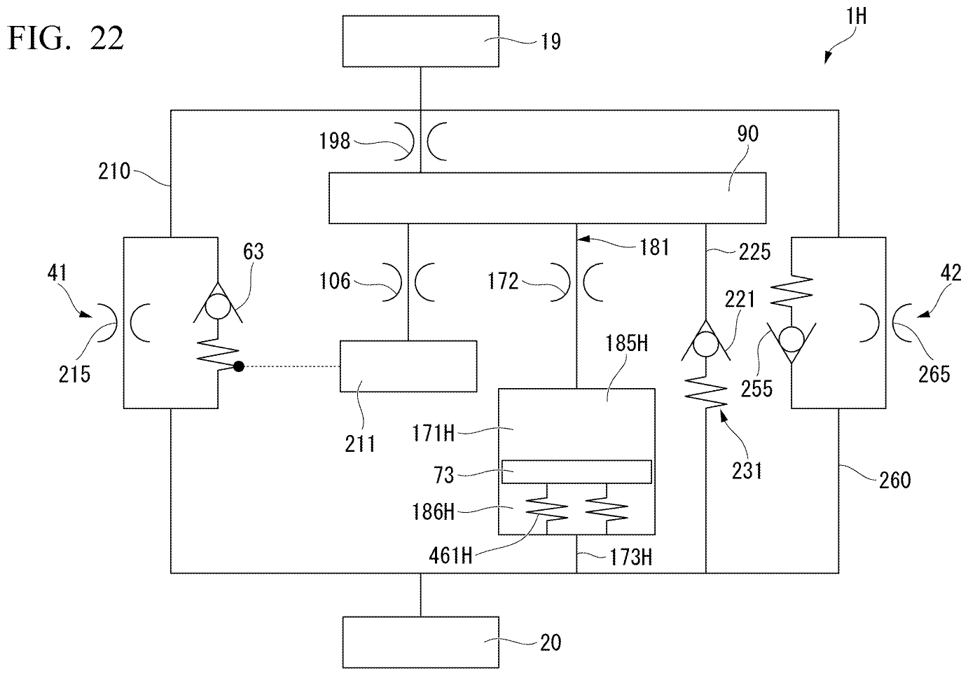

A shock absorber according to a ninth embodiment of the present invention will be described mainly on the basis of FIGS. 21 and 22, focusing on differences from the first embodiment. Further, parts common to those in the first embodiment will be denoted by the same terms and the same reference signs.

As shown in FIG. 21, a shock absorber 1H of the ninth embodiment includes a pilot case 75H instead of the pilot case 75. The pilot case 75H includes a case member 71H that is partially different from the case member 71. The pilot case 75H includes a seat member 72 similar to that of the first embodiment. A seal member 73 similar to that of the first embodiment is provided in the pilot case 75H.

The case member 71H includes a seat member side annular groove 102H that is larger in width in a radial direction of the case member 71H than the seat member side annular groove 102. The seat member side annular groove 102H has a wall surface portion 121 similar to that of the first embodiment. The seat member side annular groove 102H has a wall surface portion 122H on an outer side with respect to the wall surface portion 122 of the first embodiment in position in the radial direction of the case member 71H. The seat member side annular groove 102H has a bottom surface portion 123H that is larger in width in the radial direction of the case member 71H than that of the bottom surface portion 123 of the first embodiment.

The width of the seat member side annular groove 102H in the radial direction of the case member 71H is larger than that of the seat member side annular groove 102. The case member 71H has a surface portion 96H whose area is reduced from that of the surface portion 96 by an amount of the increased width of the seat member side annular groove 102H as described above. A seat member side radial groove 104H whose length is smaller than the seat member side radial groove 104 by the amount of the increased width of the seat member side annular groove 102H is provided. The seat member side radial groove 104H includes an outer groove part 142H that is smaller in length than the outer groove part 142.

Therefore, the pilot case 75H includes a seal chamber 171H that is larger in width in the radial direction of the case member 71H than the seal chamber 171. The pilot case 75H includes a lower chamber side passage 173H that is smaller in length in the radial direction of the case member 71H than the lower chamber side passage 173.

The seal member 73 is provided in the seal chamber 171H. A seal part 191 of the seal member 73 seals a gap between itself and an abutment part 165. A seal part 192 of the seal member 73 seals a gap between itself and the bottom surface portion 123H. Therefore, the seal member 73 partitions the seal chamber 171H into an upper chamber communicating chamber 185H and a lower chamber communicating chamber 186H. The upper chamber communicating chamber 185H communicates with a rod chamber 90 via a throttle 172. The lower chamber communicating chamber 186H communicates with a lower chamber 20 through the lower chamber side passage 173H.

The shock absorber 1H includes a biasing member 461H provided in the seal chamber 171H. The biasing member 461H is made of a metal and disposed on an outer side of the seal member 73 in a radial direction of the seal chamber 171H. When the seal member 73 increases in diameter, the biasing member 461H elastically deforms in the radial direction accordingly. At that time, the biasing member 461H biases the seal member 73 inward in a radial direction of the seal member 73. The biasing member 461H is a C-shaped ring obtained by partially cutting an annular ring. As the biasing member 461H, a spiral spring formed by winding a band plate in a spiral shape can be used. The biasing member 461H has a length in an axial direction of the case member 71H that is smaller than a length of the seal chamber 171H in the same direction. That is, the biasing member 461H does not partition the inside of the seal chamber 171H.

The throttle 172, the seal chamber 171H, the lower chamber side passage 173H, the seal member 73, and the biasing member 461H constitute a frequency sensitive mechanism 195H that makes a damping force variable in response to a frequency of reciprocation of a piston 18. The frequency sensitive mechanism 195H is provided in the pilot case 75H. In the frequency sensitive mechanism 195H, the seal chamber 171H, the lower chamber side passage 173H, and the throttle 172 are formed of two members including the case member 71H and the seat member 72.

The lower chamber side passage 173H communicates with the lower chamber communicating chamber 186H of the seal chamber 171H. The lower chamber side passage 173H communicates with the lower chamber 20 downstream of a damping valve 63 in a flow direction of an oil fluid in a piston passage 210 during an extension stroke.

Here, when the above-described parts are assembled to the mounting shaft part 28 of the piston rod 21, the case member 71H is assembled instead of the case member 71. Also, the biasing member 461H is assembled in addition to the seal member 73. Other than these, assembly is performed in the same manner as in the first embodiment. Thereby, a central axis of the case member 71H is made to coincide with a central axis of the piston rod 21.

FIG. 22 shows a hydraulic circuit diagram of a portion of the vicinity of the piston 18 of the shock absorber 1H configured as described above. As shown in FIG. 22, the shock absorber 1H is different from the shock absorber 1 of the first embodiment in that a rigidity of the seal member 73 is represented by a sum of a spring constant of the seal member 73 and a spring constant of the biasing member 461H.

During the extension stroke of the shock absorber 1H configured as described above, the oil fluid is introduced from the piston passage 210 into the upper chamber communicating chamber 185H of the seal chamber 171H via the throttle 198 and the upper chamber side passage 181. Then, the seal member 73 deforms in such a manner that it moves outward in the radial direction of the seal member 73. Then, the seal member 73 deforms the biasing member 461H to move outward in the radial direction of the seal member 73. At that time, the oil fluid is discharged from the lower chamber communicating chamber 186H of the seal chamber 171H to the lower chamber 20 through the lower chamber side passage 173H. During a compression stroke of the shock absorber 1H, the oil fluid is introduced from the lower chamber 20 into the lower chamber communicating chamber 186H of the seal chamber 171H via the lower chamber side passage 173H. Then, the seal member 73 deforms in such a manner that it moves inward in the radial direction of the seal member 73. At that time, the oil fluid is discharged from the upper chamber communicating chamber 185H of the seal chamber 171H to the piston passage 210, that is, an upper chamber 19, through the upper chamber side passage 181 and the throttle 198. Operations other than these of the frequency sensitive mechanism 195H are substantially the same as those of the shock absorber 1.

In the shock absorber 1H of the ninth embodiment, the biasing member 461H that biases the seal member 73 is provided in the seal chamber 171H separately from the seal member 73. Therefore, a damping force characteristic in the extension stroke when a piston frequency is high can be made dominant in movement of the biasing member 461H by making the spring constant of the biasing member 461H larger than the spring constant of the seal member 73. Therefore, an influence of a change in the spring characteristic due to a temperature of the seal member 73 can be reduced to be small.

### Tenth Embodiment

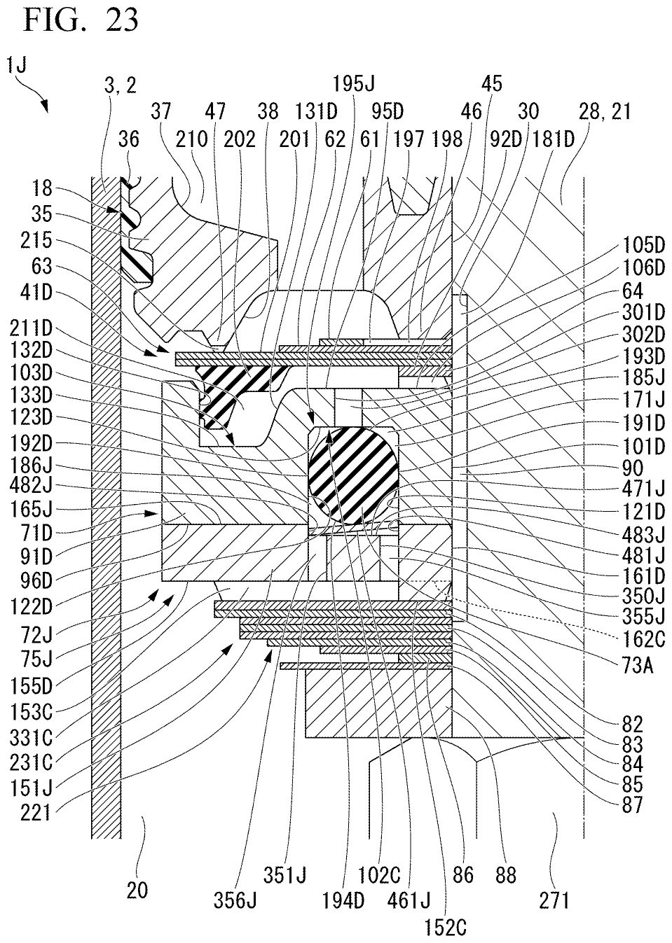

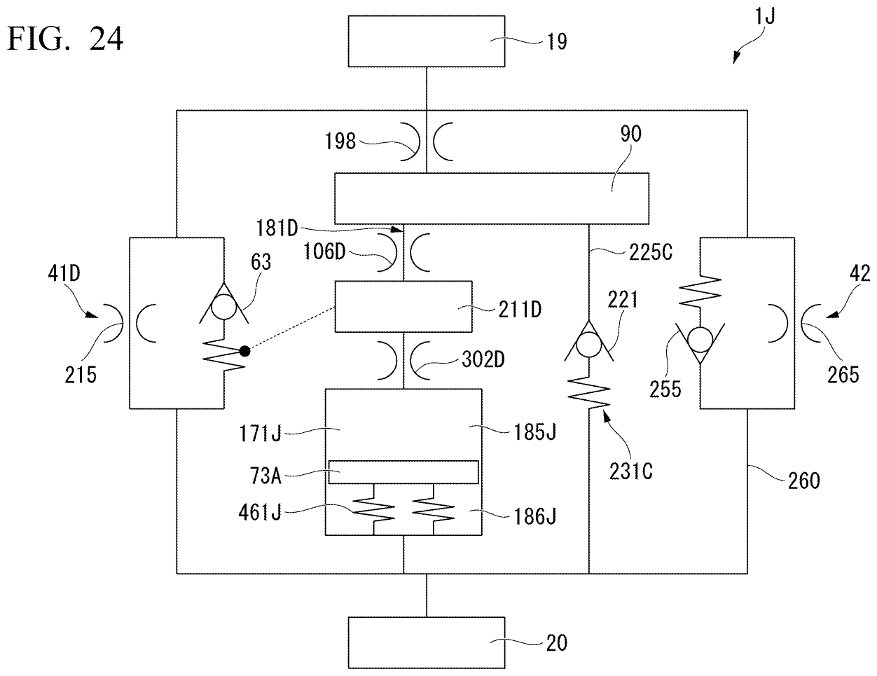

A shock absorber according to a tenth embodiment of the present invention will be described mainly on the basis of FIGS. 23 and 24, focusing on differences from the fifth embodiment. Further, parts common to those in the fifth embodiment will be denoted by the same terms and the same reference signs.

As shown in FIG. 23, a shock absorber 1J of the tenth embodiment includes a pilot case 75J instead of the pilot case 75D. The pilot case 75J includes a seat member 72J that is partially different from the seat member 72D. The pilot case 75J includes a case member 71D similar to that of the fifth embodiment. A seal member 73A similar to that of the fifth embodiment is provided in the pilot case 75J.

In the seat member 72J, a member main body part 151J is partially different from the member main body part 151D. An abutment surface 165J is formed in the member main body part 151J instead of the abutment surface 165D. The abutment surface 165J also extends in a direction orthogonal to a central axis of the member main body part 151J. The abutment surface 165J of the member main body part 151J is in surface contact with a surface portion 96D of the case member 71D. A case member side annular groove 471J that is recessed in an axial direction of the seat member 72J from the abutment surface 165J is formed in the member main body part 151J.

The case member side annular groove 471J has a wall surface portion 481J, a wall surface portion 482J, and a bottom surface portion 483J. The wall surface portion 482J is disposed on an outer side with respect to the wall surface portion 481J in a radial direction of the member main body part 151J. The wall surface portion 481J has a cylindrical surface shape. The wall surface portion 481J faces outward in the radial direction of the member main body part 151J. The wall surface portion 482J has a cylindrical surface shape. The wall surface portion 482J faces inward in the radial direction of the member main body part 151J. The bottom surface portion 483J connects an end edge portion of the wall surface portion 481J on a side opposite to the abutment surface 165J and an end edge portion of the wall surface portion 482J on a side opposite to the abutment surface 165J. The bottom surface portion 483J has a planar shape extending parallel to the abutment surface 165J. A central axis of the wall surface portion 481J, a central axis of the wall surface portion 482J, and a central axis of the bottom surface portion 483J are the same as a central axis of the case member side annular groove 471J.

When the case member 71D and the seat member 72J are assembled to a piston rod 21, the surface portion 96D and the abutment surface 165J are in surface contact. In this state, the wall surface portions 121D and 481J are disposed on the same cylindrical surface, and the wall surface portions 122D and 482J are disposed on the same cylindrical surface.

Therefore, the pilot case 75J includes a seal chamber 171J whose length in the axial direction of the pilot case 75J is larger than that of the seal chamber 171D of the fifth embodiment. The pilot case 75J includes a passage hole 350J whose length in the axial direction of the pilot case 75J is smaller than that of the passage hole 350D of the fifth embodiment. The pilot case 75J includes a passage hole 351J whose length in the axial direction of the pilot case 75J is smaller than that of the passage hole 351D of the fifth embodiment. The pilot case 75J includes a lower chamber side passage 355J whose length in the axial direction of the pilot case 75J is smaller than that of the lower chamber side passage 355D of the fifth embodiment. The pilot case 75J includes a lower chamber side passage 356J whose length in the axial direction of the pilot case 75J is smaller than that of the lower chamber side passage 356D of the fifth embodiment. The seal member 73A partitions the seal chamber 171J into an upper chamber communicating chamber 185J and a lower chamber communicating chamber 186J. The upper chamber communicating chamber 185J communicates with the pilot chamber 211D via a throttle 302D. The lower chamber communicating chamber 186J communicates with a lower chamber 20 via the lower chamber side passages 355J and 356J.

The shock absorber 1J of the tenth embodiment includes a biasing member 461J provided in the seal chamber 171J in addition to the seal member 73A. The biasing member 461J is made of a metal and disposed on a side opposite to a piston 18 with respect to the seal member 73A in an axial direction of the seal member 73A. When the seal member 73A moves to a side opposite to the piston 18 in the axial direction of the seal member 73A, the biasing member 461J elastically deforms in an axial direction of the biasing member 461J accordingly. At that time, the biasing member 461J biases the seal member 73A to the piston 18 side in an axial direction of the seal chamber 171F. The biasing member 461J is an annular disc spring. Even when the biasing member 461J is deformed, a width thereof in a radial direction of the seal chamber 171J is smaller than a width of the seal chamber 171J in the same direction. That is, the biasing member 461J does not partition the inside of the seal chamber 171J.

The throttle 302D, the seal chamber 171J, the lower chamber side passages 355J and 356J, the seal member 73A, and the biasing member 461J constitute a frequency sensitive mechanism 195J that makes a damping force variable in response to a frequency of reciprocation of the piston 18. The frequency sensitive mechanism 195J is provided in the pilot case 75J. In the frequency sensitive mechanism 195J, the throttle 302D, the seal chamber 171J, and the lower chamber side passages 355J and 356J are formed of two members including the case member 71D and the seat member 72J.

The lower chamber side passages 355J and 356J communicate with the lower chamber communicating chamber 186J of the seal chamber 171J. The lower chamber side passages 355J and 356J communicate with the lower chamber 20 downstream of a damping valve 63 in a flow direction of an oil fluid in a piston passage 210 during an extension stroke.

Here, when the above-described parts are assembled to a mounting shaft part 28 of the piston rod 21, the seat member 72J is assembled instead of the seat member 72D. Also, the biasing member 461J is assembled in addition to the seal member 73A. Other than these, assembly is performed in the same manner as in the fifth embodiment. Thereby, a central axis of the seat member 72J is made to coincide with a central axis of the piston rod 21.

A hydraulic circuit diagram of a portion of the vicinity of the piston 18 of the shock absorber 1J configured as described above is shown in FIG. 24. As shown in FIG. 24, the shock absorber 1J is different from the shock absorber 1D of the fifth embodiment in that a rigidity of the seal member 73A is represented by a sum of a spring constant of the seal member 73A and a spring constant of the biasing member 461J.

During the extension stroke of the shock absorber 1J configured as described above, the oil fluid is introduced from the piston passage 210 into the upper chamber communicating chamber 185J of the seal chamber 171J via the throttle 198 and an upper chamber side passage 181D. Then, the seal member 73A deforms in such a manner that it moves to a side opposite to the piston 18 in the axial direction of the seal member 73A. Then, the seal member 73A deforms the biasing member 461J to move to a side opposite to the piston 18 in the axial direction of the seal member 73. At that time, the oil fluid is discharged from the lower chamber communicating chamber 186J of the seal chamber 171J to the lower chamber 20 through the lower chamber side passages 355J and 356J. During a compression stroke of the shock absorber 1J, the oil fluid is introduced from the lower chamber 20 into the lower chamber communicating chamber 186J of the seal chamber 171J through the lower chamber side passages 355J and 356J. Then, the seal member 73A deforms in such a manner that it moves to the piston 18 side in the axial direction of the seal member 73A. At that time, the oil fluid is discharged from the upper chamber communicating chamber 185J of the seal chamber 171J to the piston passage 210, that is, an upper chamber 19, through the upper chamber side passage 181D and the throttle 198. Operations other than these of the frequency sensitive mechanism 195J are substantially the same as those of the shock absorber 1.

In the shock absorber 1J of the tenth embodiment, the biasing member 461J that biases the seal member 73A is provided in the seal chamber 171J separately from the seal member 73A. Therefore, a damping force characteristic in the extension stroke when a piston frequency is high can be made dominant in movement of the biasing member 461J by making the spring constant of the biasing member 461J larger than the spring constant of the seal member 73A. Therefore, an influence of a change in the spring characteristic due to a temperature of the seal member 73A can be reduced to be small.

In the first to tenth embodiments described above, cases in which the seal members 73, 73A, 73B, 73F, and 380F are O-rings have been described as examples. The seal members 73, 73A, 73B, 73F, and 380F may each be an X-packing having an X-shaped cross section in a plane including the central axis.

Also, in the first to tenth embodiments described above, configurations in which the seal members 73, 73A, 73B, 73F, and 380F move in the radial direction or the axial direction have been described as examples. The seal members 73, 73A, 73B, 73F, and 380F may each be configured to move in a direction inclined with respect to the axial direction. In that case, the seal chambers 171, 171A to 171H, 171J, and 411F are formed to be inclined with respect to the axial direction of the seal members 73, 73A, 73B, 73F, and 380F.

Also, in the first to tenth embodiments described above, cases in which the frequency sensitive mechanisms 195, 195A to 195H, and 195J are provided on the piston rod 21 have been described as examples. The frequency sensitive mechanisms 195, 195A to 195H, and 195J may be provided on the base valve 25. Alternatively, when a valve mechanism is attached to an outer circumferential portion of the outer cylinder 4, the frequency sensitive mechanisms 195, 195A to 195H, and 195J may be provided on the valve mechanism.

### INDUSTRIAL APPLICABILITY

According to the shock absorber and the frequency sensitive mechanism described above, the structure can be simplified.

### REFERENCE SIGNS LIST

1, 1A to 1H, 1J Shock absorber
2 Cylinder
18 Piston
19 Upper chamber
20 Lower chamber
63 Damping valve
71, 71A to 71H, 71J Case member
72, 72C, 72D, 72J Seat member
73, 73A, 73B, 73F, 380F Seal member (elastic member, moving member)
75, 75A to 75H, 75J Pilot case
171, 171A to 171H, 171J Seal chamber (passage part)
173, 173A to 173C, 173G, 345C, 355D to 355F, 355J, 356D to 356F, 356J, 415F, 416F Lower chamber side passage (third passage)
181, 181A to 181G Upper chamber side passage (second passage)
191, 191A, 191B, 191D, 191F, 192, 192A, 192B, 192D, 192F Seal part
193, 193A, 193B, 193D, 193F Pressure receiving part
195, 195A to 195H, 195J Frequency sensitive mechanism
198 Throttle
210 Piston passage (first passage)
211, 211A, 211D to 211G Pilot chamber
225, 225C Bypass passage
231, 231C Damping force generation mechanism
361E to 361G Cover disc
461H, 461J Biasing member

1. A shock absorber comprising:
a cylinder in which a working fluid is sealed;
a piston fitted in the cylinder and partitioning an inside of the cylinder;
a first passage through which the working fluid in the cylinder flows due to movement of the piston;
a damping valve provided in the first passage and configured to change a flow path area due to a flow of the working fluid;
a second passage communicating with an upstream side of the damping valve via a throttle;
a third passage communicating with a downstream side of the damping valve;
a passage part provided between the second passage and the third passage; and
an elastic member having rubber elasticity provided in the passage part, wherein
the elastic member includes:
a seal part configured to suppress a flow of the working fluid from the second passage to the third passage; and
a pressure receiving part configured to receive a pressure of the second passage, wherein
the shock absorber further comprises a pilot chamber communicating with the second passage and configured to generate a force in a direction of reducing a flow path area of the damping valve due to an internal pressure.

2. (canceled)

3. The shock absorber according to claim 1, comprising:
a bypass passage allowing the second passage and a downstream side of the damping valve to communicate with each other; and
a damping force generation mechanism provided in the bypass passage and configured to generate a damping force due to a flow of the working fluid.

4. The shock absorber according to claim 3, wherein
the first passage is formed in the piston,
the shock absorber comprises a pilot case in which a pilot chamber generating a force in a direction of reducing a flow path area of the damping valve is formed, and
the pilot case is disposed to sandwich the damping valve between the pilot case and the piston.

5. The shock absorber according to claim 1, wherein
the passage part includes a seal chamber in which the elastic member is housed, and
the elastic member moves in a radial direction within the seal chamber.

6. A shock absorber comprising:
a cylinder in which a working fluid is sealed;
a piston fitted in the cylinder and partitioning an inside of the cylinder;
a first passage through which the working fluid in the cylinder flows due to movement of the piston;
a damping valve provided in the first passage and configured to change a flow path area due to a flow of the working fluid;
a second passage communicating with an upstream side of the damping valve via a throttle;
a third passage communicating with a downstream side of the damping valve;
a seal chamber provided between the second passage and the third passage;
a moving member provided in the seal chamber and including a seal part which suppresses a flow of the working fluid from the second passage to the third passage; and
a pilot case forming a pilot chamber which communicates with the second passage and generates a force in a direction of reducing a flow path area of the damping valve due to an internal pressure, wherein
the pilot chamber and the seal chamber are formed in the pilot case at positions at which they overlap each other in an axial direction.

7. A frequency sensitive mechanism which is provided in a shock absorber including:
a cylinder in which a working fluid is sealed;
a piston fitted in the cylinder and partitioning an inside of the cylinder;
a first passage through which the working fluid in the cylinder flows due to movement of the piston;
a damping valve provided in the first passage and configured to change a flow path area due to a flow of the working fluid; and
a second passage communicating with an upstream side of the damping valve via a throttle,
the frequency sensitive mechanism comprising:
a third passage communicating with a downstream side of the damping valve;
a passage part provided between the second passage and the third passage; and
an elastic member having rubber elasticity provided in the passage part, wherein
the elastic member includes:
a seal part configured to suppress a flow of the working fluid from the second passage to the third passage; and
a pressure receiving part configured to receive a pressure of the second passage.

8. The frequency sensitive mechanism according to claim 7, wherein the elastic member moves in an axial direction.

9. The frequency sensitive mechanism according to claim 7, wherein the third passage and the passage part are formed of two members.

10. The frequency sensitive mechanism according to claim 7, wherein a biasing member biasing the elastic member is provided in the passage part separately from the elastic member.

11. The frequency sensitive mechanism according to claim 7, wherein
the passage part includes a seal chamber in which the elastic member is housed, and
the seal chamber is formed of a case member which is able to house the elastic member and a cover member disposed to face the case member.
